(19) United States
(12) Patent Application Publication
(10) Pub. No.: US 2025/0342779 A1
(43) Pub. Date: Nov. 6, 2025

(54) DEMOGRAPHICALLY DETERMINED THREE-DIMENSIONAL HUMAN ANATOMICAL SIMULATION

(71) Applicant: LESLIE EUNICE SHEEHY LEE, ELYSIAN, MN (US)

(72) Inventor: LESLIE EUNICE SHEEHY LEE, ELYSIAN, MN (US)

(21) Appl. No.: 18/653,105

(22) Filed: May 2, 2024

(51) Int. Cl. G09B 23/30; G06T 17/00

(52) U.S. Cl. CPC G09B 23/30; G06T 17/00; G06T 2210/41

(57) ABSTRACT

A demographically determined three-dimensional training device includes a structural framework corresponding to at least one human anatomical part, and at least one demographically determined simulated human tissue layer disposed on at least a portion of the structural framework and having at least one demographic bias indicator. The training device further includes at least one defect disposed upon the simulated human tissue layer. The at least one defect is selected from a group consisting of a cyst, wound, lesion, scar, fat pad and lymphoma, or a combination thereof.

### FIELD OF THE INVENTION

The invention provides three-dimensional (3D) including, without limitation, demographically determined, three-dimensional training devices, methods and systems that may be for use in the education and training fields for various service providers, such as medical and aesthetic (cosmetic) service and treatment providers.

### BACKGROUND

Today there are major markets for the provision of medical and aesthetic (cosmetic) services or treatments. Providers of aesthetic treatments are typically licensed medical professionals or their designers. A licensed medical practitioner can delegate the performance of aesthetic services to others who may or may not be licensed practitioners or have received any anatomical education or training. Currently, there are limited to no formal training regulations on aesthetic medicine and services meaning aesthetic training is mainly unregulated. Put another way, whether a licensed medical professional or not, prior to performing an aesthetic procedure, an aesthetic service provider is not required to receive any formal education or training.

Aesthetic services can comprise treatments and techniques (cosmetic procedures) that include non-surgical procedures designed to combat signs of ageing, rejuvenate and refresh the skin. The aesthetic industry is known for non-invasive cosmetic procedures such as injections of neuromodulators (Botox®) and dermal filler and laser treatments used for aging gracefully. Advanced enhancement and rejuvenation of the upper face are continuing to grow throughout the world. The aesthetic industry is an $11.5 billion a year industry expected to reach $1024 billion by 2029.

Aesthetic training is mainly unregulated self-funded and sought out by the provider themselves. Aesthetic service training is not required to be obtained prior to performing the non-invasive cosmetic procedures of many aesthetic services. Medical professionals, or their unlicensed designers, can perform cosmetic procedures without any prior hands-on training or anatomy education related to a specific anatomical feature.

Aesthetic medicine is constantly changing making it essential for service providers to have ongoing training and remain up to date on the new products and techniques for patient safety. While there is an abundance of aesthetic services training available, such training is typically limited to the use of lectures, videos, and simulations. It is often the case that such training does not provide an opportunity for a service provider to gain real-world, hands-on experience related to the performance of an aesthetic service upon an anatomical structure or feature (e.g., human anatomy). It is typical that the majority of any real-world. hands-on experience gained by any service provider is gained primarily through practice upon people. This can lead to significant complications and potential harm to a patient. Further, patients are faced with the challenge of finding a qualified provider that is appropriately trained and able to treat with natural results, as well as recognize and manage complications as they arise. Promoting an increase in aesthetic services training and hands-on, simulated real-world educational and training opportunities can promote increased service provider knowledge, patient safety (minimization of complications and harm) and the ability to address any complications as they arise.

In the medical and aesthetic services fields, training and education that employs or uses cadavers (cadaver classes) have gained importance as a way to allow such providers to gain real-world, hands-on experience before performance upon humans. The cadaver classes can often consist of educational staff dissecting the cadaver where the dissection process is displayed on a screen for the trainees, offering trainees very little, if any, opportunity for hands-on training. Outside these types of training opportunities, it can be that an aesthetic provider(s) has not received a medical school education nor dissected a cadaver, but instead has learned anatomy in college only through lectures and videos. When nurses go through nursing school, they often only take basic anatomy of the body. This kind of limited anatomy training may negatively impact on a provider's comprehension of anatomical features. For instance, as it relates to facial aesthetics, it can be crucial to have a comprehensive knowledge of the location of arteries, vessels, fat pads, muscles, foramens, and other facial landmarks, prior to performing any aesthetic procedures. One semester (four months or less) of undergraduate schooling of the entire human body may be inadequate for the safe and effective performance of various aesthetic services.

The costs associated in obtaining cadavers and the potential impact upon the availability of organs for transplant from organ donation can be significant. Currently, there is a shortage of cadavers and organ donors and this makes access to cadavers often-times difficult if not impossible along with potentially further driving costs up and reducing the number of available organs for transplant. It can also be the case that a cadaver or specific areas from a cadaver cannot be used as a medical or aesthetic teaching and training tool, such as where the body has been damaged, is from a person who donates their organs or where organs are harvested from the performance of an autopsy. As such, there can be many factors that potentially limit opportunities for using cadavers as an education and training tool. Thus, providing medical and aesthetic service providers the opportunity to gain real-world, hands-on anatomical educational and training experience can remain challenging.

Hands-on, real-world education and training can be crucial in promoting service provider knowledge which can further promote increased patient safety and minimize complications. Aesthetic service providers administer non-invasive injections that are considered high risk. For example, injecting neuromodulators, such as the botulinum toxin type A or dermal filler into human faces. Diligence and confidence in knowing the anatomy of the places where injections may take place needs to be at the forefront of aesthetics to maintain patient safety and minimize complications. In this example, adequate facial anatomy knowledge is crucial for patient safety and reducing risks such as blindness and vascular occlusions. The current challenges to get adequate hands-on facial anatomy education and training opportunities can severely impact upon a provider's knowledge and understanding of the location and function of various features, such as the muscles and fat pads in a face, but also the ability to landmark important other features such as where arteries, nerves, vessels, foramens and other features are located. Thus, for properly providing aesthetic services it is imperative that an aesthetic provider has a detailed comprehension of the relevant anatomical features to promote the performance of safe, confident procedures.

The use of 3D printing may have the potential to provide a basis for addressing the needs for real-world, hands-on training and promote a massive revolution in healthcare. The use of 3D printing in the medical and aesthetic fields can not only promote savings of time and money, but also potentially promote access to training tools, devices and models that may facilitate increased access to and opportunities for simulation of real-world human anatomical features and structures for hands-on educational and training purposes.

3D printing technology has advanced and can promote the cost-effective production of a wide range of three-dimensional objects including various training tools (i.e., devices and models). In specific instances the 3D printing technology can produce various objects based on MRI or CT imaging (scan) data converted into a format the 3D printer can utilize. By way of some specific examples, 3D printing has been used in the printing of eyeglasses, animal cartilage, arteries, heart valves, regenerating the meniscus, and reconstructing the trachea along with being used in surgery, with prosthetics and dental implants, and organs. 3D printing has a minimal setup cost, allows for a high degree of customization, and the cost of the first item is the same as the last, meaning that it can promote the making of one-of-a-kind items in a cost-effective manner. Using imaging data to design and manufacture material into three-dimensional objects layer by layer, 3D printers can provide service providers with access to a cost-effective, new and potentially unlimited resource for generating numerous training devices, tools and models.

Another crucial aspect of aesthetic service education and training is gaining experience in performing procedures with patients having various demographic (i.e., age, gender, race, and others) characteristics associated with anatomical features. Cadavers, when available, may offer one-time access to a single anatomical structure providing a defined demographic instance. To obtain experience with anatomical structures having different demographic characteristics would require access to multiple cadavers. This can be cost prohibitive and limited by the shortage in cadaver availability. It can be that 3D printing can provide a cost effective approach to generating a potentially unlimited number of objects. 3D printing typically employs an additive printing process wherein the generation of 3D models, devices and tools can be accomplished through application of successive layers of material(s) to make the object being printed. Using this approach. 3D printing can provide simulated 3D representations of various tools, devices and models including, without limitation, various features (e.g., fat pads, musculature, foramen) therein, and can further generate features having specific demographic characteristics. Thus, 3D printing can potentially enable the generation of multiple (potentially unlimited), demographically distinct tools, devices and models that can further promote access to real-world, hands-on education and training for service providers.

Currently, there remains a need for a more comprehensive approach to the training and education of medical and aesthetic service providers. Further, there remains a need for the cost-effective development and generation of training tools, devices and models that promote increased access to and opportunities for hands-on, real-world anatomical education and training for service providers. Additionally, there remains a need for demographically distinct anatomical education and training opportunities. Still further, there remains a need to promote increased organ availability from organ donation for transplant purposes.

### SUMMARY OF INVENTION

Exemplary embodiments for the current invention described herein include, without limitation, the following: (i) physical or virtual (computer implemented) three-dimensional (a) training devices, tools, models, simulations and/or representations, and (b) demographically determined training devices, tools, models, simulations and/or representations, (collectively referred to herein as a “3DS” or “3-DS”): (ii) methods and systems of training and methods and systems of computer implemented trainings that may employ or utilize the exemplary 3DS; and (iii) methods and systems for fabricating the exemplary 3DS and/or promoting the performance of the exemplary methods and systems, including computer implemented methods and systems, of the current invention for use in various industries including, without limitation, the medical and aesthetic (cosmetic) service industries. As indicated herein above, contemplated exemplary embodiments for the current invention can include computer implemented or virtual representations of any exemplary 3DS embodiments. The exemplary methods and computer implemented methods are collectively referred to herein as “Methods”. These exemplary embodiments may promote a revolutionary approach to anatomical education and medical training, bridging the gap between theoretical knowledge and practical understanding and may further promote patient safety.

In general, the exemplary 3DS embodiments disclosed herein provide three-dimensional simulations, that may include one or more demographic bias indications, of human anatomy, comprising one or more human features, without limitation, features such as a head, neck, face, shoulder(s), chest, abdomen, leg(s), knee(s), feet and such other human anatomical features as may be contemplated. The exemplary 3DS embodiments provide the various simulations of human anatomical features by employing, identifying and describing one or more elements (aka, layers and components) including, without limitation, the following: (i) one or more simulated human anatomical tissue(s), layers, structures, and/or systems (individually and collectively referred to herein as “HALSS”), (ii) Features, (iii) Body Parts, (iv) Defects, (v) Target Sites, and/or (vi) Landmarks. These can be individually referred to by the given identifier (herein above) or collectively referred to herein as “HFDT”, “HFDTS”, “HFDTL”, “HFDTLs” or as is found throughout the instant specification. Any of the one or more simulated HFDTLs may be fabricated to promote and/or provide a high-fidelity, precise human anatomical simulation, or at least a substantially accurate anatomical simulation, and in one or more exemplary embodiments comprise a correlation with a desired demographic bias. Each of these elements are further defined herein below and throughout the instant application.

Exemplary embodiments of the present invention promote and provide exceptionally precise and high-fidelity three-dimensional simulations (3DS), wherein the exemplary 3DS may be provided in tangible physical form(s) or as a virtual (digital) representation(s) of various forms. It is further contemplated that the exemplary 3DS embodiments may be presented or represented in or comprise an (immersive) virtual environment(s). These 3DS simulations can replicate a multitude of human anatomical aspects, spanning an array of tissues, structures, systems, and other intricate anatomical elements, as comprehensively understood by experts in the field.

An exemplary embodiment of a three-dimensional simulation (3DS) can be capable of meticulously representing a diverse range of human anatomical body parts, features, systems, assemblies and structures. This may include, but is not necessarily limited to, promoting the intricate and accurate detailing of human anatomy such as the head, face, nose, ears, lips, cheeks, neck, throat, shoulders, elbows, wrists, hands, fingers, thoracic region, various internal organs, legs, knees, feet, toes and many other aspects of human anatomy as are known by those skilled in the art. The versatility of the exemplary embodiments of the current invention can extend to encapsulating numerous regions, properties, layers, structures, systems, landmarks, target sites, defects, and features inherent to the human anatomy and/or beneficially provided by the current invention. Each of these elements may be designed and configured without limitation, encompassing every conceivable aspect of human anatomy that is known and can be contemplated.

The creation of these exemplary 3DS embodiments, including without limitation any HFDTLs and the like, is not just limited to the exemplary physical models for the current invention. The current invention's exemplary embodiments may also allow for virtual (digital) representation of these 3DS including any HFDTLs and other aspects of a 3DS, providing a flexible approach to anatomical simulation. This dual capability-physical and virtual-enhances the utility of the 3DS, promoting it as an invaluable tool in various applications. Whether for aesthetic training, medical training, patient education, surgical planning, artistic endeavors, or as may be contemplated these 3DS simulations can be employed in myriad ways.

The scope of the current invention embraces an array of innovative construction and manufacturing techniques. This may include, among others, advanced 3D printing technologies and methodologies. These state-of-the-art techniques and technologies enable the creation of highly accurate and lifelike 3DS exemplary embodiments. By leveraging such cutting-edge technologies, the current invention may open new horizons in the various realms of endeavor, such as medical training, patient education, and clinical research, offering novel and unparalleled tools for understanding and exploring the human body in ways that were once the realm of science fiction.

The exemplary embodiments for the current invention that promote and/or provide high-fidelity, precise three-dimensional simulations including, without limitation, demographically determined 3DS, and methods and systems, can address various long-felt needs in the industry by promoting increased (i) cost-effective means for generating and thereby accessing 3DS, (ii) access to and opportunities for comprehensive, hands-on, real-world education and training (Methods) employing 3DS, (iii) access to and opportunities for delivery of 3DS and Methods of comprehensive, hands-on, real-world anatomical education and training employing demographically distinct 3DS (e.g., devices, tools and models) and (iv) availability of donated organs for transplant purposes.

Each variation and combination of factors and features presented in any exemplary 3DS embodiment can exemplify a determined demographic bias. For any exemplary embodiment of the current invention, the use of the term(s) “demographic”, “demographic bias”, “demographic bias factor”, “demographic bias feature”, “demographic bias indicator” and the like shall be understood as generally referring to the concept of demographics that may comprise description of various characteristics for an individual and, as such, may be intended to promote a significant recognition of an individual. For purposes of the current invention, demographics may be generally understood to significantly comprise description related to and promoting the ascertainment (e.g., via sensory acquisition) of one or more various characteristics, for example: race, ethnicity, age/generation, and/or gender. It is generally understood that demographics may relate to description of additional characteristics, such as, income, marital status, education, and homeownership. These and other characteristics as may be contemplated by those skilled in the art are used herein for the current invention to provide general categories by which to describe and promote an understanding of the exemplary embodiments of the current invention.

It shall be understood that definitions may vary as related to the identification of one or more characteristic and the categorization being promoted by any one or combination of demographic bias factors as simulated in any exemplary 3DS embodiments. For instance, for purposes of the current invention, while it can be understood that race may be generally defined as a category providing a description of physical traits and ethnicity as a category providing description directed to cultural expressions they may both be capable of being represented as part of a demographic indicator for the current invention. Therefore, it shall be understood that any use of or reference made herein to demographic bias factors shall be intended to encompass the singular or multiple factors and be non-limiting as to category and characteristics being defined and/or promoted.

Exemplary embodiments, both physical and virtual, of the current invention can provide significantly accurate, high-fidelity simulations of human anatomy and properties having distinct demographic characteristics. The demographic characteristics can be collectively understood to promote and simulate associated characteristics for and on an exemplary embodiment as they may appear in relation to the determined factors. It can be the case that in some additional, alternative, or selectively cumulative embodiments, the at least one demographic bias indicator provides the 3DS with an aesthetic associated with at least one demographic factor selected from the group consisting of age, gender, race, ethnicity, weight, height and skin tone. It is understood that the aesthetic presented by any of the exemplary embodiments for the current invention can be, at least in part, provided by any one or more of the simulated layers, features, structures, systems, defects and the like as may comprise the embodiment.

By way of a non-limiting example, the current invention can provide a 3DS simulation of a human head, face, neck, shoulders and chest that is representative of a twenty-five year old human. This specific example may further include any of the various aspects, features, defects, layers, structures and the like as may be contemplated by those skilled in the art including, without limitation, one or more layers (e.g., skin layer(s)), structures (e.g., skeletal, etc.,), features (e.g., nose, mouth, etc.,), defects (e.g., fat pads, lines, cysts, wounds, etc.,) and/or other characteristics that simulate those typically found for a twenty-five year old human. Alternatively, exemplary embodiments can include various other demographic and other factors or features that may be representative of a person of any age, gender, ethnicity, cultural background and like as may be contemplated by those skilled in the art.

For some of the exemplary embodiments of the current invention, as shown and described in reference to the drawing figures, general racial and ethnic characteristics may be identified and employed to enhance the understanding of the uniqueness that may be promoted or provided by the simulated 3DS's herein. The exemplary embodiments more specifically may refer to and use terms for the purpose of generally identifying a category and/or characteristic(s) that may promote a simulation providing and, therefore, ascertainment of a particular demographic and associated characteristics. The terms used herein that may provide a categorization based on and/or refer to race or ethnicity shall be understood as non-limiting and as being based on generally recognized and acceptable categories and descriptions, as may be provided by the U.S. Census Bureau that must adhere to the 1997 Office of Management and Budget (OMB), and can be seen to include (i) Black, (ii) Asian or (iii) White. These are non-limiting terms and shall be understood as simply intended to and providing descriptive clarity. The current invention contemplates that exemplary embodiments, as set forth in the instant application, may be generally described in reference to other terms that provide a categorization based on and/or refer to race or ethnicity and that these may include, without limitation, Hispanic, American Indian or Alaska Native, Native Hawaiian or Other Pacific Islander. Therefore, merely for purposes of clarity in regards to the current invention set forth in the instant application, it shall be understood that description provided herein may reflect a perspective that is or may be generally accepted in one or more geographic and/or geo-political regions. For instance, in the United States, the term Black may be defined and understood as a person having origins in any of the Black racial groups of Africa. Therefore, this characteristic may have become generally accepted to mean people of black African ancestry and may include identifiers, without limitation, such as black and African American. Asian may be defined and understood as a person having origins in any of the original peoples of the Far East, Southeast Asia, or the Indian subcontinent including, for example, Cambodia, China, India, Japan, Korea, Malaysia, Pakistan, the Philippine Islands, Thailand, and Vietnam. White may be defined and understood as a person having origins in any of the original peoples of Europe, the Middle East, or North Africa and may include identifiers such as Caucasian, non-hispanic and any other identifiers as may be generally understood to promote the heretofore described understanding. However, it shall be understood that these terms and other terms may have quite different meanings in other countries and/or geo-political regions. Therefore, it shall be understood that the instant application for the current invention may generally promote the understanding in the United States of America and also contemplates and shall be inclusive and respectful of all different categories, characteristics and definitions.

Exemplary embodiments of this disclosure may promote and provide three-dimensional training device(s) and demographically determined three-dimensional training device(s) based on an exemplary structural framework. By way of non-limiting example, a structural framework can be a structure established to promote or correspond to a general configuration whereby, a simulation presenting an ascertainable aesthetic (appearance) corresponding to at least one human anatomical feature can be achieved. It is understood that the structural framework can promote a demographically biased appearance for exemplary 3DS embodiments. It is further understood that these exemplary embodiments may comprise at least one or any combination of a HFDTLs and/or demographic bias indicator disposed on or proximal to at least a portion of the structural framework or variously about the 3DS structure. Additionally, these one or more, or any combination of an HFDTLs and other characteristics may be positioned relative to one another.

Exemplary embodiments of the current invention can comprise methods and systems that provide methods of creating, constructing, printing, fabricating, manufacturing and/or generating in any manner an exemplary training device (3DS) and computer implemented Methods of such, wherein such may be collectively referred to herein as producing (aka, “Producing”) an exemplary 3DS embodiment. Further, exemplary embodiments of the current invention comprise systems that provide Methods and computer implemented Methods of producing exemplary 3DS embodiments having at least one HFDTLs. Still further, exemplary embodiments of the current invention comprise systems that provide Methods and computer implemented Methods of producing a 3DS having at least one HFDTLs, wherein the 3DS and the HFDTLs can further promote the representation and ascertainment of one or more desired or determined demographic characteristic.

Exemplary embodiments of the present invention may and can provide methods and systems for providing and delivering education and training employing exemplary 3DS that can be used to serve various needs including, without limitation, providing 3DS for the education and training on the performance of medical, cosmetic and/or aesthetic treatments, procedures and services (also referred to herein throughout as “MACS”). Exemplary embodiments of the current invention comprise various training processes, Protocols, methods and other instructional approaches that employ one or more of the 3DS, collectively these may also be referred to herein as “3DS Training Methods” or “Training Methods”. The 3DS employed in the exemplary Training Methods can comprise at least one or more HFDTLs and other features as may be contemplated.

Using one or more 3DS and/or generating one or more 3Ds by using a 3D printing device(s) these 3DS can be generated and represent various human anatomical constructs including, without limitation, one or more various HFDTs. Any exemplary 3DS can provide a demographically distinct representation of various human anatomical constructs including, without limitation, one or more various HFDTs as may be contemplated. By promoting an increased access to these types of 3DS, including the methods and systems, for developing and generating these 3DS, the present invention may promote (i) increased hands-on educational and training opportunities for MACS service providers, (ii) increasing service provider knowledge, (iii) promoting demographically distinct anatomical training and (iii) promoting patient safety and minimization of complications and harm, all while promoting an increase in availability of and access to cadavers and/or organs available to be used for donation and potentially, transplants.

By way of non-limiting example, a 3DS can be employed to enable the providing of a person (referred to herein as “User”, “Service Provider” or “Trainee”) with instruction, training, teaching, guidance or such other form of education and/or training as may be contemplated related to one or more MACS. In exemplary embodiments, a 3DS can provide a Trainee with access to a significantly accurate representation of a desired human anatomical construct and, thereby, promote the Trainee's ability to gain real-world, hands-on experience, training and education related to the performance of one or more MACS. Preferably, exemplary method embodiments of the current invention enable the performance of one or more MACS in conjunction with, employing and/or upon one or more 3DS, thereby, promoting a more real-world experience for a Trainee.

It shall be understood that any disclosure and description herein regarding any step, protocol, characteristic, aspect, feature, component or other identified element, provided in reference to one of the exemplary 3DS devices, methods for creating and/or employing a 3DS can also be applicable to any other. Further, all disclosure provided for any exemplary 3DS or method for creating and/or employing a 3DS can be understood as applicable to all exemplary embodiments of the current invention.

By integrating any or all such detailed and comprehensive descriptive elements into any of the exemplary 3DS simulations, methods and/or systems, the current invention can open up new realms of possibility in understanding, teaching, and interacting with the complex beauty of human anatomy.

### BRIEF DESCRIPTION OF THE DRAWINGS

The objects and advantages of the invention will be understood by reading the following detailed description in conjunction with the drawings in which:

FIG. 1A illustrates a perspective view of an exemplary first demographically determined three-dimensional training device (referred to herein as a “3DS”), wherein the 3DS simulates a head (face), neck, shoulders and chest regions for a twenty-five year old human having a general demographic bias (appearance) indicators of a person of a female gender and Black (African American) race;

FIG. 1B illustrates a perspective view of the first exemplary demographically 3DS, wherein the 3DS simulates a head (face), neck, shoulders and chest regions for a forty-five year old human having a general demographic bias (appearance) indicators of a person of a female gender and Black (African American) race;

FIG. 1C illustrates a perspective view of the first exemplary demographically 3DS, wherein the 3DS simulates a head (face), neck, shoulders and chest regions for a sixty-five year old human having a general demographic bias (appearance) indicators of a person of a female gender and a Black (African American) race;

FIG. 2A illustrates a perspective view of an exemplary second demographically determined three-dimensional training device (referred to herein as a “3DS”), wherein the 3DS simulates a head (face), neck, shoulders and chest regions for a twenty-five year old human having a general demographic bias (appearance) indicators of a person of a male gender and Black (African American) race;

FIG. 2B illustrates a perspective view of the first exemplary demographically 3DS, wherein the 3DS simulates a head (face), neck, shoulders and chest regions for a forty-five year old human having a general demographic bias (appearance) indicators of a person of a male gender and Black (African American) race;

FIG. 2C illustrates a perspective view of the first exemplary demographically 3DS, wherein the 3DS simulates a head (face), neck, shoulders and chest regions for a sixty-five year old human having a general demographic bias (appearance) indicators of a person of a male gender and Black (African American) race;

FIG. 3A illustrates a perspective view of an exemplary third demographically determined three-dimensional training device (referred to herein as a “3DS”), wherein the 3DS simulates a head (face), neck, shoulders and chest regions for a twenty-five year old human having a general demographic bias (appearance) indicators of a person of a female gender and Asian race;

FIG. 3B illustrates a perspective view of the first exemplary demographically 3DS, wherein the 3DS simulates a head (face), neck, shoulders and chest regions for a forty-five year old human having a general demographic bias (appearance) indicators of a person of a female gender and Asian race;

FIG. 3C illustrates a perspective view of the first exemplary demographically 3DS, wherein the 3DS simulates a head (face), neck, shoulders and chest regions for a sixty-five year old human having a general demographic bias (appearance) indicators of a person of a female gender and Asian race;

FIG. 4A illustrates a perspective view of an exemplary third demographically determined three-dimensional training device (referred to herein as a “3DS”), wherein the 3DS simulates a head (face), neck, shoulders and chest regions for a twenty-five year old human having a general demographic bias (appearance) indicators of a person of a male gender and Asian race;

FIG. 4B illustrates a perspective view of the first exemplary demographically 3DS, wherein the 3DS simulates a head (face), neck, shoulders and chest regions for a forty-five year old human having a general demographic bias (appearance) indicators of a person of a male gender and Asian race;

FIG. 4C illustrates a perspective view of the first exemplary demographically 3DS, wherein the 3DS simulates a head (face), neck, shoulders and chest regions for a sixty-five year old human having a general demographic bias (appearance) indicators of a person of a male gender and Asian race;

FIG. 5A illustrates a perspective view of the first exemplary demographically 3DS, wherein the 3DS simulates a head (face), neck, shoulders and chest regions for a twenty-five year old human having a general demographic bias (appearance) indicators of a person of a female gender and Caucasian race;

FIG. 5B illustrates a perspective view of the first exemplary demographically 3DS, wherein the 3DS simulates a head (face), neck, shoulders and chest regions for a forty-five year old human having a general demographic bias (appearance) indicators of a person of a female gender and Caucasian race;

FIG. 5C illustrates a perspective view of the first exemplary demographically 3DS, wherein the 3DS simulates a head (face), neck, shoulders and chest regions for a sixty-five year old human having a general demographic bias (appearance) indicators of a person of a female gender and Caucasian race;

FIG. 6A illustrates a perspective view of the first exemplary demographically 3DS, wherein the 3DS simulates a head (face), neck, shoulders and chest regions for a twenty-five year old human having a general demographic bias (appearance) indicators of a person of a male gender and Caucasian race;

FIG. 6B illustrates a perspective view of the first exemplary demographically 3DS, wherein the 3DS simulates a head (face), neck, shoulders and chest regions for a forty-five year old human having a general demographic bias (appearance) indicators of a person of a male gender and Caucasian race;

FIG. 6C illustrates a perspective view of the first exemplary demographically 3DS, wherein the 3DS simulates a head (face), neck, shoulders and chest regions for a twenty-five year old human having general demographic bias (appearance) indicators of a person of a male gender and Caucasian race;

FIG. 7 illustrates a perspective view of an exemplary demographically determined three-dimensional training device (referred to herein as a “3DS”), wherein the 3DS simulates a head (face), neck, shoulders and chest regions including a plurality of training features for a twenty-five year old human;

FIG. 8 illustrates a perspective view of an exemplary demographically determined three-dimensional training device (referred to herein as a “3DS”), wherein the 3DS simulates a head (face), neck, shoulders and chest regions including a plurality of training features for a forty-five year old human;

FIG. 9 illustrates a perspective view of an exemplary demographically determined three-dimensional training device (referred to herein as a “3DS”), wherein the 3DS simulates a head (face), neck, shoulders and chest regions including a plurality of training features for a sixty-five year old human;

FIG. 10 illustrates a perspective view of an exemplary fat pad system and structure and ligament system and structure as may be found within a three-dimensional training device (referred to herein as a “3DS”), wherein the 3DS simulates a facial structure of a human head including a plurality of fat pad features and ligament features for a human;

FIG. 11 illustrates a perspective view of an exemplary skeletal system and structure as may be found within a three-dimensional training device (referred to herein as a “3DS”), wherein the 3DS simulates a skeletal system and structure of a human head including a plurality of skeletal features;

FIG. 12 illustrates a perspective view of an exemplary musculature system and structure as may be found within a three-dimensional training device (referred to herein as a “3DS”), wherein the 3DS simulates a musculature system and structure of a human head including a plurality of features;

FIG. 13 illustrates a perspective view of an exemplary vasculature system and structure as may be found within a three-dimensional training device (referred to herein as a “3DS”), wherein the 3DS simulates a vasculature system and structure of a human head including a plurality of features;

FIG. 14 illustrates a perspective view of an exemplary tissue (dermal) system and structure as may be found within a three-dimensional training device (referred to herein as a “3DS”), wherein the 3DS simulates a tissue (dermal) system and structure of a human head including a plurality of features;

FIG. 15 is a block diagram illustration of an exemplary method for producing a three-dimensional training device (referred to herein as a “3DS”), wherein the 3DS can simulate one or more human anatomical features; and

FIG. 16 is a block diagram illustration of an exemplary method for providing training employing a three-dimensional training device (referred to herein as a “3DS”), wherein the 3DS can simulate one or more human anatomical features that can be related to the training.

It is to be understood that the figures are not drawn to scale. Further, the relation between objects in a figure may not be to scale, and may in fact have a reverse relationship as to size. The figures are intended to bring understanding and clarity to the structure of each object shown, and thus, some features may be exaggerated in order to illustrate a specific feature of a structure.

### DETAILED DESCRIPTION

Described herein, and incorporating all description as provided in the instant application, are (i) three-dimensional training devices, demographically determined three-dimensional training device(s) and demographically determined virtual three-dimensional training device(s) and/or simulations (collectively referred to herein as a “3DS”); (ii) methods and systems of training and methods and systems of computer implemented trainings that can employ or utilize the exemplary 3DS; and (iii) methods and systems for fabricating the exemplary 3DS and/or promoting the performance of the exemplary methods and systems, including computer implemented methods and systems, of the current invention for use in various industries including, without limitation, the medical and aesthetic (cosmetic) service industries.

As previously indicated, the exemplary 3DS embodiments disclosed herein provide three-dimensional simulations, that may include one or more demographic bias indications, of human anatomy, comprising one or more human features including, without limitation, features such as a head, neck, face, shoulder(s), chest, abdomen, leg(s), knee(s), feet and such other human anatomical features as may be contemplated. The exemplary 3DS embodiments provide the various simulations of human anatomical features by employing, identifying and describing one or more layers and components including, without limitation, the following: (i) one or more simulated human anatomical tissue(s), layers, structures, and/or systems (individually and collectively referred to herein as “HALSS”), (ii) Features, (iii) Body Parts, (iv) Defects, (v) Target Sites, and/or (vi) Landmarks. These can be individually referred to by the given identifier (herein above) or collectively referred to herein as “HFDT”, “HFDTS”, “HFDTs”, “HFDTL”, and/or “HFDTLs”. Any of the one or more simulated HFDTLs may be fabricated to promote and/or provide a high-fidelity, precise human anatomical simulation, or at least a substantially accurate anatomical simulation, and in one or more exemplary embodiments comprise a correlation with a desired demographic bias. Each of these components are further defined herein below and throughout the instant application.

In exemplary embodiments, the HALSS, which can be utilized independently or in a synergistic, selectively cumulative manner, are designed to include and simulate one or more human anatomical tissues, layers, structures, and systems. These HALSS components can promote and provide an unparalleled depth of realism in simulating human anatomy, catering to a wide range of aesthetic, educational, medical, and research needs.

Delving into the specifics, the HALSS layers are designed to significantly emulate various tissue layers within the human body. By way of non-limiting examples, the HALSS may include, without limitation, any one or combination of the following: (i) skin layer, (ii) muscle layer, (iii) artery structures, (iv) nerve structures, (v) superficial musculoaponeurotic system structure(s), (vi) gland structures, (vii) skull structure, (viii) cartilage structures. At the forefront is an outer (surface) or one or more epidermis-simulating layer(s), which can be configured and constructed to promote and mimic the look, color, texture, feel and other unique characteristics of human skin as closely as possible. This layer may not only be the first point of contact in simulations but also sets the stage for the deeper, more complex layers underneath. Under this outer layer, additional HALSS can be strategically placed.

Adjacent to, or subjacent beneath, the one or more epidermis-simulating layer, may lie one or more dermis-simulating layers. This dermis-layer can be subdivided into an upper dermis-simulating layer and a lower dermis-simulating layer, each configured to represent the different properties and functions of the dermis. The upper layer may simulate the papillary region of the dermis, while the lower layer represents the reticular region, offering insights into the intricacies of the skin's structure.

Further promoting or enhancing the realism, a subcutaneous-simulating layer may be disposed inwardly from the dermis-simulating layer. This layer is designed to replicate the subcutaneous tissue, adding another level of complexity and depth to the simulation. The inclusion of these layers can promote comprehensive exemplary embodiments of the skin's anatomy, from the outermost epidermis down to the underlying subcutaneous tissue.

These simulated human tissue layers can be employed individually or in concert to create a highly realistic and interactive exemplary 3DS models. These exemplary embodiments can further include demographic characteristics that promote appearance and anatomical features in accordance with determined desires or requirements. Such an advanced 3DS framework opens new avenues in the fields of aesthetic training, medical training, surgical planning, and patient education, providing a tactile and visual experience that promotes an enhanced real human anatomy experience.

In furtherance of the diverse scope and applications of the exemplary 3DS embodiments of the current invention, it is envisaged that they may include, comprise, encompass, promote or enhance the understanding of various and demographically determined human anatomical structures or systems. This includes, but is not limited to, detailed musculature, skeletal, or integrated musculoskeletal systems and structures

As an illustrative, non-restrictive example, one could consider the inclusion of a muscle-simulating layer, designed to replicate the texture, density, and functionality of human muscles. This layer, positioned just beneath a subcutaneous-simulating layer, serves to provide a realistic representation of how muscles lie under the skin, offering invaluable insights for medical and aesthetic professionals and students alike.

Further expanding on this exemplary 3DS invention, a skull-simulating or broader skeleton-simulating structure may also be incorporated. This structure, designed to be positioned beneath the muscle-simulating layer, aims to replicate the shape, density, and mechanical properties of human bones. The combination of these layers-skull or skeleton, muscle, and subcutaneous-creates a comprehensive, multi-dimensional model that may closely mimic real human anatomy.

Such layered, interactive exemplary embodiments of the current invention not only facilitate a deeper understanding of human anatomy but also pave the way for more advanced aesthetic training, surgical training, physiotherapy education, and biomechanical studies. They offer a tactile and visual experience, which can be based on demographically determined requirements, that is unparalleled, allowing for a more thorough exploration of the complexities and nuances of the human body. This inventive approach has the potential to significantly enhance the learning curve in medical education and provide a more hands-on, experiential form of learning.

In the intricate process of configuring, crafting and establishing the comprehensive three-dimensional exemplary embodiments (3DS) that form the cornerstone of the current invention, the one or more simulated HFDTLs can be expertly manipulated and shaped. This process transforms, in whole or in part, these HFDTLs into an array of forms, aspects, characteristics, and components, each designed to represent a specific part, region, area or aspect of human anatomy. Thus, these forms, aspects, characteristics, and components, which may be individually known and referred to as a ‘Feature’ or ‘Body Part’ and collectively as ‘Features’ or ‘Body Parts.’ are central to the functionality and versatility of the 3DS. The promoted correlation of these Features or Body Parts with determined demographic characteristics, as may be provided by the exemplary embodiments of the current invention, further comprise the unique aspects that provide the novel distinctiveness for the current invention.

The scope of these simulated Features or Body Parts is vast and inclusive, covering the full and wide array of human anatomy. This includes, but is not limited to, the simulation of various areas such as the head, face, neck, chest, torso, hips, legs, and feet. Additionally, this may further include simulated organs, vessels, skeletal structures, muscles, and the like as are known. It is contemplated that each exemplary 3DS provides astonishing detail, ensuring the promotion of as realistic and accurate representation of human anatomy as possible.

The various exemplary embodiments of a 3DS for the current invention may promote and/or provide high definition, high fidelity, significantly accurate and/or accurate simulations, modeling and representations, both physical and virtual, of aspects of human anatomy and physical properties thereof. An exemplary 3DS can provide simulations of various anatomic areas and/or regions, and these may comprise or include one or more various HFDTLs each of which may comprise various characteristics and/or properties. For example, a 3DS can provide a simulation of a human head, face, neck, throat, shoulders, thoracic region, organs, legs, feet and other areas and any combination thereof.

Exemplary embodiments, both physical and virtual, of 3DS of the current invention can provide significantly accurate, high-fidelity simulations of human anatomy and properties having distinct demographic characteristics. The demographic characteristics can be collectively understood to promote and simulate associated aesthetic and other characteristics for and on the 3DS as they may appear in relation to the determined factors. Further, exemplary 3DS can include various other demographic and other factors or features that may be representative of a person of any age, race, gender, weight, height, skin tone and/or other demographic factor. Each variation and combination of factors and features may exemplify a determined demographic bias/indicator for any exemplary 3DS embodiment and, as previously identified, can be understood and referred to herein as the demographic bias, demographic bias factor(s) or bias feature(s).

As previously described, the exemplary 3DS embodiments, including any exemplary virtual embodiments, can comprise a simulation of one or more HFDTLs. The HFDTLs can provide a simulation or (virtual) representation of various features, which may further include distinct demographic bias factor(s), present in a 3DS including, without limitation, one or more of body part, tissue layer, fat pad, musculature structure, vasculature structure, organ structure, skeletal structure, glandular structure and any other anatomical feature or any combination thereof. Further, simulated Defects can include, without limitation, cysts, wounds, lymphomas, lesions (tumors), scars, blood vessels, arteries and any combination(s) thereof.

In accordance with an exemplary embodiment for the current invention a 3DS provides a simulation (physical and/or digital [virtual]) of a human structure including, without limitation, anatomical head, facial framework (face), neck, shoulders and chest. The 3DS can include one or more HFDTLs, each of which may be located at similar or distinct positions upon the surface and/or within one or more layers (including below an outer surface layer), features, structures and the like of the 3DS. For instance, a 3DS can employ constructs, referred to herein as Target Sites that can be variously configured, such as, for instance, a depression (slight or significant) and/or hollow compartment(s) within one or more layer, and within which one or more Defect(s) may be positioned. Further, the Target Sites can be covered or at least partially covered by a cover or flap, wherein the cover can include at least a section that can be connected and removed from the 3DS over the position where the Target Site has been established. It is contemplated for one or more of the various exemplary 3DS embodiments that one or more of the HFDTLs can be at least partially encompassed or embedded within one or more of these Target Sites. It is contemplated that any one or more HFDTLs can be positioned upon, within and throughout the 3DS and in various proximity to one or more additional HFDTLs.

It shall be understood that any disclosure and description provided herein for a 3DS may be understood as applicable to, but not required by or for, any other or all other exemplary embodiments of the current invention that employ a 3DS or for which a 3DS may be contemplated. Further, any characteristic, aspect, component, feature, body part or other identified element, such as any HFDTLs, provided in reference to one 3DS may also be applicable to, but not required by or for, any other embodiment of the current invention. As has been described, the HFDTLs as presented in any exemplary embodiment for the current invention may comprise one or more tissue, structure, feature, defect and the like that may be selected from any of the associated characteristics. For instance, an exemplary Defect can comprise any one or more characteristic that may be from the group consisting of a cyst, wound, lesion, scar, fat pad, lymphoma, and any other such characteristic as may be known or contemplated by those skilled in the art or any combination thereof. An exemplary structure or feature can comprise any one or more Landmark, such as glands, muscles, vascular structures (i.e.,blood vessels and/or arterial structures), foramen (skeletal structures), ligaments and other well-known features. Further, an exemplary training device may comprise at least one or any combination of HFDTS disposed upon at least one of the at least one simulated human tissue layer and/or skeletal structure.

It is also understood that an exemplary embodiment of the current invention may comprise one or more HFDTLs and other well-known features can be positioned relative or proximal to any one or more of the other HFDTLs. Any one or more stuctures, features and the like may comprise, be positioned relative to and or extend through any of the one or more tissue layers, structures and/or HFDTLs presented by the exemplary device. Therefore, it is a critical advantage of the current invention that it can significantly promote the ascertainment of “landmark” or “landmarks” and may properly identify the location of any one or more of these layers, structures, features and the like relative to any one or more other HFDTLs and the one or more tissue layers and skeletal structure that comprise any one of the exemplary three-dimensional training devices embodied.

All disclosure made in reference to a specific exemplary embodiment of the current invention including, without limitation, any HFDTLs, characteristic, aspect, feature, component or other identified element can be understood, where appropriate, as applicable to another. The exemplary 3DS of the current invention can comprise embodiments that may significantly promote an anatomically accurate training device.

Various exemplary embodiments for the present invention can comprise demographically determined three-dimensional (3DS) aesthetic training simulations that may be used for enabling, demonstrating, practicing, providing, performing and/or implementing any services as may be contemplated by those of ordinary skill in the art.

Accordingly, the current invention provides demographically determined, three-dimensional simulations, representations, tools, devices and/or models (3DS) and methods and systems for addressing various needs by promoting increased (i) cost-effective means for generating and thereby accessing 3DS, (ii) access to and opportunities for comprehensive, hands-on, real-world education and training (Methods) employing 3DS, (iii) access to and opportunities for delivery of 3DS and Methods of comprehensive, hands-on, real-world anatomical education and training employing demographically distinct devices, tools and models and (iv) availability of donated organs for transplant purposes.

Medical and aesthetic and/or cosmetic services contemplated by and for the current invention can include, without limitation, numerous and various applications, treatments, diagnostics, prognostics, procedures, options and others as known by those skilled in the art and are collectively referred to herein as MACS″. One or any combination of MACS can individually and/or collectively comprise one or more step(s), instruction(s), method(s), requirement(s) and the like as may be contemplated by those of ordinary skill in the art (collectively referred to herein as “Protocol” and “Protocols”). MACS employed in accordance with exemplary embodiments of the current invention can encompass various fields of care including, without limitation, (i) skin care, (ii) oral care. (iii) sun care, (iv) hair care, (v) decorative cosmetics, (vi) body care and (vii) perfumes. The current invention includes various exemplary embodiments that focus on promoting benefits within any contemplated fields of care.

Exemplary embodiments of the current invention can include a focus on MACS that promote skin and body care. It shall be understood, therefore, that MACS is a broad term used to cover a wide and varied array of medical, aesthetic and cosmetic services, within this it includes treating scars, skin laxity, fine lines and wrinkles, and various other treatment options as are known by those skilled in the art. Non-surgical cosmetic procedures (treatment options) employed in accordance with exemplary embodiments of the current invention can vary but may be generally understood to include, without limitation, injections (anti-wrinkle), Botulinum toxin (type A) and dermal (soft-tissue) fillers, skin boosters, microdermabrasion (chemical peel), laser therapies, and non-surgical body sculpting (i.e., Coolsculpting®), and other services as are known by those in the field. Generally, the aesthetic procedures can be understood or classified by mode of delivery to include (i) Injectables (e.g., botulinum, fillers, boosters), (ii) Emulsions (e.g., microdermabrasion) and (iii) Laser (ablative or non-ablative) therapies.

The MACS employed in accordance with exemplary embodiments of the current invention can include various ingredients (i.e., active ingredients and characteristics) and various mechanisms for how these active ingredients reach or are delivered to a desired location target site and/or live tissue). Generally, there are three mechanisms that can be employed by the current invention to promote delivery of active ingredients to a target site (e.g., Defect, Feature) including (i) Intercellular, (ii) Transcellular and (iii) Transappendageal. Delivery can be affected by many factors such as but not necessarily limited to (i) concentration of active ingredients, (ii) pH (lower pH=deeper penetration), (iii) molecular size and weight (Micro and Macro-particle sizing and also nanotechnology) and (iv) characteristics of ingredients (e.g., water and lipid-solubility.). The use of various devices (e.g., needles, patches, lasers and other means) and other associated devices external thereto are contemplated for use in accordance with the exemplary embodiments of the current invention. In addition to the devices previously identified, devices for promoting the performance and/or delivery of a treatment option contemplated for the current invention can include, without limitation, (i) ultrasound/microdermabrasion, (ii) high frequency current application, (iii) galvanic current application and others as may be contemplated by those skilled in the art.

Embodiments of any exemplary 3DS, as disclosed herein, shall be understood and are contemplated to promote or provide significantly accurate and demographically distinct simulations of human anatomy and physical and other properties of human tissue layers, structures, features and the like. It can be understood that the various exemplary 3DS embodiments disclosed and described herein may comprise numerous and various components and/or characteristics. As disclosed and described throughout the instant specification, an exemplary 3DS embodiment, can be understood to comprise one or more characteristics, components, features, structures, parts, assemblies and the like as may be contemplated herein.

For the current invention, the use of the term demographic, demographic bias, demographic bias indicator and the like shall be understood as generally referring to the concept of demographics that may comprise description of various characteristics for who an individual is and who any exemplary embodiment is intended to promote a significant recognition of. For purposes of the current invention, demographics may be generally understood to significantly comprise description related to and promote the ascertainment (e.g., via sensory perception) of one or more various characteristics, for example: race, ethnicity, age/generation and/or gender. It is generally understood that demographics may relate to description of additional characteristics, such as, income, marital status, education, and homeownership. These and other characteristics as may be contemplated by those skilled in the art are used herein for the current invention to provide general categories by which to describe and promote an understanding of the exemplary embodiments of the current invention.

It shall be understood that definitions may vary as related to the identification of one or more characteristics and the categorization being promoted by any one or combination of demographic bias factors as simulated in any exemplary 3DS embodiments. For instance, for purposes of the current invention, while it can be understood that race may be generally defined as a category providing a description of physical traits and ethnicity as a category providing description directed to cultural expression, they are both being promoted as part of a demographic description. Therefore, it shall be understood that any use of or reference made herein to demographic bias factors shall be intended to encompass the singular or multiple factors and be non-limiting as to category and characteristics being defined and/or promoted.

In general, the exemplary embodiments disclosed herein identify and describe one or more HALS, Features, Defects, Target Sites and/or Landmarks (collectively referred to herein as previously indicated). The HFDTLs are further defined herein below and throughout the instant application. Further, any exemplary 3DS embodiment of the current invention can be understood to comprise any one or more or any combination of one or more HFDTLs. It is understood that a 3DS of the current invention may comprise additional components and/or characteristics without departing from the scope and spirit of the instant invention.

Any one or combination of these can be understood to be configured having certain appearance, dimensional, volumetric and other contemplated properties as may be indicated herein and contemplated by those skilled in the art. Any of the (i) general properties for, including without limitation the appearance, dimensional, volumetric and/or other sizing properties; (ii) proximal relation to, (iii) aspect ratio between and/or (iv) correlation or similarity of appearance given any and all HFDTLs can significantly vary based on an exemplary 3DS embodiments and any desired demographic bias (described herein) for any exemplary embodiments. The desired appearance characteristics can be based on various demographic characteristics and, further, upon such other characteristics that may be visually and/or virtually simulated and provide a visually and/or virtually ascertainable simulation of characteristics for various conditions, diseases, and the like as may be contemplated.

The exemplary 3DS embodiments can comprise and be configured to include one or more simulated human anatomical tissue layers, structures, features, parts and/or systems (collectively referred to herein as previously indicated). Each HALSS, individually and/or collectively included, that may be formed and generated using various techniques and technologies and in various manners including, without limitation, integrally, connectably, interchangeably and as may be further contemplated by those skilled in the art. It is contemplated that an exemplary 3DS, including any and/or all of its HFDTLs, may include one or more simulated structures and/or tissue layers including, without limitation, skin layers, fatty layer(s), muscles, blood vessels, nerves, glands, bone, cartilage, and/or other tissues and body parts.

It is contemplated that these simulated layers, such as a skin-simulating layer, as shown for many of the exemplary embodiments of the current invention comprise one or more physical properties that attempts to simulate and/or does correlate with one or more properties found in or embodied by that of human tissue, including but not limited to high tensile strength, elongation and hardness. It is further contemplated that for any simulated layers for the current invention it can possess similar properties and provide similar characteristics as found in actual human tissue and/or structure. As such, the current invention provides an exemplary 3DS device that promotes a real-world, life-like simulation and may promote the performance of or upon which to perform various and numerous MACS techniques. For example, the skin-simulating layer of the exemplary 3DS provides a surface and device upon which MACS practitioners may perform complex techniques on simulated human HFDTLs without the risk of tearing through or creating a deformation in a human tissue.

It is contemplated that high-risk anatomical areas, may include but not be limited to the head, face, throat and neck and/or may include various structures or features including, without limitation, vascular structures, glands, foramens, and the like. One or more of the HFDTLs can be understood as positioned, located or distributed within various areas of a 3DS of the current invention wherein the performance or mis-performance of one or more MACS (aesthetic and/or cosmetic services [i.e., procedures, protocols, treatments, services and/or techniques] for delivery of an active ingredient) may result in various temporary or more permanent harmful outcomes that may range from tissue necrosis, to deformation, to destruction of anatomical features, to blindness, to stroke and other well-known complications, based on damage done to one or more simulated layers formed for the 3DS. For instance, it may result in deformation of one or more of the simulated skin layers and/or any adjacent or underlying additional simulated tissue layers, structures and/or systems. For example, a sculpting process performed on the neck and/or chest may result in deformation of skin in those areas, in the form of stretching or buckling. In another example, the performance of one or more MACS in or around Target Sites (such as the exemplary Target Sites 760, 860 and/or 880) may promote an increase in the incidence of buckling (e.g., loss of elastic fibers, resorption of skeletal elements, re-positioning of sub-cutaneous features and the like) as areas surrounding the eyes and the mouth can be considered high-risk and prone to buckling.

Any of the simulated layers, that may comprise any one or more HFDTLs, including any one or more layers, structures, features, defects and the like, may be generated from or use one or more materials, including but not limited to plastics, polymers, elastomerics, composites, other materials, additives, and/or any combinations thereof, such that these layers possess similar or the same characteristics, such as substantially the same or similar tensile strength, hardness and/or elongation at break point as that of an actual layers, structures, features, defects and the like as found in a human anatomical feature. It is further contemplated that a simulated HFDTLs may comprise a synthetic polymer layer, for instance a polyfiber layer, to provide additional support to the simulated layer. In exemplary embodiments, the thickness of one or more of the various simulated layers may range from about 0.1 mm to about 100.0 mm. It is contemplated that the various simulated layers may range from about 0.5 mm to about 10 mm. It is further contemplated that the thickness or other dimensional characteristic(s) of any simulated layer(s) or tissue(s) may be less than or greater than the ranges specifically identified herein, without departing from the scope and spirit of the instant invention. These simulating layer(s) may further comprise the addition of a dye to simulate the pigmentation of human tissue. For example, the dye may be an oil-based flesh tone pigment for an epidermis simulated layer.

The one or more simulated layers including, without limitation, one or more HFDTLs, can be further shaped, through the process of generating the comprehensive 3DS simulation, into various forms, aspects, characteristics and/or components (individually referred to herein as a “Feature” or “Body Party” and collectively referred to herein as “Feature(s)” or “Body Parts”) of a human anatomy, such as simulated (i) areas and regions including, without limitation, head, face, neck, chest, torso, hips, legs, feet, and the like and (ii) body parts, assemblies and structures including, without limitation, nose, ears, lips, cheek, shoulders, elbows, wrists, hand, fingers, knees, toes and the like as may be contemplated. Any and all Feature(s) can be generated (physically and/or virtually), fabricated or formed for use and employed in exemplary embodiments of the current invention. It is contemplated that these Features, singularly or in any combination, can have various dimensional, volumetric and other sizing characteristics that may range from about 0.1 mm to about 1 m. It is further contemplated that the various simulated Features may comprise any one or more characteristics ranging from about 0.5 mm to about 200 mm.

By way of example, and as shown and described, at least in part or in whole, in reference to the drawing figures of the instant application it can be seen that the simulations provide, at least in part, a simulated human head that may include, without limitation, an age, gender and racial demographic bias indicators. Identification of various traits or characteristics of the features being represented by the exemplary 3DS simulations of the current invention can promote and increase a comprehensive understanding and sensory perception of the location or position of any one or more HFDTLs by a person interacting with the exemplary 3DS. A human head can be generally understood to include (i) face, (ii) eyes, (iii) nose, (iv) ears, (v) mouth, (vi) teeth. (vii) chin and (viii) hair. Additional or fewer traits or features can be included in any exemplary 3DS embodiment including a head without departing from the scope and spirit of the current invention.

Description of the various traits or features of the areas being represented can promote and increase a comprehensive understanding of and sensory perception by a person interacting with the exemplary simulated 3DS embodiments of the current invention. Therefore, facial features can promote a broad characterization, description and perception in terms of the size and shape of the whole face and/or its component parts (e.g., big/small head; short/long and wide/thin face, prominent or retrusive chin). The appearance of each facial feature has an effect on the sensory perception of facial traits. For instance, it may be that an exemplary simulated 3DS for the current invention which includes a gender based demographic bias may simulate a female face that, based on generalizations, may provide a sensory perception wherein the female face is smaller, has larger cheeks and has smaller and less prominent brows, noses, and chins compared with other exemplary 3DS embodiments that include a gender based demographically biased simulation of a male face. It is shown and contemplated that an exemplary simulated 3DS embodiment for the current invention may promote a broad characterization, description and perception in terms of (i) Afrocentric facial features that may generally include, without limitation, dark skin/complexion, wide nose, full lips, dark eye color, coarse hair as compared to the Asian and/or White exemplary simulated 3DS embodiments; Asian facial features that may generally include, without limitation, lighter skin/complexion (as compared to Afrocentric features), smaller nose, thinner lips, darker eye color, straight black hair as compared to the Black and/or White exemplary simulated 3DS embodiments. White facial features that may generally include, without limitation, lighter skin/complexion, narrower nose, thinner lips, lighter hair color as compared to the Black and/or Asian exemplary simulated 3DS embodiments. It is recognized by and for the instant application and exemplary embodiments for the current invention that it may describe as comprising a wide range of simulated facial features, skin colors and textures, hair colors and textures, body and/or body part sizes and various other physical traits that may be included in and fully describe this race based demographic bias category in any simulated human 3DS embodiments. It is further contemplated that any demographic bias category shown and/or described in the instant application may include and fully simulate a wide range of simulated HFDTLs (e.g., HALSS, Features, Defects, Target Sites/Features and/or Landmarks). Therefore, it shall be understood that the exemplary 3DS embodiments, both shown and contemplated, for the current invention may provide and promote a sensory perception (i.e., visual ascertainment, touch, and the like) by a person who is interacting with any exemplary simulated 3DS simulating various HFDTLs and characteristics.

It is contemplated that any HEDTLs of an exemplary 3DS may be generally identified or landmarked as locations or positions on, about, within and/or otherwise associated with the 3DS (as previously identified herein these may be individually referred to herein as layers, structures, features and the like). It is understood that the location of any or more HEDTLs can be a site for or proximally positioned relative to a site for the application of a MACS treatment as contemplated herein. A treatment can comprise the injection of an active ingredient into a location that is substantially defined by a blood vessels, arteries, glands, foramens and the like as may be contemplated by those skilled in the art. As discussed herein, the application of a treatment can occur in critical areas of the human anatomy and the capability for practice upon models that provide substantially real-world, life-like simulations of human anatomy provided by the current invention is a critical advantage. For instance, if an injection is to be made in the temple area of a human anatomy, then it is a critical advantage to not only understand that there is a temporal artery in that area but actually be enabled by the current invention to landmark the artery and practice delivering the injection and avoiding the temporal artery. Avoiding the temporal artery is important due to the risk of causing blindness should an injection be made into the artery. Further, vessels and arteries that run into and out of the face and back into the skull may be encompassed by foramens. As such, the mistaken injection into the foramen of an active ingredient during the performance of a MACS treatment protocol can also cause critical damage. The real-world simulation and practice of various treatment protocols that is enabled through employment of any of the various embodiments of the current invention promotes a significant advantage for the practitioners performing the treatments and may significantly improve the safety for persons receiving one or more of the MACS treatment protocols.

It is contemplated that any element of an exemplary 3DS can include various defects and/or defect-simulating structures, which may be generally identified as locations or positions on, about, within and/or otherwise associated with the 3DS (as previously identified herein these may be individually referred to herein as “Defect” and collectively referred to herein as “Defects”). In exemplary embodiments of the current invention, it is contemplated that one or more, or a combination of various defects and/or defect-simulating structures can be seamlessly integrated or removably connectable with, in or upon the 3DS. These elements are recognized as critical components, often representing locations, positions, or anomalies on, about, within, or in any way associated with the exemplary embodiments. The Defects can be configured in various positions about the simulated 3DS and/or proximal to any element, such as cheeks, nose, forehead, chest, arm, leg and the like. The range of possible defects is extensive, potentially encompassing, but not limited to, features such as lines, fat pads, lesions, wounds, cysts, lymphomas, scars, and an array of other defects as recognized or envisioned by experts in the field, and in various combinations. Each of these Defects can be combined in any number of ways and may promote the exemplary 3DS embodiments of the current invention as a comprehensive tool for aesthetic training, medical training, education, and research.

It is understood that the location of any one or more Defect(s) can be a site for application of a MACS treatment as contemplated herein. A treatment can comprise the injection of an active ingredient into a location that is substantially defined by a Defect such as a cyst, lesion, lymphoma and the like. As discussed herein, the application of a treatment can occur in critical areas of the human anatomy and the capability for practice upon models that provide substantially real-world, life-like simulations of human anatomy provided by the current invention is a critical advantage. For instance, as described herein above, if an injection is to be made in a Defect positioned proximally to a temple area of a human anatomy, then it is a critical advantage to not only understand that there is a temporal artery in that area but actually be enabled by the current invention to landmark the artery and practice delivering the injection and avoiding the temporal artery. Avoiding the temporal artery is important due to the risk of causing blindness should an injection be made into the artery. Further, vessels and arteries that run into and out of the face and back into the skull may be encompassed by foramens. As such, the mistaken injection into the foramen of an active ingredient during the performance of a MACS treatment protocol can also cause critical damage. The real-world simulation and practice of various treatment protocols that is enabled through employment of any of the various embodiments of the current invention promotes a significant advantage for the practitioners performing the treatments and may significantly improve the safety for persons receiving one or more of the MACS treatment protocols.

These Defects may comprise a remarkable range of diversity, allowing for a broad spectrum of sizes, shapes, and configurations. It is contemplated that the Defect(s) may range in size from 0.5 mm to 100 mm or more. It is contemplated that the various Defects may range from about 0.10 mm to about 50 mm. This flexibility ensures that each Defect can be strategically positioned in various positions around an exemplary simulated 3DS embodiment. The placement of these Defects is not confined to superficial layers but can be proximal to any aspect of an exemplary embodiment. This includes but is not limited to any layer, structure, feature, or system, such as cheeks, nose, forehead, chest, arm, leg, and similar areas.

Furthermore, the selection of Defects for any exemplary embodiment of the current invention is not limited to a singular type. They can range from common conditions like cysts, wounds, and scars to more specific and medically significant entities like fat pads and lymphomas. In some additional, alternative, or selectively cumulative embodiments, the Defect can be a cutaneous defect-simulating structure or protrude above an outer-most surface of the simulated human tissue layer. This wide array of options ensures that the exemplary embodiments can cater to a vast range of educational and clinical needs, promoting realistic and comprehensive 3DS models for study and exploration.

By incorporating these various Defects into any of the exemplary 3DS embodiments, the invention may offer an invaluable resource for professionals and students alike in various fields. It promotes access to a significantly realistic platform for understanding and applying various MACS protocols and procedures, and may further promote the diagnosing and treating a wide range of medical conditions, thereby enhancing the depth and breadth of education and practice.

In some additional, alternative, or selectively cumulative embodiments, the 3DS may further comprise what is referred to herein as at least one “Target Site” or “Target Feature” disposed upon the 3DS. Reference to a Target Site shall be understood as a generic reference to one or more various positions or locations upon or within an exemplary 3DS where the presence or at least partial presence of any of the one or more HFDTLs as described herein throughout the instant application may be more likely to be found, likely to be found or ascertainable by association therein. Thus, it shall be understood that reference to a Target Site is not a necessary requirement nor an indication of any anatomical feature presented upon or within any of the exemplary 3DS embodiments. Further, the absence or presence of a Target Site for any of the exemplary embodiments, shall be understood as non-limiting and is not intended and shall not be understood as a requirement or necessary claimed feature for the current invention.

In some additional, alternative, or selectively cumulative embodiments, the at least one Target Site is a location or position within or upon an exemplary 3DS embodiment that is intended to present that understanding that it encompasses or at least partially encompasses at least one Defect disposed therein. It can be understood for exemplary embodiments of the current invention that the target site can be configured as a hollow, enclosure, compartment or other space located within an exemplary construct that comprises a 3DS embodiment for interaction with one or more of the HFDTLs. It is contemplated that an at least one Target Site may allow for at least one HFDTL(s) to be removable from and/or insertable within and, thereby, allows for the interchange of various HFDTL(s) within an exemplary 3DS. Still further, a Target Site can comprise a cover, flap, or other overlay structure which can be removably connected and provide for the at least partial encompassment of a structure disposed therein.

Exemplary embodiments of the current invention are notably inclusive of one or more additional anatomical features, encompassing a wide spectrum such as glands, muscles, vascular structures (including blood vessels and arterial structures), foramen (pertaining to skeletal structures), ligaments, and other well-known anatomical features. These specific types of features, along with others recognized by those with expertise in the field, can be identified as “landmarks” or “Landmarks” within the context of the invention. The careful identification of the type and position of such landmarks in an exemplary embodiment can be pivotal as it may facilitate the safe and effective execution of various medical and/or aesthetic and cosmetic (MAC) protocols or procedures, the details of which will be elaborated upon herein.

A crucial aspect of this invention is the understanding that one or more of the aforementioned HFDTLs may be situated in proximity to one or more other HFDTLs or vice versa. This intricate positioning is understood to allow for any HFDTL of the current invention to be incorporated into, positioned relative to, or even extend through any other HFDTL presented by the exemplary 3DS device embodiments.

A significant advantage of the current invention may lie in its ability to substantially aid in the identification of these landmarks, which may also enhance the proper ascertainment of defects, structures, and/or features. The positioning of any simulated layer, structure, feature, or defect within any exemplary simulation, such as a 3DS or training device, is designed to be relative to the positioning of other layers, structures, systems, features, or defects within the same embodiment.

Consequently, the exemplary embodiments of the current invention may promote, enable, or enhance the effective identification, through both visual and tactile sensory perceptions, of any one or more simulated HFDTLs presented therein and/or contained within. This precise and multi-sensory approach promoted by exemplary embodiments of the current invention may significantly elevate the educational and practical value of the invention, providing a comprehensive and interactive tool for aesthetic and medical training and practice

It is understood that various other features may be simulated by an exemplary 3DS, for example, a simulation of a thoracic region may include, without limitation, a chest, hair, nipples, a skeletal structure (i.e., ribs, spine, etc.), tummy, belly button, hips, diaphragm, heart, liver, stomach, other internal organs and such other one or more HFDTLs as may be contemplated. The exemplary 3DS embodiments including any reference made herein to a 3DS shall be understood as capable of including one, any combination and/or all of the physical or virtual simulations, representations, images and modeling of one or more areas and/or regions of human anatomy including any of the one or more various HFDTLs. Therefore, any exemplary 3DS can, either individually or in any combination, include HFDTLs as may be described for any other exemplary 3DS of the current invention.

Additionally, or optionally, an exemplary 3DS embodiment for the current invention may further include one or more Target Site(s) for performing training. It is contemplated that the Target Sites may be general locations that correspond to or association with one or more HFDTLs and may range in size from about 1 mm to 200 mm or more. It is contemplated that the one or more Target Sites can be positioned upon a 3DS and define, represent and be included as one or more of the “Defects” described for the current invention. It may be understood that the use of one or more Defects and/or Target Sites may be generated for any exemplary 3DS, and promote the training, teaching and/or performance of one or more MACS protocols.

It is contemplated that any simulated human anatomical structure can comprise, be configured to include, generated and/or constructed with one or more representative HFDTLs. For instance, a simulated human head can include a face or facial framework that can further comprise, without limitation, a nose, mouth, lips, eye(s), eyebrows, cheeks, ears, hair, jaw and other features as may be contemplated. The structure may further include any one or more HFDTLs and the like as may be contemplated. Any one or combination of HFDTLs can be integrally formed in providing an exemplary 3DS. It is further contemplated that any one or combination of HFDTLs can be removably connected to a structural framework that underlies the 3DS or any framework provided for simulating one or more element of the 3DS. It is still further contemplated that any one or combination of HFDTLs can be removably connected to and with one another individually or in any combination for an exemplary 3DS.

It is understood that various other Features may be simulated by an exemplary 3DS, for example, a simulation of a thoracic region may include, without limitation, a chest, hair, nipples, a skeletal structure (i.e., ribs, spine, etc.), tummy, belly button, hips, diaphragm, heart, liver, stomach, other internal organs and such other HFDTLs and the like as may be contemplated. A 3DS can also simulate a human lower body region and may include, without limitation, a skeletal structure (i.e., hips, legs, feet, etc.), thighs, knees, ankles, toes and such other parts, characteristics and/or HFDTLs as may be contemplated. No limitation or restriction of the simulation of human anatomy and tissue properties provided by an exemplary 3DS is intended or should be understood as required.

The exemplary 3DS embodiments including any reference made herein to a 3DS shall be understood as capable of including one, any combination and/or all of the physical or virtual simulations, representations, images and modeling of one or more areas and/or regions of human anatomy including any of the one or more various HFDTLs. Therefore, any exemplary 3DS can, either individually or in any combination, include HFDTLs as may be described for any other exemplary 3DS of the current invention. For example, a 3DS(s) can simulate separately or in any combination a human head, face, neck, shoulders and chest with one or more (any combination of) skin, skull, arteries, vessels, fat pads, lesions, ligaments, muscles, tissues, foramens, eyes, mouth, nose, hair, ears and such other HFDTLs as may be contemplated. It can be further understood that any 3DS, including any HFDTLs, may be configured individually or in any combination to comprise various properties, dimensions, volumes, appearance characteristics and other characteristics and the relationships, ratios, associations between any one or combination thereof as may be contemplated by those skilled in the art.

In various embodiments, the 3DS, including any HFDTLs, may be sized in proportion to actual human tissue being represented. This general sizing can be influenced by or in accordance with the needs of a method, particular MACS Protocol and/or combination of two or more MACS employed in the performance of exemplary embodiments of the current invention. For example, a 3DS can comprise various HFDTLs and other characteristics as may be contemplated, each of which promoting, providing and/or comprising, without limitation, certain length, width, height, radius, diameter and other contemplated dimensional characteristics, between about one millimeter (1 mm) to about two meters (2m). It is contemplated for embodiments that the 3DS can be configured with HFDTLs and other characteristics ranging from 0.5 mm to 3m. It is understood that the various properties and/or characteristics for any part of or comprehensive exemplary 3DS for the current invention can vary outside or within the ranges stated herein and may do so significantly without departing from the scope and spirit of the current invention. Desired properties and/or dimensions can be selected by a user and/or service provider, determined by a MACS Protocol(s), automatically determined by a computer program that is executable upon a computing device or other contemplated means.

The exemplary 3DS embodiments can comprise one or more simulated human tissue layers, structures and/or systems. The one or more simulated layers can comprise an outer (surface) layer and one or more additional layers subjacent to the surface layer and relative to one another. It is contemplated that any one or more layer or structure can be connected (operationally and/or functionally) with any other one or more other layer or structure. This connection can be represented by simulating known human anatomical systems/parts/features and any other means as may be contemplated.

Any exemplary embodiments of the current invention can comprise a plurality of simulated human tissue layers including, without limitation, skull-simulating structures, skin-simulating layers, cutaneous and/or sub-cutaneous defect-simulating structures, target site-simulating structures, muscle-simulating layers, artery or blood vessel-simulating structures, feature-simulating structures, nerve-simulating structures, a superficial musculoaponeurotic system-simulating structure, gland-simulating structures, cartilage-simulating structures, other simulations as contemplated by those skilled in the art and/or any combinations thereof.

Any of the one or more simulated HFDTLs may be fabricated to promote and/or provide an anatomically correct simulation, or at least substantially anatomically correct simulation, in correlation with a desired demographic bias. As will be shown in the drawings and described herein the simulated human anatomical structures and/or features are simulated in approximate proportion to what may generally be considered standard appearance for human tissues. It is understood that an exemplary 3DS for the current invention can be configured to capture, display and/or present any desired appearance.

In order to achieve the high-fidelity simulation provided by the current invention, it is contemplated, for example, that any simulating layer, may be generated having appearance (aesthetic), tensile, elongation and hardness characteristics similar to those found in actual human tissue associated with the characteristics represented by the 3DS. It is contemplated that achieving fidelity for the simulated layers may comprise an epidermis (skin) simulating layer which is the outermost layer of the 3DS, a dermis-simulating layer subjacent to the epidermis-simulating layer comprising an upper dermis-simulating layer and a lower dermis-simulating layer and a subcutaneous-simulating layer disposed inwardly from the dermis-simulating layer. Therefore, any HFDTLs may comprise and be configured including any one or combination of layers. Further, any HFDTLs, including any defect-simulating structure, may be disposed within the epidermis-simulating layer extending up through a surface of the outer-most epidermis-simulating layer. It is contemplated that a cutaneous HFDTLs (e.g., defect) structures may be embedded in any position throughout a 3DS including, without limitation, in critical, high-risk anatomic locations (e.g., near eyes, mouth, nose) and/or structures such as vascular, glandular, foramen, and the like. It is further contemplated that any HFDTs may extend above the surface, providing a raised or protruding structure on the surface of the epidermis-simulating layer.

Any one or more of the plurality of simulated layer(s) can be configured entirely separately from any other layer and/or in any form of relationship, association and/or correlation with or to at least part or all of any other layer. For example, a skin-simulated layer may provide a continuous or fully encompassing outer surface for an exemplary 3DS or in the alternative provide less than a continuous or fully encompassing outer surface. Further, a secondary (or additional) layer may be fully exposed to, partially exposed to or have no exposure to any one or more other layer and may be fully encompassing or less than fully encompassing of the general configuration provided for a 3DS. The configuration established for any layer may have various appearance, dimensional, volumetric and other characteristics and that between multiple layers may place one layer on top of, beneath, adjacent or in any relational positioning as contemplated by those skilled in the art.

It is contemplated that an exemplary 3DS may simulate various HFDTLs that may be found within and provide one or more interactive features during and for the performance of MACS services and enabling the capabilities of the current invention. For example, a 3DS can comprise a muscle-simulating layer which may be positioned subjacent to a subcutaneous-simulating layer. A skull-simulating (and/or skeleton-simulating) structure may be included and may be positioned subjacent to the muscle-simulating layer. The muscle-simulating layer may simulate one or more superficial muscles of the head and neck, including, but not limited to, the frontal, occipital, procerus, orbicularis oculi, transverse nasalis, levator labii superioris alaeque nasi, levator labii superioris, zygomaticus minor, zygomaticus major, orbicularis oris, buccinator, depressor anguli oris, depressor labii inferioris, mentalis, and platysma. The muscle-simulating layer may simulate one or more other muscles that may be found in other human anatomical regions that are presented as an exemplary 3DS of the current invention. The skull-simulating structure may further comprise various additional layers and/or structures including, without limitation, a periosteum-simulating layer, a galea aponeurotica-simulating structure and others as may be contemplated.

An exemplary 3DS may also comprise a hinge or other directional movement capability to promote movements, such as an opening and closing of a mouth. The 3DS may further comprise simulated teeth (not shown) and/or a tongue-simulating structure (not shown). It is contemplated that any desired human anatomical feature can be simulated by and for any of the exemplary embodiments of the current invention.

Still further, nerve-simulating structures may be located on the muscle-simulating layer, or other layers as may be contemplated, in their correct anatomical positions. This nerve-simulating structure(s) may promote and/or enable a simulated nerve reaction during the performance of a MACS procedure. Further, bleeding may be simulated by including one or more blood vessel- and/or artery-simulating structures within an exemplary 3DS. Therefore, during performance of one or more MACS techniques upon the 3DS a MACS practitioner and service provider may gain experience with bleeding. In exemplary, non-limiting embodiments, one or more blood vessel-simulating structures may be incorporated into a lower dermis-simulating layer, and one or more artery-simulating structures may be positioned on a muscle-simulating layer or either may be incorporated into or located on such other layer(s) as may be contemplated. The artery-simulating structures of a facial structure may include, without limitation, the supratrochlear artery, the supraorbital artery, the temporal artery, the opthalmic artery, the angular artery, the transverse facial artery, the superior labial artery, and the inferior labial artery. It is understood that the description provided related to a human facial structure is merely exemplary and non-limiting and that any simulated human anatomical areas may include the appropriate features, structures, assemblies and the like as may be contemplated.

It is contemplated that exemplary 3DS embodiments may comprise various mechanical and/or electrical devices, assemblies and/or structures to provide various capabilities. For instance, a container for storing or holding a liquid (i.e., blood-simulating fluid) and a pumping device that may be manually or automatically operated in order to move the liquid through the blood- and/or artery-simulating structures. As such, the blood- and/or artery-simulating structures would comprise channels, tubes, or other fluid carriers within or on the layers of the exemplary 3DS in order to deliver and hold the fluid. Further, a generator may be operationally coupled with mechanical features, that can be representative of nerve-like structures, that may be positioned within or upon an exemplary 3DS and correlate with such similar structures as may be found in the human anatomy. The use of other mechanical means and/or devices to promote and provide a life-like 3DS simulation for the exemplary embodiments are contemplated within the scope of the current invention.

By way of further example, a superficial musculoaponeurotic system-simulating layer can be included within an exemplary 3DS and located on a muscle-simulating layer, such that artery-simulating structures and nerve-simulating structures are in their correct anatomical positions subjacent to or superficial to the superficial musculoaponeurotic system-simulating layer. Still further, cartilage-simulating structures may be included subject to a muscle-simulating layer. The cartilage-simulating structures can comprise various structures ranging from nasal cartilage-simulating structures to auricular cartilage-simulating structures (not shown). The nasal cartilage-simulating structures can include, without limitation, septa cartilage, lateral crus of the major alar cartilage, and minor alar cartilage. The cartilage-simulating structures also comprise the lateral fibro-fatty tissue.

Gland-simulating structures may be included superficially to the muscle-simulating layer and arranged in an anatomically correct disposition. It is contemplated that gland-simulating structures may include, without limitation, lacrimal glands, parotid glands and parotid duct-simulating structures. Lacrimal glands can be positioned in the anterior, superior, temporal region of the eye socket. Parotid glands can be positioned posterior to the mandibular ramus, anterior and inferior to the ear, and extending irregularly from the zygomatic arch to the angle of the mandible.

It is further contemplated that an exemplary embodiment of the 3DS of the current invention may comprise a support assembly, framework assembly and/or a mounting assembly (collectively referred to herein as “Forming Assembly” or “Structural Framework”). The Forming Assembly may comprise one or more devices including, without limitation, clips, screws, posts, nails and/or other contemplated connection technologies and devices, along with various directional movement devices, such as hinges, pivoting connectors (i.e., joints, ball and socket, swivel, etc.), and the like that provide a mechanism to which attachments and/or connections can be made. The Forming Assembly can comprise various connection mechanisms and technologies to promote affixing the 3DS to a solid platform. In operation, one or more devices of the Forming Assembly may connect or attach (i) directly to a solid support surface or (ii) to one or more additional forming devices to affix the 3DS to a solid support surface. It is also contemplated that the Forming Assembly may enable a direct connection of the 3DS to a solid platform or directly connect with a secondary mounting assembly that may enable a connection of the 3DS to a solid platform.

The forming assembly or structural framework promotes the simulated human tissue layer in a configuration that can promote an exemplary 3DS to display a representation of a desired aesthetic (appearance) including, without limitation, a desired at least one demographic bias indicator. It is understood that the 3DS device and any one, multiple and/or combination of any simulated human tissue layers, structures, systems, defects, and/or other features, may comprise, without limitation, multiple tissue layers, structures, systems and the like as is known and contemplated by those of ordinary skill in the art. For example, the structural framework can promote a 3DS that may comprise at least one or any combination of an epidermis layer, dermis layer, hypo-dermis layer, musculature layer, skeletal structure and/or any other simulated human tissue layer or anatomical structure, system or feature as may be known by those skilled in the art.

In some additional, alternative, or selectively cumulative embodiments, a simulated skin layer may comprise at least one epidermis-simulating layer which is the outermost layer of the 3DS, a dermis-simulating layer adjacent to the epidermis-simulating layer comprising an upper dermis-simulating layer and a lower dermis-simulating layer and a subcutaneous-simulating layer disposed inwardly from the dermis-simulating layer. It can be understood for embodiments that any one or more HFDTLs may be positioned in and/or on one or more of the simulated layers presented.

Disclosure and description for any exemplary 3DS can be referenced to a single, integral (solid) 3D structure and/or framework. This can encompass and may refer to the materials employed for the generation or fabrication process (described herein below) becoming solid. It is understood that an exemplary 3DS may not necessarily be a solid structure and can include one or more simulated HFDTLs and any one or combination of HFDTLs may further define, be configured including and/or comprise one or more unfilled or hollow spaces therein. Still further, an exemplary 3DS can be configured as a significantly open, porous or lattice-like structure and may in fact include spaces therein enclosing one or more one or more HFDTLs and/or other alternative substances such as a liquid, non-solid filling material, nerve-simulating mechanism and the like as may be contemplated.

The one or more simulated HALS (i.e., human anatomical layers, structures and/or systems) can include, without limitation, the following: (i) skin layer(s), (ii) blood vessel structure(s); (iii) artery structure(s); (iv) nerve structure(s); (v) cartilage structure(s), (vi) gland structure(s), (vii) muscle layer(s), (viii) system structure(s) (e.g., musculoaponeurotic and others), (ix) skull structure(s) and various other body part(s) as may be contemplated. Individually and/or collectively, the one or more HALS can be understood as promoting and/or providing one or more locations or positions upon which one or more protocols of one or more MACS can be performed. Further, any one or more HALS can be understood as promoting and/or providing one or more locations or positions that can be associated with or within any one or more HFDTLs of an exemplary 3DS for which one or more protocols of a MACS can be performed.

It can be understood that any one or combination of HFDTLs can be configured to promote and allow for a sensory (e.g., touch, visual, smell, etc.,) interaction by a user. This interactive capability can further promote the performance of any investigative techniques and/or performance of any protocols that may be required for performance of any one or more exemplary MAC method(s). It shall be understood that reference herein to a user can be any one or more person, practitioner, a service provider and/or person in training for the performance of one or more methods and/or MACSs or any combination thereof that may be for the current invention.

It is further contemplated that any exemplary 3DS of the current invention can be constructed and configured with connectable, removably connectable and/or interchangeable HFDTLs. Thus, an exemplary 3DS framework can include and comprise various structural features and mechanisms (technologies and devices) that promote the generation and fabrication of an exemplary 3DS. These structural features and mechanisms may include, without limitation, various fastener(s) and connector(s) structures and assemblies (e.g., male/female joint, etc.) that can enable the location and positioning of one or more HFDTLs relative to one or any combination of other HFDTLs.

For any of the exemplary embodiments of the current invention, it can be understood that various connections can be simulated, for example, a skin (surface) layer can be connected with a subjacent skull structure via a muscle layer. Further, for any 3DS that provides a physical simulation of one or more human tissues, anatomical areas and/or regions, it is understood that the connection of any one or more HFDTLs with another can be made by employing various technologies and techniques, for example, using various adhesive and/or laminate products to fix relative positions of two or more HFDTLs relative to one another. It is contemplated that one or more HFDTLs can be embedded and/or affixed via compressive force(s) within any of the one or more layers and/or structures and maintain a significantly fixed position. Alternative connector(s) (e.g., pins, plug and socket), materials and technologies can be employed as contemplated by those skilled in the art.

Any one or more HFDTLs can be relatively positioned upon, adjacent or subjacent to another, associated or correlated with, or be encompassed and/or embedded (including at least partially) to and/or within any other HFDTLs. By way of example, a 3DS can simulate a muscle layer which can further have superficially associated or at least partially encompassed therein various additional layers and/or structures including, without limitation, blood vessel, artery, gland, nerve and/or other HFDTLs. It is further contemplated that various associated systems can be simulated in relation to one or more of the layers and/or structures of an exemplary 3DS. For instance, in a simulated human cheek of a 3DS a superficial musculoaponeurotic system (SMAS) can be associated and/or connected with or onto the muscle layer. In this example, the SMAS can be relatively positioned (superficially and/or subjacent) to the various other layers and/or structures.

Exemplary embodiments of the 3DS can be configured and constructed from biologically acceptable materials suitable for medical and aesthetic (cosmetic) procedures, treatments, applications and/or options (MACS). For instance, a 3DS can be constructed employing biodegradable, bioresorbable or other materials as may be contemplated by those skilled in the art. These materials can include, without limitation, various (synthetic) polymers, metals, alloys, super elasto-plastic metals, super elastic metallic, super elasto-plastic metals, super elastic metallic, ceramics, allografts, xenografts, isografts, various composites and other contemplated materials and/or their composites, depending on the particular application and/or preferences. Contemplated composites and materials that may be employed in a 3DS for the current invention can include various flexible, semi-rigid and rigid materials of (i) metals (alloys and composites); (ii) plastics, polymers, thermoplastics, recyclable plastics; (iii) elastomers, elastomerics, or thermo-plastic or set elastomers; (iv) polyurethanes (silicone); (v) rubber (polymeric) materials; (vi) carbon materials; (vii) calcium based ceramics and/or phosphates; (vii) fabrics; (viii) hydrogels, (ix) bone materials and (x) tissue materials (growth or differentiation factors that can be readsorbable or partially resorbable materials), such as, for example, composites of metals, calcium-based materials, or various polymer (ic) materials and any of their combination(s).

The 3DS for the current invention may be comprised of various material composites including, without limitation, the above materials. The selection and use of any of the various materials may be to achieve various desired characteristics such as elasticity, rigidity, durability, strength, compliance, biomechanical performance or imaging preference. The 3DS may be fabricated from a homogeneous material or heterogeneous materials such as a combination of two or more of the above-described materials. The 3DS may be monolithically formed, integrally connected or include fastening elements, connectors, adhesives, and/or instruments, as described herein.

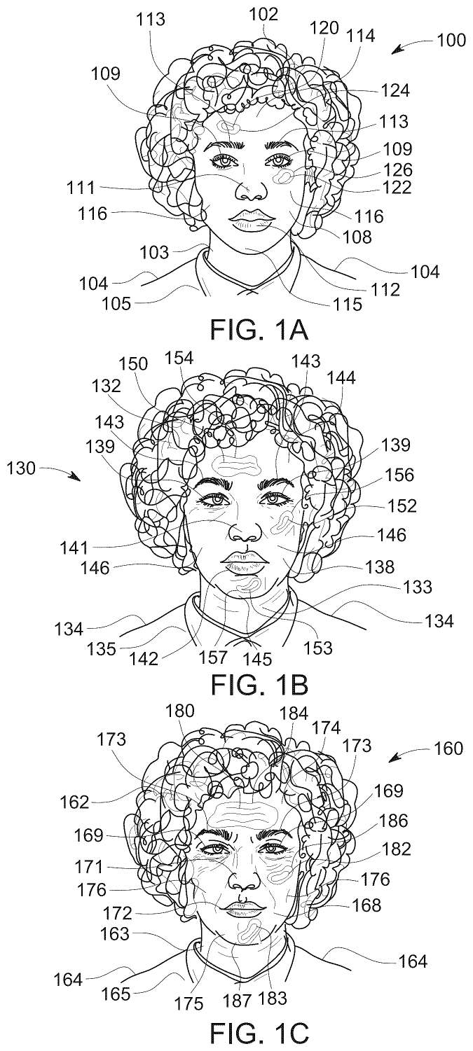

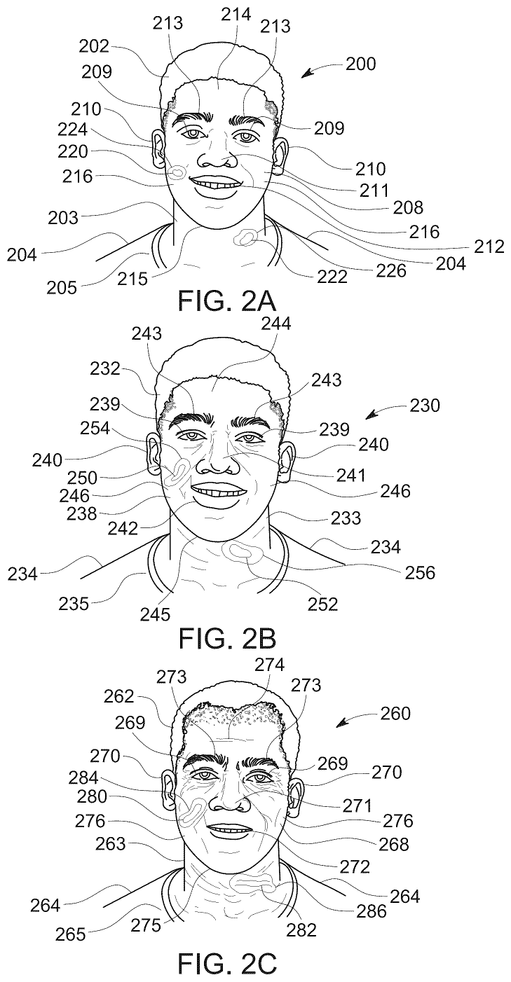

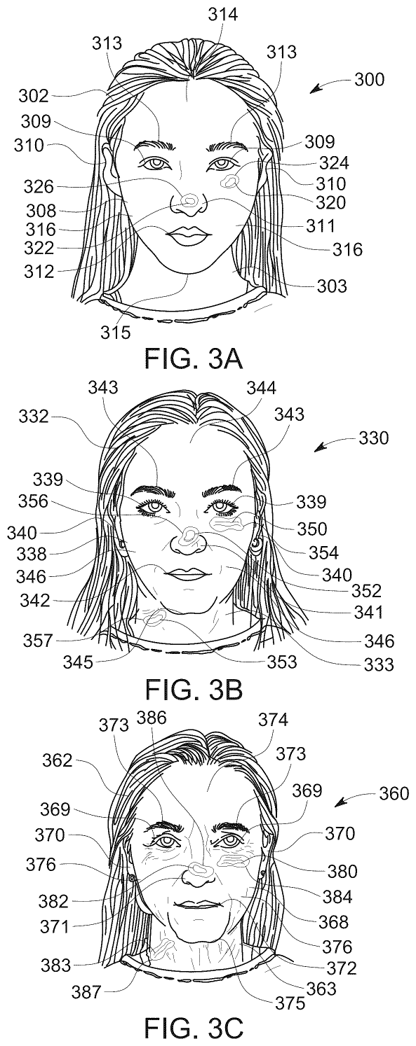

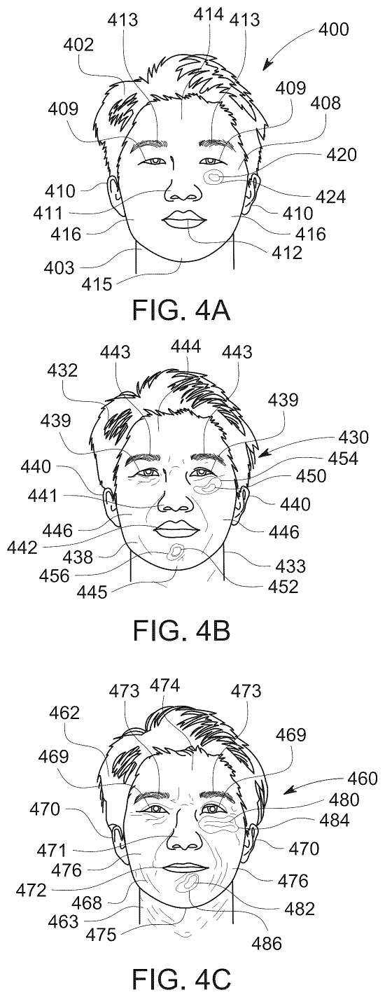

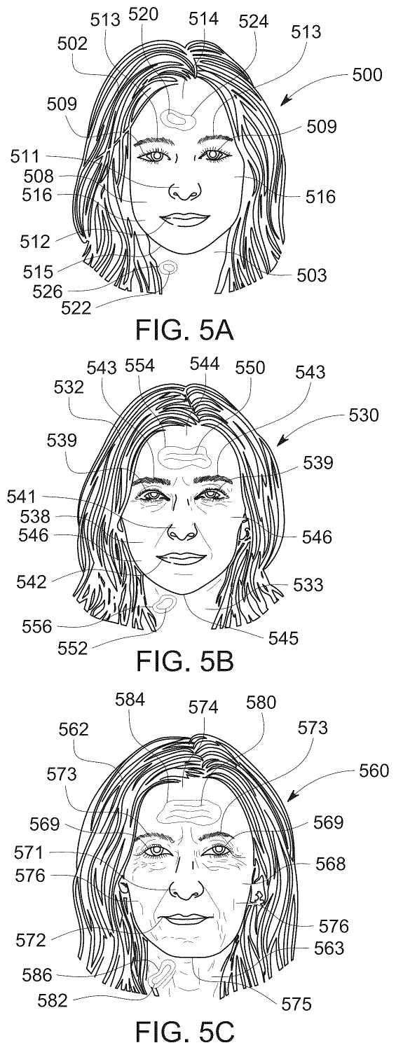

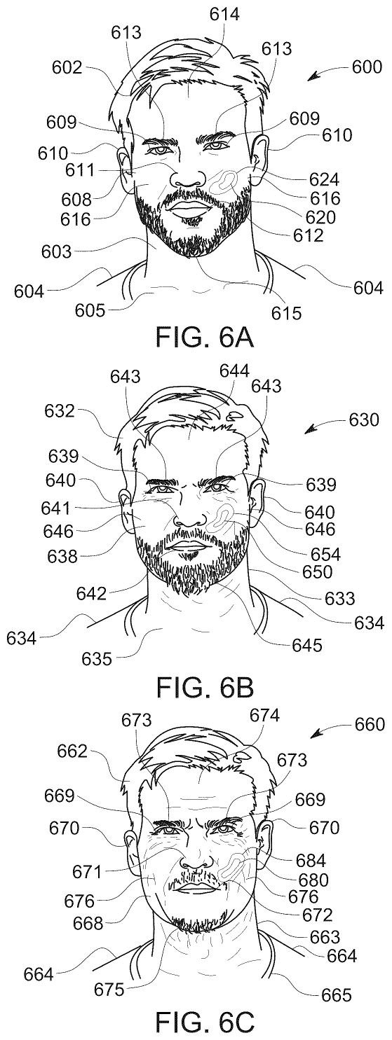

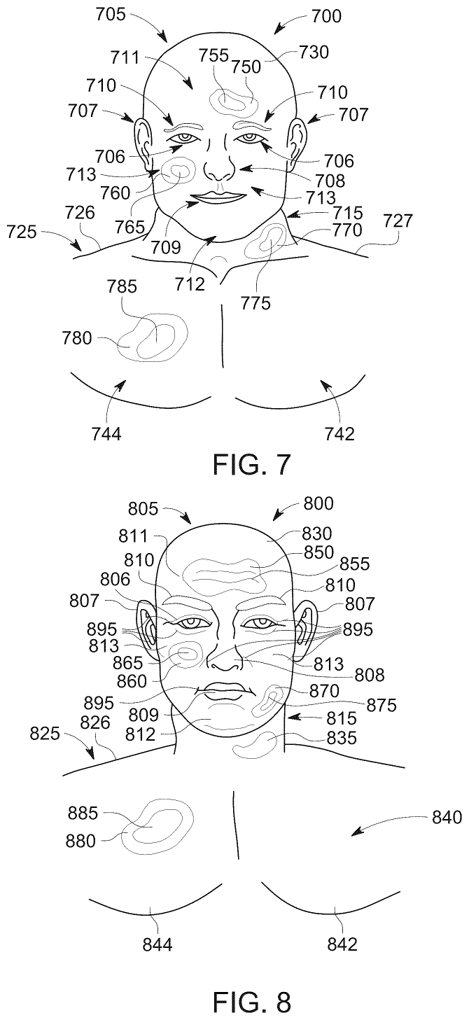

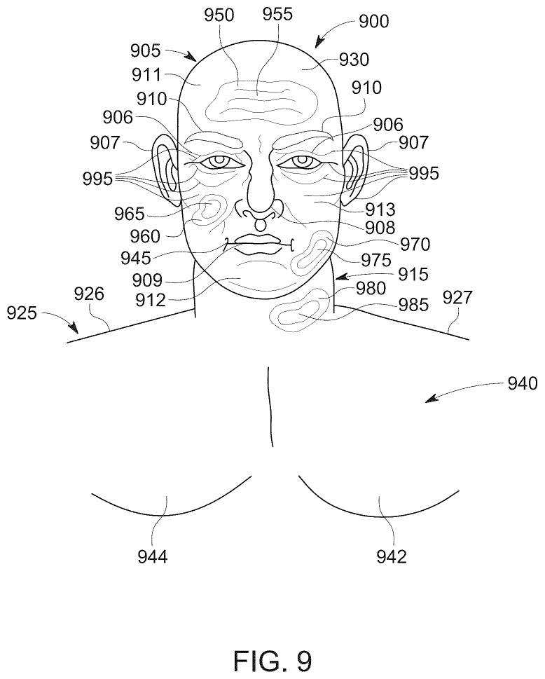

Described in reference to FIGS. 1A, 1B, 1C, 2A, 2B, 2C, 3A, 3B, 3C, 4A, 4B, 4C, 5A, 5B, 5C, 6A, 6B, 6C, 7, 8 and 9 (collectively referred to herein as “FIGS. 1-9”) a demographically determined three-dimensional training device(s), referred to herein throughout as “3DS”, is shown. Description provided herein shall be understood to apply individually and/or collectively, in whole or in part as may be contemplated by those skilled in the art, to each of the exemplary 3DS embodiments shown in FIGS. 1-9 and as are identified therein, respectively, as 100 (see FIG. 1A), 130 (see FIG. 1B), 160 (see FIG. 1C), 200 (see FIG. 2A), 230 (see FIG. 2B), 260 (see FIG. 2C), 300 (see FIG. 3A), 330 (see FIG. 3B), 360 (see FIG. 3C), 400 (see FIG. 4A), 430 (see FIG. 4B), 460 (see FIG. 4C), 500 (see FIG. 5A), 530 (see FIG. 5B), 560 (see FIG. 5C), 600 (see FIG. 6A), 630 (see FIG. 6B), 660 (see FIG. 6C), 700 (see FIG. 7), 800 (see FIGS. 8) and 900 (see FIG. 9).

FIGS. 1-9 exemplify embodiments for the current invention that can be generated and provide three-dimensional, demographically determined simulations of human anatomy, comprising one or more human features including, without limitation, features such as a head, neck, face, shoulder(s), chest, abdomen, leg(s), knee(s), feet and such other human anatomical features as may be contemplated. Further, any one or more human anatomical feature may additional comprise, individually or in any combination, any one or more of the HFDTLs as identified herein. The exemplary embodiments for the current invention may be configured as representative of human anatomical structures/parts in approximate proportion and aesthetic appearance to the actual anatomical regions, including any HFDTLs, that may be and/or are being represented. The exemplary 3DS embodiments, shown in FIGS. 1-9, simulate a human head, neck, shoulders and chest areas. Any one or combination of these areas can be understood as comprising one or more HFDTLs. The area(s) being represented in the current embodiments are representative, non-limiting examples, as the current invention may be simulations for any human anatomical structures, areas or regions including, without limitation, any HFDTLs.

Any exemplary 3DS, such as any shown in FIGS. 1-9, for the current invention may provide simulations that promote visually ascertainable demographic bias (appearance or aesthetic) indicators that reflect, at least in part, a general appearance having a demographic bias. For instance, the human anatomical structures, areas or regions including, without limitation any HFDTLs, may be simulated to promote the visual ascertainment of a general appearance that reflects, at least in part, a demographic bias based on gender (by birth or self-identification), racial background, ethnic background and/or age. It shall be understood that any of the simulated 3DS may promote a similarity to certain demographic bias indicators and that any deviation from the general appearance and/or HFDTLs that may or may not provide an accurate representation of such demographic bias indicators is not intended and shall be understood as a non-limiting factor for the embodiment(s).

As shown in the embodiments of FIGS. 1-9, a demographically determined, three-dimensional training device (3DS) promotes the ascertainment of and/or provides a simulation of a human head, neck, shoulders and chest. Each of the exemplary embodiments for the current invention significantly promote the landmarking (ascertainment) of one or more HFDTLs and other human anatomical characteristics as may be presented and may be contemplated by those of ordinary skill in the art. Still further, it can be understood that the exemplary embodiments shown in FIGS. 1-9 present at least one identifiable (visually or other sensory ascertainable) demographic bias indicator (simulated general aesthetic appearance or appearance indicator(s)).

As shown in FIGS. 1A, 2A, 3A, 4A, 5A, 6A and 7, the 3DS are demographically biased to provide a primary demographic bias indicator based on age and more particularly, for a twenty-five year old human. Referring to FIGS. 1B, 2B, 3B, 4B, 5B, 6B and 8, the 3DS are demographically biased having a primary demographic bias indicator based on age and more particularly, for a forty-five-year-old human. Moreover, FIGS. 1C, 2C, 3C, 4C, 5C, 6C and 9 depict the 3DS that are demographically biased to provide a primary demographic bias indicator based on age and more particularly, for a sixty-five year old human.

The 3DS 100 shown in FIG. 1A simulates a human head 102, neck 103, shoulders 104 and chest 105. The 3DS 100 comprises a simulated (skin) layer 108 (providing a thickness and an outer surface or top surface for 3DS 100) and a plurality of Features including eyes 109, nose 111, mouth 112, eyebrows 113, forehead 114, chin 115, cheek 116. 3DS 100, shown in FIG. 1A, is shown as further comprising a plurality of Defects or defect-simulating structure(s) 120 and 122 that are established in positions and/or locations target sites 124, 126 of the 3DS. The plurality of defects 120, 120 protrudes from an outer surface of the skin layer 108.

The 3DS 200 shown in FIG. 2A simulates a human head 202, neck 203, shoulders 204 and chest 205. The 3DS 200 comprises a simulated (skin) layer 208 (providing a thickness and an outer surface or top surface for 3DS 200) and a plurality of Features including eyes 209, ears 210, nose 211, mouth 212, eyebrows 213, forehead 214, chin 215, cheek 216. 3DS 200, shown in FIG. 2A, is shown as further comprising a plurality of Defects or defect-simulating structure(s) 220, 222 that are established in positions and/or locations i.e., target sites 224, 226 of the 3DS 200. The 3DS 300 shown in FIG. 3A simulates a human head 302, and neck 303. The 3DS 300 comprises a simulated (skin) layer 308 (providing a thickness and an outer surface or top surface for 3DS 300) and a plurality of Features including eyes 309, cars 310, nose 311, mouth 312, eyebrows 313, forehead 314, chin 315, check 316. 3DS 300, shown in FIG. 3A, is shown as further comprising a plurality of Defects or defect-simulating structure(s) 320, 322 that are established in positions and/or locations i.e., target sites 324, 326 of the 3DS 300.

The 3DS 400 shown in FIG. 4A simulates a human head 402 and neck 403. The 3DS 400 comprises a simulated (skin) layer 408 (providing a thickness and an outer surface or top surface for 3DS 400) and a plurality of Features including eyes 409, ears 410, nose 411, mouth 412, eyebrows 413, forehead 414, chin 415, check 416. 3DS 400, shown in FIG. 4A, is shown as further comprising a defect or defect-simulating structure 420 that is established in position and/or location i.e., target site 424 of the 3DS 400. The 3DS 500 shown in FIG. 5A simulates a human head 502 and neck 503. The 3DS 500 comprises a simulated (skin) layer 508 (providing a thickness and an outer surface or top surface for 3DS 500) and a plurality of Features including eyes 509, nose 511, mouth 512, eyebrows 513, forehead 514, chin 515, check 516. 3DS 500, shown in FIG. 5A, is shown as further comprising a plurality of defects or defect-simulating structure(s) 520, 522 that are established in positions and/or locations i.e., target sites 524, 526 of the 3DS 500. The 3DS 600 shown in FIG. 6A simulates a human head 602, neck 603, shoulders 604 and chest 605. The 3DS 600 comprises a simulated (skin) layer 608 (providing a thickness and an outer surface or top surface for 3DS 600) and a plurality of Features including eyes 609, cars 610, nose 611, mouth 612, eyebrows 613, forehead 614, chin 615, check 616. 3DS 600, shown in FIG. 6A, is shown as further comprising a defect or defect-simulating structure 620 that are established in position and/or location i.e., target site 624 of the 3DS 600. Although the 3DS 100, 200, 300, 400, 500, 600 includes age related demographic bias indicator of 25 years person, the one or more demographic bias indicators of 3DS 100, 200, 300, 400, 500, 600 may vary in gender and/or ethnicity. For example, it may be appreciated that the demographic bias indicator of 3DS 200 is different from that of the 3DS 100 in both gender and ethnicity.

The 3DS 130 shown in FIG. 1B simulates a human head 132, neck 133, shoulders 134 and chest 135. The 3DS 130 comprises a simulated (skin) layer 138 (providing a thickness and an outer surface or top surface for 3DS 130) and a plurality of Features including eyes 139, nose 141, mouth 142, eyebrows 143, forehead 144, chin 145, check 146. 3DS 130, shown in FIG. 1B, is shown as further comprising a plurality of defects or defect-simulating structure(s) 150, 152, 153 that are established in positions and/or locations i.e., target sites 154, 156, 157 of the 3DS 130. As can be seen from FIGS. 1A and 1B, the defects 120, 122 have progressed more with age, and the 3DS 130 an additional defect 153 on the skin layer 138 of the chin 146 that corresponds to an age-related defect. The 3DS 230 shown in FIG. 2B simulates a human head 232, neck 233, shoulders 234 and chest 235. The 3DS 230 comprises a simulated (skin) layer 238 (providing a thickness and an outer surface or top surface for 3DS 230) and a plurality of Features including eyes 239, ears 240, nose 241, mouth 242, eyebrows 243, forehead 244, chin 245, check 246. 3DS 230, shown in FIG. 2B, is shown as further comprising a plurality of Defects or defect-simulating structure(s) 250, 252 that are established in positions and/or locations i.e., 254, 256 of the 3DS. As can be seen from FIGS. 2A and 2B, the defects 220, 222 have progressed more with age.

The 3DS 330 shown in FIG. 3B simulates a human head 332 and neck 333. The 3DS 330 comprises a simulated (skin) layer 338 (providing a thickness and an outer surface or top surface for 3DS 330) and a plurality of Features including eyes 339, cars 340, nose 341, mouth 342, eyebrows 343, forehead 344, chin 345, check 346. 3DS 330, shown in FIG. 3B, is shown as further comprising a plurality of Defects or defect-simulating structure(s) 350, 352, 353 that are established in positions and/or locations i.e., target sites 354, 356, 357 of the 3DS 330. As can be seen from FIGS. 3A and 3B, the defects 320, 322 have progressed more with age, and the 3DS 330 includes an additional defect 353 on the skin layer 338 of the neck 333 which may correspond to an age-related defect. The 3DS 430 shown in FIG. 4B simulates a human head 432 and neck 433. The 3DS 430 comprises a simulated (skin) layer 438 (providing a thickness and an outer surface or top surface for 3DS 430) and a plurality of Features including eyes 439, cars 440, nose 441, mouth 442, eyebrows 443, forehead 444, chin 445, check 446. 3DS 430, shown in FIG. 4B, is shown as further comprising a plurality of Defects or defect-simulating structure(s) 450,452 that are established in positions and/or locations i.e., target sites 454, 456 of the 3DS 430. As can be seen from FIGS. 4A and 4B, the defect 420 has progressed or degenerated more with age, and the 3DS 430 includes an additional defect 452 on the skin layer 438 on the chin 435 which may correspond to an age-related defect.

The 3DS 530 shown in FIG. 5B simulates a human head 532 and neck 533. The 3DS 530 comprises a simulated (skin) layer 538 (providing a thickness and an outer surface or top surface for 3DS 530) and a plurality of Features including eyes 539, nose 541, mouth 542, eyebrows 543, forehead 544, chin 545, check 546. 3DS 530, shown in FIG. 5B, is shown as further comprising a plurality of Defects or defect-simulating structure(s) 550,552 that are established in positions and/or locations i.e., target sites 554, 556 of the 3DS 530. As can be seen from FIGS. 5A and 5B, the defects 520, 522 have progressed or degenerated more with age. The 3DS 630 shown in FIG. 6B simulates a human head 632, neck 633, shoulders 634 and chest 635. The 3DS 630 comprises a simulated (skin) layer 638 (providing a thickness and an outer surface or top surface for 3DS 630) and a plurality of Features including eyes 639, ears 640, nose 641, mouth 642, eyebrows 643, forehead 644, chin 645, cheek 646. 3DS 630, shown in FIG. 6B, is shown as further comprising a defect or defect-simulating structure 650 that is established in position and/or location i.e., target side 654 of the 3DS 630. Although the 3DS 130, 230, 330, 430, 530, 630 includes age related demographic bias indicator of 45 years person, the one or more demographic bias indicators of 3DS 130, 230, 330, 430, 530, 630 may vary in gender and/or ethnicity. For example, it may be appreciated that the demographic bias indicator of 3DS 230 is different from that of the 3DS 130 in both gender and ethnicity.

The 3DS 160 shown in FIG. 1C simulates a human head 162, neck 163, shoulders 164 and chest 165. The 3DS 160 comprises a simulated (skin) layer 168 (providing a thickness and an outer surface or top surface for 3DS 160) and a plurality of Features including eyes 169, nose 171, mouth 172, eyebrows 173, forehead 174, chin 175, cheek 176. 3DS 160, shown in FIG. 1C, is shown as further comprising a plurality of Defects or defect-simulating structure(s) 180, 182, 183 that are established in positions and/or locations i.e., target sites 184, 186, 187 of the 3DS 160. As can be seen from FIG. 1B and FIG. 1C, the defects 150, 152, 153 have progressed or generated further with age. The 3DS 260 shown in FIG. 2C simulates a human head 262, neck 263, shoulders 264 and chest 265. The 3DS 260 comprises a simulated (skin) layer 268 (providing a thickness and an outer surface or top surface for 3DS 260) and a plurality of Features including eyes 269, ears 270, nose 271, mouth 272, eyebrows 273, forehead 274, chin 275, cheek 276. 3DS 260, shown in FIG. 2C, is shown as further comprising a plurality of Defects or defect-simulating structure(s) 280, 282 that are established in positions and/or locations i.e., target sites 282, 284 of the 3DS 260. As can be seen from FIG. 2B and FIG. 2C, the defects 250, 252 have progressed or degenerated further with age.

The 3DS 360 shown in FIG. 3C simulates a human head 362 and neck 363. The 3DS 360 comprises a simulated (skin) layer 368 (providing a thickness and an outer surface or top surface for 3DS 360) and a plurality of Features including eyes 369, ears 370, nose 371, mouth 372, eyebrows 373, forehead 374, chin 375, cheek 376. 3DS 360, shown in FIG. 3C, is shown as further comprising a plurality of Defects or defect-simulating structure(s) 380,382, 383 that are established in positions and/or locations i.e., target sites 384, 386, 387 of the 3DS 360. As can be seen from FIG. 3B and FIG. 3C, the defects 350, 352, 353 have progressed or degenerated further with age. The 3DS 460 shown in FIG. 4C simulates a human head 462 and neck 463. The 3DS 460 comprises a simulated (skin) layer 438 (providing a thickness and an outer surface or top surface for 3DS 460) and a plurality of Features including eyes 469, ears 470, nose 471, mouth 472, eyebrows 473, forehead 474, chin 475, cheek 476. 3DS 460, shown in FIG. 4C, is shown as further comprising a plurality of Defects or defect-simulating structure(s) 480, 482 that are established in positions and/or locations i.e., target sites 484, 486 of the 3DS 460. As can be seen from FIG. 4B and FIG. 4C, the defects 450, 452 have progressed or degenerated further with age.

The 3DS 560 shown in FIG. 5C simulates a human head 562 and neck 563. The 3DS 560 comprises a simulated (skin) layer 568 (providing a thickness and an outer surface or top surface for 3DS 560) and a plurality of Features including eyes 569, nose 571, mouth 572, eyebrows 573, forehead 574, chin 575, cheek 576. 3DS 560, shown in FIG. 5C, is shown as further comprising a plurality of Defects or defect-simulating structure(s) 580, 582 that are established in positions and/or locations i.e., target sites 584, 586 of the 3DS 560. As can be seen from FIG. 5B and FIG. 5C, the defects 550, 552 have progressed or degenerated further with age. The 3DS 660 shown in FIG. 6C simulates a human head 662, neck 663, shoulders 664 and chest 665. The 3DS 660 comprises a simulated (skin) layer 668 (providing a thickness and an outer surface or top surface for 3DS 660) and a plurality of Features including eyes 669, ears 670, nose 671, mouth 672, eyebrows 673, forehead 674, chin 675, cheek 676. 3DS 660, shown in FIG. 6C, is shown as further comprising a defect or defect-simulating structure 680 that is established in position and/or location i.e., target site 684 of the 3DS 660. As can be seen from FIG. 6B and FIG. 6C, the defect 650 has progressed or degenerated further with age. Although the 3DS 160, 260, 360, 460, 560, 660 includes age related demographic bias indicator of 65 years person, the one or more demographic bias indicators of 3DS 160, 260, 360, 4360, 560, 660 may vary in gender and/or ethnicity. For example, it may be appreciated that the demographic bias indicator of 3DS 260 is different from that of the 3DS 160 in both gender and ethnicity.

Generally, it can be understood that the exemplary embodiments shown in FIGS. 1-6 present at least one additional and identifiable (visually or other sensory ascertainable) demographic bias indicator(s). For the current embodiments, an identifiable secondary demographic bias indicator(s) is based on a visually or other sensory ascertainable race factor as follows: (i) the 3DS shown in FIGS. 1A-1C and FIGS. 2A-2C provides simulations comprising a secondary demographic bias indicator(s) based on race that promotes the ascertainment of a human (female and male) with what may be understood as generally Black (African American) racial characteristics; (ii) the 3DS shown in FIGS. 3A-3C and FIGS. 4A-4C provides simulations comprising a secondary demographic bias indicator(s) based on race that promotes the ascertainment of a human (female and male) with what may be understood as generally Asian racial characteristics; (iii) the 3DS shown in FIGS. 5A-5C and FIGS. 6A-6C provides simulations comprising a secondary demographic bias indicator(s) based on race that promotes the ascertainment of a human with what may be understood as generally Caucasian (White) racial characteristics.

Generally, it can be understood that the exemplary embodiments shown in FIGS. 1A-6C present at least one additional and identifiable (visually or other sensory ascertainable) demographic bias indicator(s). For the current embodiments, a tertiary identifiable demographic bias indicator(s) is based on a visually or other sensory ascertainable gender factor as follows: (i) the exemplary 3DS shown in and described in reference to FIGS. 1A-1C. 3A-3C and 5A-5C are demographically biased to provide a tertiary demographic bias indicator(s) that promotes the ascertainment of a human with what may be understood as a generally female gender and (ii) the exemplary 3DS shown in and described in reference to FIGS. 2A-2C. 4A-4C and 6A-6C are demographically biased to provide a tertiary demographic bias indicator(s) that promotes the ascertainment of a human with what may be understood as a generally male gender.

The exemplary embodiments shown in FIGS. 7, 8 and 9 provide simulations with a primary demographic bias indicators based on age for a twenty-five, forty-five and sixty-five year old human, respectively. For descriptive purposes only, the exemplary embodiments shown in FIGS. 7, 8 and 9 shall be understood as gender neutral and race neutral. Therefore, it is understood that the exemplary 3DS embodiments for the current invention can comprise one or any combination of demographic bias indicators. It is further understood that no specific demographic bias indicator shall be required for any of the exemplary 3DS embodiments for the current invention.

As shall be further described herein below, the exemplary embodiments described in reference to and shown in FIGS. 7, 8 and 9 may comprise at least one HFDTLs therein. It shall be understood that any description provided in reference to and shown in FIGS. 7, 8 and/or 9 may apply in whole or in part to any one or more of FIGS. 1A through 6C as may be contemplated by those or ordinary skill in the art. Therefore, any of the FIGS. 1-9 may comprise similar or different, individual and/or combinations of, any one or more of the following: (i) HFDTLs and/or other systems and characteristics as may be contemplated by those skilled in the art; (ii) appearance and/or demographic bias indication characteristics; (iii) dimensional, volumetric and/or other sizing properties and characteristics, and (iv) such other desired and determined aspects as may be contemplated by those skilled in the art for any of the exemplary 3DS embodiments for the current invention.

As shown in FIG. 7, a demographically determined, three-dimensional training device 3DS 700 is provided. It shall be understood that in addition to the description provided above for the various exemplary 3DS embodiments the description provided herein below for the 3DS 700 is similarly applicable to in at least one or all aspects including, without limitation, any individual or combination of one or more HFDTLs, to the exemplary embodiments described in reference to and shown in FIGS. 1A-6C, 8 and 9 for the current invention.

The 3DS 700 shown in FIG. 7 simulates a human head 705, neck 715, shoulders 725 and chest 740. The 3DS 700 comprises a simulated (skin) layer 730 (providing a thickness and an outer surface or top surface for 3DS 700) and a plurality of Features including eyes 706, ears 707, nose 708, mouth 709, eyebrows 710, forehead 711, chin 712, cheek 713, right shoulder 726, left shoulder 727, left breast 742 and right breast 744. The skin-simulating layer 730 of the 3DS 700 comprises a single integral construct that provides the desired simulated configuration and appearance (representation) reflecting the one or more demographic bias indicator(s) for the 3DS. For the current embodiment, the construct can be integrally formed to provide a configuration of a human skull, neck and upper chest structure. It is understood that that the exemplary 3DS for FIGS. 1A-6C, 8 and 9 may be formed in a similar manner of an integral construct. Alternatively, any of the exemplary 3DS for the current invention may comprise one or multiple component features such as a skeletal structure(s) simulating layer, muscular structure(s) simulating layer, skin simulating layer, HFDTLs and other systems and characteristics as may be contemplated. Individually or in combination these simulated layers and the like may each be a separate construct or integral construct capable of being disposed upon a structural framework. The structural framework providing general support for the simulation layers. The structural framework can be formed in a configuration that supports the disposition, connection or other affixation means of the simulating layers thereupon and the achievement of the three-dimensional simulated representation of the human anatomical features. In operation the simulating layers may be placed and/or affixed (partially or wholly), removably or integrally, in some manner upon the structural framework and the resulting combination construct can comprise an exemplary 3DS with the desired configuration and appearance for a 3DS including, without limitation, the desired demographic bias indicators.

It is contemplated that any exemplary 3DS for the current invention can be configured as any human anatomical feature, such as a human head, or combination of various structures and/or features as may be contemplated. A structural framework can comprise a lattice type structure, a solid form structure or other general purpose structure as may be contemplated and upon which the simulated layers, additional HFDTLs and/or other characteristics as may be contemplated, can be established on, within, or in any position relative to the structural framework to provide the desired aesthetic appearance and operational capabilities for the 3DS.

By way of further example, 3DS 700, shown in FIG. 7, is shown as further comprising a plurality of Defects or defect-simulating structure(s) 755, 765, 775 and 785 that are established in positions and/or locations i.e., target sites of the 3DS 700. As shown, in reference to FIG. 7, the Defects are positioned in, on and about the 3DS and associated or in correlation with a plurality of Target Sites 750, 760, 770 and 780, respectively. It is contemplated that the Defect(s) and/or Target Sites may range in size from 0.5 mm to 100 mm. Alternatively, the dimensional characteristics may vary within or outside the stated range. One or more Defects and/or Target Sites may be presented and/or positioned in, on or about the 3DS with or without correlation to or association with one or more Defects and/or Target Site(s).

The simulated (skin) layer 730 can comprise the outer surface or top surface that interacts with an environment outside the 3DS 700 and an inner surface or bottom surface, opposite from the outer surface. It can be understood that an inner or bottom surface of simulated layer 730 is positioned in relationship with at least a portion of an interior environment of the 3DS 700. Further, any one or plurality of Target Sites and/or Defects can be generally understood as cutaneous and, therefore, ascertainable and/or accessible via the top surface of the simulated layer 730. Thus, accessibility may be provided to a user through a visual indicator, a tactile interaction or such other sensory indicator that may be ascertainable via the top surface of the simulated layer 730 as may be determined for the 3DS.

It is further contemplated that ascertainment and/or accessibility by a user can be promoted through the use of various mechanical, electrical or other contemplated devices. The mechanical, electrical or other devices that may be contemplated for use by and with an exemplary embodiment of the current invention can include a syringe (needle), electrode(s), dermal delivery mechanism(s) and the like as may be contemplated by those skilled in the art.

It is contemplated that 3DS 700, or any exemplary 3DS embodiments described herein, may be generated with a plurality of simulated layers. The plurality of simulated layers may comprise any of the previously described layers and provide the simulation with one or more features. Thus, it is contemplated that one or more layers can be in addition to the simulated layer 730. For example, 3DS 700 may comprise a configuration whereby at least one or more additional layer(s) may be generated and generally configured and located beneath and/or positioned relative, subjacent, adjacent or otherwise to the simulated layer 730 such as, the inner or bottom surface or top surface of the skin-simulated layer 730. Thus, it is understood that an interior environment for an exemplary 3DS embodiment can comprise one or multiple layers and include any one or more of the HFDTLs.

In embodiments, as shown in FIG. 8, a demographically determined 3DS 800 simulates a human head 805, neck 815, shoulders 825, and chest 840, all of which are biased to provide an appearance (demographic bias indicators or appearance indicators) of a forty-five year old human. The 3DS 800 comprises a skin-simulated layer 830 (providing an outer layer/surface for 3DS 800) and numerous Features (body parts) including eyes 806, cars 807, nose 808, mouth 809, eyebrows 810, forehead 811, chin 812, cheek 813, right shoulder 826, left shoulder 827, left breast 842 and right breast 844. The 3DS further comprises numerous Defects 835, 855, 865, 875, 885 and 895. The Defects may be located in correlation with Target Sites 850, 860, 870 and 880 respectively, about the 3DS 800.

The 3DS 800 comprises various and numerous Defects that can promote an aesthetic and appearance consistent with the indicated demographic bias. For example, Defect 855 provides an indication of a set of two appearance lines present in the forehead 811 region. In the current embodiment, the defect 855 is positioned in association with Target Site 850. In the alternative, Defect 855 may be located independent of any one or more Target Sites. The set of two appearance lines comprising Defect 855 are distinct from the Defects present in 3DS 700. In particular, Defect 855 are present in 3DS 800 based, at least in part, on the age demographic bias indicator stated for simulated 3DS 800. It is contemplated that the appearance lines, as indicated by Defect 855, appear only on age-limited simulations, such as simulations that represent exemplary 3DS with an age demographic bias indicator of forty-five years or older. Consistent with the age-limited simulation embodiments, 3DS 900 as shown in FIG. 9 and described herein below, includes a Defect that is ascertainable as a set of three appearance line indicators. Further, 3DS 800 includes Defect(s) 895 which are additional appearance lines that can be seen positioned variously about the simulation, for instance, proximal to about the areas of the eyes, nose, cheeks and mouth. Still further, the chin 812 for 3DS 800 is indicated in a more prominent manner that promotes an appearance indication consistent with the age demographic bias indicator given the exemplary embodiment.

In embodiments, as shown in FIG. 9, a demographically determined 3DS 900 simulates a human head 905, neck 915, shoulders 925, and chest 940, all of which are biased to provide an appearance (demographic bias indicators or appearance indicators) of a sixty-five year old human. The 3DS 900 comprises a skin-simulated layer 930 (providing an outer layer/surface for 3DS 900) and numerous Features (body parts) including eyes 906, ears 907, nose 908, mouth 909, eyebrows 910, forehead 911, chin 912, check 913, right shoulder 926, left shoulder 927, left breast 942 and right breast 944. The 3DS further comprises numerous Defects 955, 965, 975, 985 and 995. The TFs are located in correlation with Target Sites 950, 960, 970 and 980 respectively, about the 3DS 900.

It can be understood that various Target Sites may be variously configured to promote and/or enable the performance of MACS and/or provide for the Defect positioning about, upon and/or within an exemplary 3DS. It is contemplated that one or more of the Target Sites can be alternatively configured, such as a surface position upon a 3DS or as a hollow compartment within one or more simulated layers within which one or more of the Defects can be placed. When exemplary Target Sites are configured as a hollow compartment it is further contemplated that the compartment and any Defect that may or may not be placed therein may be at least partially enclosed by a cover. Thus, in embodiments of exemplary 3DS it can be understood that one or more of the Target Sites may be configured as a hollow within which one or more Defect can be placed and then the hollow and the one or more Defect therein are covered by a flap. In this manner, the current embodiments and any additional exemplary embodiments of the current invention can be configured in a reusable manner, whereby, any Target Site can be accessed and promote the interchangeable placement of various and numerous Defects therein. In alternative configurations, it can be understood that a Target Site and one or more Defect can be integrally or removably formed and located upon and/or within any of the exemplary 3DS embodiments of the current invention. Thus, the current invention can be configured to promote and allow for one or more Defects to be formed in, placed in and removed from one or more Target Sites.

A Target Site that may be configured as a hollow compartment may be further understood as extending a general depth ranging from 0.5 mm to 100 mm and having a general diameter ranging from 0.5 mm to 100 mm. The dimensional properties and characteristics of any Target Site(s) can vary for the individual Target Site or between two or more Target Sites to provide a desired indication of a position upon and/or within the 3DS. It is contemplated that when the Target Site(s) is configured as a hollow compartment that its dimensional characteristics, such as depth and diameter, may extend some distance that is at least partially or entirely through one or more of a simulated layer of an exemplary 3DS. Further, the Target Site(s) hollow compartment may extend some distance that is at least partially or entirely through one or more additional layers and/or structures, in addition to the skin simulation layer, of a 3DS as has been described.

As shown in FIGS. 7-9 each exemplary 3DS 700, 800 and 900, respectively, comprise a plurality of Defects that can be distributed about the 3DS, including in proximal relation to various anatomical features, such as the eyes, chest, cheek, neck and forehead, or other Features. The one or more Defects can be configured to comprise, without limitation, lines, fat pads, lesions, wounds, cysts, lymphomas, scars, blood vessels, arteries or other features and/or defects as contemplated by those skilled in the art and in any combinations thereof. For instance, defect 765 and 865 can simulate a fat pad that is positioned in Target Site 760 and 860, respectively, and in close proximity to mouth 709 and 809, respectively. Further, defect 755 and 855 can simulate a wound that is positioned in Target Site 750 and 850, respectively and proximal to forehead 711 and 811, respectively. Defect 775 and 875 can simulate a scar that is positioned in Target Site 770 and 870, respectively and proximal to neck 715 and 815, respectively. As shown in FIG. 7, Defect 785 can simulate a cyst that is positioned in Target Site 780, respectively and proximal to right breast 744 of chest 740. In addition, as shown in FIG. 8, Defect 885 simulates a plurality of lines that are positioned in Target Site 880 and in proximity to and about both eyes 806. It shall be understood that the Defect and positioning in the Target Site can vary as may be contemplated without departing from the scope and spirit of the current invention.

As shown in FIGS. 7-9, the Defects may be positioned in the 3DS 700, 800 and 900, respectively, in proximal relation to high-risk anatomical areas, including but not limited to the head, face, throat and neck and/or vascular structures, glands, foramens, and the like. One or more of the Defects can be understood as distributed within the 3DS 700, 800 and 900 in areas wherein the performance or mis-performance of one or more MACS (aesthetic and/or cosmetic services [i.e., procedures, protocols, treatments, services and/or techniques] for delivery of an active ingredient) may result in various temporary or more permanent harmful outcomes that may range from tissue necrosis, to deformation, to destruction of anatomical features, to blindness, to stroke and other well-known complications, based on damage done to one or more simulated layers and/or skeletal structured formed for the 3DS. For instance, it may result in deformation of one or more of the simulated skin layers and/or any adjacent or underlying additional simulated tissue layers, structures and/or systems. For example, a sculpting process performed on the neck and/or chest may result in deformation of skin in those areas, in the form of stretching or buckling. In another example, the performance of one or more MACS in or around Target Sites 760, 860 and/or 880 may promote an increase in the incidence of buckling (e.g., loss of elastic fibers, resorption of skeletal elements, re-positioning of sub-cutaneous features and the like) as areas surrounding the eyes and the mouth can be considered high-risk and prone to buckling.

As has been described, an exemplary training device may comprise at least one or any combination of HFDTLs disposed upon at least one of the at least one simulated human tissue layer and/or skeletal structure. The performance of one or more MACS may present a limited to significant risk-profile to a patient in terms of potential for damage resulting from the performance of a treatment in a localized or more general pattern. The risk profile may be the potential non-positive impact and/or outcome the performance of a MACS treatment may have upon one or more anatomical features, such as glands, muscles, vascular structures (i.e.,blood vessels and/or arterial structures), foramen (skeletal structures), ligaments and other well-known features. It is understood that the performance of a MACS treatment may be directed to any high-risk area, HFDTLs and the like as may be contemplated. Further, it is understood that the performance of a MACS treatment may be directed to a position of the 3DS that may and can be proximal to any one or more of the HFDTLs including, without limitation, any high-risk area. These anatomical features may comprise, be positioned relative to and or extend through any of the one or more tissue layers and/or HFDTLs presented by the exemplary device. Therefore, it is a critical advantage of the current invention that it can significantly landmark and may properly identify the location of these structures and/or features relative to any one or more HFDTLs and the one or more tissue layers and skeletal structure that comprise any one of the exemplary three-dimensional training devices embodied.

Thus, the 3DS 700, 800 and 900 provides practitioners and others a demographically determined synthetic (manufactured) three dimensional device upon which to practice the performance of aesthetic and/or cosmetic services, including the treatment protocols and techniques, directly in or proximal to high risk anatomic locations wherein such techniques may result in deformation and/or other types of harm to various anatomical HFDTLs. The 3DS 700, 800 and 900 and any exemplary embodiments of the current invention provide a synthetic model that can promote and provide practitioners an opportunity to practice aesthetic services upon demographically simulated human anatomical areas prior to encountering live human patients.

It can be understood that any exemplary embodiment of the current invention can comprise and present demographically determined tissue layers and/or anatomical features, such as described herein, which may further comprise various other alterations or changes that are perceptible. These changes, alone or in any combination, can be representative of various elective or non-elective alterations that may impact upon and present perceptible changes to any one or more tissue layer and/or anatomical feature. For instance, changes to any tissue and/or anatomical features that may result from a trauma, localized or generalized, can be understood as non-elective alterations. Additionally, changes to any tissue and/or anatomical features that may result from a surgical procedure, localized or generalized, can be understood as elective alterations.

By way of non-limiting example, a person who elects to undergo a face-lift procedure may experience that one or more tissue layers and/or anatomical features have been impacted by this procedure. For instance, the positioning in the facial area of one or more fat pads, vascular structures, glands and such other tissues and features as are well-known by those skilled in the art, relative to any other tissues and/or features may be altered from an original pre-procedure position. Thus, these “landmarks” can be presented in a first demographically determined exemplary embodiment as being in a perceptible original (pre-MAC procedure) position and then presented in a second demographically determined exemplary embodiment as being in a perceptible altered or secondary (post-MAC procedure) position in combination with the original demographically determined characteristics. It is understood that these types of elective and/or non-elective changes may be experienced by a person comprising any age or other demographically defined characteristics. Therefore, it is understood that the exemplary embodiments of the current invention, regardless of the demographically defined characteristics for any embodiment, can present any one or combination of such alterations and changes as may be desired.

The demographic determination for the 3DS 700, 800 and 900 is understood to bias the exemplary 3DS simulation in accordance with overall and specific appearance (demographic bias) indicators based on age for a twenty-five, forty-five or sixty-five year old human, respectively. The approximate proportion of the head 705 (including all facial features), neck 715, shoulders 725 and chest 740 of the 3DS 700 is in relation to what is generally understood as the age demographic bias associated for a twenty-five year old human. The approximate proportion of the head 805 (including all facial features), neck 815, shoulders 825 and chest 840 of the 3DS 800 is in relation to what is generally understood as the age demographic bias associated for a forty-five year old human. The approximate proportion of the head 905 (including all facial features), neck 915, shoulders 925 and chest 940 of the 3DS 900 is in relation to what is generally understood as the demographic bias associated for a sixty-five year old human. The distinction between 3DS 700, 800 and 900 can be viewed in comparison, for example, the chin 712 and neck 715 of 3DS 700 as well as the lack of “lines” around the eyes 706, nose 708, check 713 and forehead 711 provide a simulated indication of a younger human than that simulated in 3DS 800 and/or 900. The indicator lines that generally provide the appearance of sagging in the skin 830 of the forehead 811, under the eyes 806 and checks 813 for 3DS 800 relative to the under the eyes 706, forehead 711 and cheeks 713 of 3DS 700 simulates the demographic determination for a forty-five year old human of 3DS 800 in distinction from the twenty-five year old human of 3DS 700. The lines indicating a more prominent chin 713 and additional indicator lines that generally provide the appearance of more sagging in the skin 930 of the forehead 911, under the eyes 906 and cheeks 913 for 3DS 900 relative to the under the eyes 706 and/or 806, forehead 711 and/or 811 and cheeks 713 and/or 813 of 3DS 700 and/or 800, respectively, simulates the demographic determination for a sixty-five year old human of 3DS 900 in distinction from the twenty-five year old human of 3DS 700 and forty-five year old human of 3DS 800.

Exemplary 3DS embodiments, including 3DS 700, 800 and 900 configured with demographically biased simulated layers 730, 830 and 930, respectively, can be configured with one or more demographically biased HFDTLs. It is contemplated that 3DS 700, 800 and 900 and any exemplary embodiment of the current invention can be configured and comprise one or more tissues that may be configured as one or more HFDTLs.

Thus, it can be understood that 3DS 700, 800 and 900 and any exemplary embodiment(s) can include one or more HFDTLs that may or may not be shown in FIGS. 7-9 including, without limitation, fat, blood vessels, muscle, ligament, artery, nerve, superficial musculoaponeurotic system, gland, cartilage, skeleton, organ(s), and others as may be contemplated. It is understood that the 3DS 700, 800 and 900 and any exemplary embodiments of the current invention may or may not comprise any one or more of the HFDTLs and any combination thereof.

As described herein above in reference to FIGS. 1-9 a demographically determined three-dimensional training device(s), referred to herein throughout as “3DS”, has been shown. The 3DS of FIGS. 1-9, respectively, exemplify embodiments for the current invention of simulated human anatomical area(s) that can be generated (fabricated or printed) for and employed by additional exemplary embodiments of the current invention.

The human anatomy including, without limitation, the human face, comprises an intricate arrangement of multiple anatomical features, such as fat pads and ligaments, septa (septum), skeletal structure, musculature structure, vascular system and dermal tissue layers, each playing a pivotal role. The current invention shall be understood as promoting this critical understanding of all of these anatomical features throughout the human body and, therefore, enables a real-world opportunity to interact with these features in a simulated environment that further promotes the obtainment of real-world experience in interacting with these high-risk areas in a safe and effective learning opportunity. It is crucial for cosmetic and surgical procedure and planning, injury prevention, and effective treatment of facial conditions that practitioners are enabled to gain accurate, real-world knowledge of the location and risk(s) involved with all anatomical features to ensure proper performance of procedures. Therefore, the accurate understanding of the location and risk(s) involved with all anatomical features that is promoted by the current invention can be a significant advantage provided by the exemplary embodiments, both described and contemplated.

Fat pads move, ligaments move meaning that the structures that hold these tissues move and can result in blood vessels and/or arteries moving. Promoting an understanding of the movements that may occur for any anatomical feature based on demographic characteristics, as is provided by the exemplary embodiments of the current invention, can provide significant improvements for providers of the various MACS as have been discussed herein. By way of example, fat pads can lose volume over time (aging), therefore, it can be critically important to understand where fat pads are located, based on the varying demographic characteristics simulated in an exemplary embodiment of the current invention, in order to promote the proper replacement (a filler treatment/procedure) of any lost volume in any given fat pad. This can further promote the patient benefitting from an improved or more natural aesthetic result from the filler treatment for replacing lost volume in a fat pad.

A typical adverse event that may result from these types of procedures is bruising caused by the application of a needle to tissue or injection of a filler. The size and severity of bruising that may result from the performance of these types of procedures can be related to incorrect application that impacts upon one or more landmarks, such as a blood vessel or artery. By promoting an understanding of where the landmarks (e.g., blood vessels and arteries or other landmarks as have been described throughout the instant specification) are, particularly in relation to the application of any type of treatment, the exemplary embodiments of the current invention may further promote a reduction in the severity of any adverse results from a procedure, improved recovery time or less down time for a patient.

A primary consideration for the application of fillers can be the risk of a filler getting into a vessel or an artery, or a foramen. Foramens are where the vessels and arteries come in and out of the face. A risk can be that if you get filler in a vessel or artery, or into a foramen which may result in a filler getting into the vessels and arteries, this may result in blocked blood flow to an area which may cause necrosis, blindness, or a stroke. It is generally understood that our bones resorb as we age making the foramens get larger over time. The exemplary embodiments of the current invention may also simulate the expansion of a foramen that can naturally occur throughout the aging process. Therefore, simulations that can promote an understanding of this growth process for foramens is another example of the benefits provided by the current invention. The 3DS of the current invention can significantly promote the increased understanding gained by providers of the MACS treatments, procedures and/or protocols, by enabling them to learn and identify where the structures may move and how they may change over time and in relation to the various different demographic characteristics, as discussed.

It shall be understood that the instant application shall describe herein below various aspects of numerous anatomical features in relation to a simulated human facial anatomical structure, as provided by the exemplary embodiments, but that such description may and/or can apply to any such aspects of these anatomical features regardless of where a particular anatomical feature may be located throughout the human anatomy.

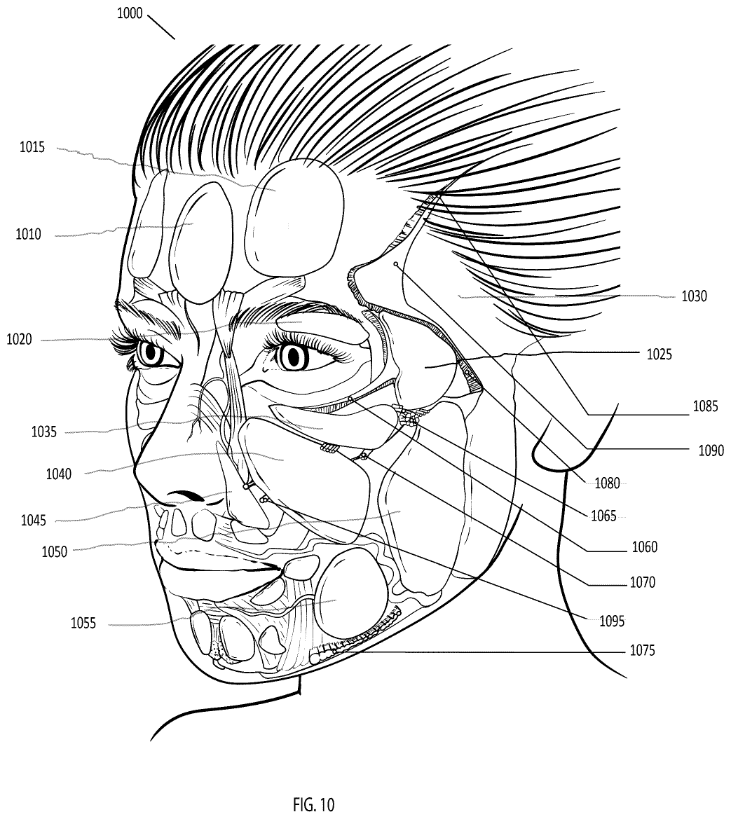

These anatomical features in the human face play a critical role in facial contour, expression, and aging. As shown in FIGS. 10-14, understanding these structures, and any high-risks in interacting with these structures that may impact significantly upon aesthetic characteristics, is crucial in various medical and aesthetic fields, including plastic surgery, dermatology, cosmetic procedures, and maxillofacial surgery. The current invention promotes this critical understanding and therefore, enables a real-world opportunity to interact with these features in an environment that further promotes the obtainment of real-world experience in interacting with these high-risk areas in a safe and effective learning opportunity.

The head and face 1000, as shown in FIG. 10, may include fat (pads) compartments that are discrete anatomical structures situated beneath the skin, primarily serving as cushions and providing structural support. They can be distributed and positioned in exemplary key areas throughout the human anatomical structures, for example, such as in the cheeks, around the eyes, and near the mouth of a human facial structure. Therefore, it shall be understood that the current invention can promote the simulation of fat (pads) compartments found throughout the human body. Ligaments vary in size, strength, and elasticity, contributing to their functional capabilities and the unique contours of the face.

Variations in the facial fat pads are influenced by genetic and environmental factors. Age leads to changes in volume and distribution, while race and ethnicity affect the baseline size and shape of these pads. These variations can impact facial aging and aesthetics. Therefore, the composition and density of these fat pads significantly influence human anatomical contouring and appearance, such as facial contouring and appearance, as shown in FIGS. 1-9. A precise understanding of facial compartments is essential in the realms of reconstructive and aesthetic facial surgery, as these structures significantly influence facial contours, aging, and expressions.

As shown in FIG. 10, the central forehead compartment 1010 can be understood as positioned in the uppermost region of the forehead and characterized by a thin layer of fat. This fat pad contributes to the contouring and smooth appearance of the forehead and is important in forehead rejuvenation procedures. Changes here can affect the appearance of aging. The middle forehead compartment 1015 is positioned directly below the central forehead compartment. This compartment contains fibrous tissue and fat contributing to forehead fullness and plays a vital role in facial expressions, particularly those involving eyebrow movement. This compartment may be considered in procedures like brow lifts, wherein its alteration can impact forehead aesthetics and expressions. The retro-orbicularis oculi Fat (ROOF) 1020 is positioned behind the orbicularis oculi muscle and is a specialized fat compartment in the eyelid area. This compartment supports the structure of the eyelid, contributing to its contour and function and can be crucial in eyelid surgeries, wherein alterations affect eyelid appearance and function. The lateral orbital compartment 1025 is positioned adjacent to the temporal region, near the eye. This fat compartment can aid in the support of the lateral eye and contributes to the overall shape and support of the eye socket. It can be key in surgeries involving the lateral periorbital area, influencing eye contour. The lateral temporal-cheek compartment 1030 is positioned between the temporal and cheek regions and bridges the gap between cheek and temporal fat. This compartment can aid in ensuring a smooth transition in facial contours between the cheek and temporal areas and may be considered in midface lifting and temporal augmentation. The infraorbital fat compartment 1035 is positioned beneath the eye and supports the lower eyelid. Significant for the aesthetic of the under-eye region it can also be vital in lower eyelid surgery and tear trough correction. The malar fat compartment 1040 is positioned over the cheekbones. This prominent fat pad contributes to cheek fullness and defines the prominence and contour of the cheeks. It can be central in midface rejuvenation and cheek augmentation procedures. The nasolabial compartment 1045 is positioned adjacent to the nasolabial fold and influences the formation and appearance of the smile and expressions. Affecting the appearance of the nasolabial area during facial expressions it can be considered in procedures targeting nasolabial fold reduction and midface lifting. The middle cheek compartment 1050 is positioned in the central cheek area and contributes to overall cheek fullness. Playing a significant role in the aesthetic of the cheeks it is important in cheek augmentation and rejuvenation techniques. The jowl compartment 1055 is positioned relative to and around the lower jaw. It can influence the contour of the lower face, affecting facial contour and can be a key area in aging-related studies. It can be central in addressing aging effects in the lower face, particularly in jowl lifting procedures.

Each of these facial (fat pad) compartments contributes uniquely to facial structure and aesthetics. Their distinct characteristics are critical for surgical and aesthetic (cosmetic) planning and outcomes, directly impacting facial rejuvenation and reconstructive procedures.

Ligaments are fibrous bands that connect bones to other bones or tissues throughout the human body. Therefore, it shall be understood that the current invention can promote the simulation of ligaments found throughout the human body. Ligaments vary in size, strength, and elasticity, contributing to their functional capabilities and the unique contours of the face.

As shown and described in the exemplary embodiments for the current invention, the 3DS can include and provide simulation for one or more of the ligaments that can be found in a human facial simulated structure. Understanding the distinct roles and structures of these facial ligaments is crucial for surgical interventions, facial reconstructive procedures, and cosmetic applications. Each ligament plays a unique role in facial dynamics and aesthetics. Therefore, the current invention can provide a real-world, simulation that promotes the understanding of the position and critical role played by ligaments in the human body.

By way of non-limiting example, some of the key ligaments that may be found in a human facial anatomical structure, that can be simulated, individually or in any combination, in any of the exemplary embodiments of the current invention, can include, without limitation, the following: orbitomalar (orbicularis retaining) ligament ((a) lateral part and (b) medial part); zygomatic ligament; preauricular parotid cutaneous ligament; auriculoplatysmal ligament; masseteric cutaneous ligament; platysma mandibular ligament; mandibular osseocutaneous ligament; and zygomatic cutaneous ligament.

The exemplary embodiments for the current invention promote an understanding of facial ligaments that can be critical in the realms of reconstructive and cosmetic facial surgery and other procedures. Each ligament's distinct anatomical and functional properties are crucial in influencing facial aesthetics and expressions. Therefore, it can be understood that ligaments may be considered high-risk areas for the performance of a MAC. The orbitomalar (Orbicularis Retaining) ligament 1060 (lateral part) extends from the lateral orbital margin and functions to support the lateral eyelid and periorbital area. Understanding the positioning of this landmark is vital in blepharoplasty and midface lifting, influencing the appearance of the lateral eye and temple area. The orbitomalar (Orbicularis Retaining) ligament 1060 (medial part) originates near the medial canthus and functions to support the medial eyelid and adjacent areas. It can be important in medial eye surgeries and correcting issues like tear trough deformities. The zygomatic (cutaneous) ligament 1065 can be found midface, originating from the zygomatic bone, and functions as an anchor to support facial skin in relation to the cheekbone, maintaining midface contour. This ligament can play a role in midface lifting, alterations affecting malar prominence and malar fat pad repositioning and midfacial aging. The preauricular parotid cutaneous ligament (not shown) can be found anterior to the car, connecting the parotid fascia to the dermis, and functions to support the preauricular skin, affecting the contour near the ear. This ligament can be considered in facelifts and parotid gland surgeries, affecting outcomes around the car and cheek. The auriculoplatysmal ligament (not shown) extends from the auricle to the platysma muscle and functions to connect the ear region with the neck musculature. This ligament can impact neck lift outcomes and the aesthetic of the jawline and lower face. The masseteric cutaneous ligament 1070 links the masseter muscle fascia to the overlying skin and influences the contour and movement of the lower cheek. This ligament can be essential in lower face rejuvenation and jawline definition. The platysma mandibular ligament (not shown) may be located at the junction of the platysma muscle and the mandible and functions to support the lower face and neck contour. This ligament can be critical in defining the jawline in neck lift and lower facelift procedures. The mandibular Osseocutaneous ligament (not shown) extends from the mandibular periosteum to the dermis and functions to promote the stabilization of the skin of the lower jaw. This can influence outcomes in lower face rejuvenation and jowl correction. The temporal ligament 1090 is situated in the temporal region of the head, which encompasses the area surrounding the temporal bone of the skull. It connects the temporal bone to other adjacent structures, typically involving the fascia or muscle tissue in the temporal area. The temporal ligament provides stability and support to the temporal area and is a key consideration in procedures involving the temporal region, such as facelifts, temporal artery biopsies, and cranial surgeries. The maxillary ligaments 1095 are situated in the midface region, connecting the maxilla to surrounding tissues. These ligaments typically attach the maxilla to the cheekbones (zygomatic bones), the palate, and other adjacent facial bones and soft tissues. They contribute to the overall contour and aesthetics of the midface and critical in procedures involving the midface, such as corrective jaw surgery, facial reconstruction, and cosmetic procedures.

Each of these ligaments contributes uniquely to facial structure and aesthetics. Their distinct characteristics are critical in the planning and execution of various MACS, directly impacting the outcomes of facial reconstructive and cosmetic procedures.

An accurate understanding of facial septa, as shown in exemplary face 1000 of FIG. 10, is vital in facial reconstructive and aesthetic surgery, as these structures play key roles in facial contour and integrity. Their detailed description is crucial for surgical precision and innovation in medical and cosmetic procedures. The mandibular septum 1075 is located or positioned within the lower jaw region and comprises fibrous tissue forming a septum in the mandibular area. It serves to compartmentalize the facial tissues in the lower jaw, providing structural support and maintaining the contour of the lower face. This feature can be essential in surgeries involving the lower face, particularly in procedures addressing sagging and aging effects in the jowl and mandibular areas. The inferior temporal septum 1080 is found within the temporal region, below the level of the zygomatic arch. It is a fibrous partition that separates different layers of the temporal fat pads and plays a role in maintaining the distribution and position of the temporal fat pads, affecting the overall aesthetics of the temporal region. Its understanding is vital in temporal lifting and contouring procedures, impacting both aesthetic and functional outcomes. The superior temporal septum 1085 is located in the upper part of the temporal region, above the zygomatic arch. It is a distinct fibrous barrier within the upper temporal fat pads and functions to contribute to the separation and support of the temporal fat pads, influencing the structure of the upper face. It can be key in upper facial rejuvenation techniques, including brow lifting and temporal filling, where manipulation of this septum can alter facial contours and aesthetics.

The mandibular septum, inferior temporal septum, and superior temporal septum each have unique anatomical and functional roles that are crucial in facial surgery and aesthetics. A comprehensive understanding of these structures is indispensable for surgical advancements and for the development of new medical techniques and devices.

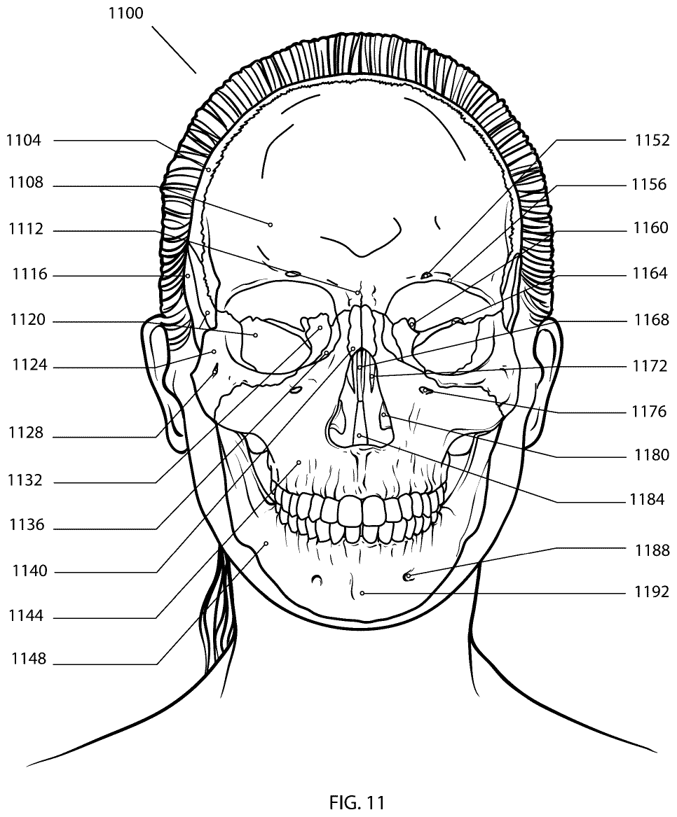

An in-depth understanding of the exemplary facial skeletal structure 1100, as shown in FIG. 11, is fundamental in fields such as aesthetic/cosmetic procedures, maxillofacial surgery, dentistry, and forensic science. Therefore, promoting an understanding of the key components of the facial skeletal system can be another critical advantage provided by the current invention.

The parietal bone 1104 is positioned on the sides of the skull and forms the roof and sides of the cranial cavity. This feature can be integral in protecting the brain and supporting the scalp. The frontal bone 1108 is positioned in the forehead region, including the roofs of the orbital and nasal cavities. The frontal bone contributes to the upper part of the eye sockets and can affect the contouring of the forehead and eye sockets. The glabella 1112 is positioned and is a part of the frontal bone above and between the eyebrows. This provides a reference point in facial measurements and a landmark in cosmetic procedures and anthropological studies. The temporal bone 1116 is positioned on the sides and base of the skull. Forming the temples and houses structures for hearing it is essential for hearing and balance. The sphenoid bone 1120 is positioned at the base of the skull. It contributes to the formation of the orbital and nasal cavities and is important in cranial nerve passage and orbital structure. The zygomatic bone 1124 is positioned in the cheek region and forms the prominence of the cheeks. This bone is key in facial contour and protection of the eye. The zygomaticofacial foramen 1128 is located in the zygomatic bone. It functions as a passage for the zygomaticofacial nerve and vessels and is involved in sensation of the cheek. The ethmoid bone 1132 is located between the eyes and forms part of the nasal septum and medial walls of the orbits and can impact nasal structure and olfaction. The lacrimal bone 1136 is located on the medial wall of the orbit. It is part of the tear duct system and involved in tear drainage. The nasal bone 1140 is located at the bridge of the nose. It functions to support cartilage of the lower nose and influences the shape of the nose. The maxilla 1144 is located in the upper jaw and forms the upper dental arch as part of the nasal and orbital cavities. This skeletal structure is essential for mastication and facial aesthetics. The mandible 1148 is located in the lower jaw and functions to hold the lower teeth. It is the largest facial bone, crucial for chewing and speech. The supraorbital foramen 1152 is located above the orbit in the frontal bone. It functions as a passage for the supraorbital artery and nerve and is, therefore, important in facial sensation and blood supply. The supraorbital margin 1156 is located in the superior border of the eye socket and functions to provide structural integrity to the orbital cavity. This structure protects the eye and influences orbital shape. The optic canal 1160 is located in the sphenoid bone. It allows the passage of the optic nerve and ophthalmic artery and is, therefore, critical for vision. The orbital fissure 1164 is located between the greater and lesser wings of the sphenoid bone. It allows passage of nerves and vessels to the orbit and is important for eye movement and sensation. The perpendicular plate 1168 is part of the ethmoid bone and contributes to the nasal septum. This structure impacts the nasal structure and airway. The middle nasal concha 1172 is part of the ethmoid bone in the nasal cavity. This structure plays a role in air filtration and influences air flow and filtration in the nose. The infraorbital foramen 1176 is located on the maxilla below the orbit and functions to provide passage for the infraorbital nerve and artery. This structure is involved in facial sensation and blood supply. The inferior nasal concha 1180 comprises independent bones in the nasal cavity. These play a crucial role in humidifying and filtering inhaled air and affect nasal function and respiratory health. The vomer 1184 forms the lower portion of the nasal septum and is a thin, flat bone that influences nasal structure and septal deviation. The mental foramen 1188 is located on the mandible. This structure transmits the mental nerve and vessels and is crucial for sensation in the lower lip and chin. The mental protuberance 1192 is identifiable as the forward projection of the lower part of the mandible. This structure contributes to the shape of the chin and influences facial aesthetics and chin contour.

Each of these skeletal structures plays a distinct role in the overall facial anatomy, impacting function, aesthetics, and surgical outcomes. Understanding these components is critical for medical and aesthetic professionals in various specialties.

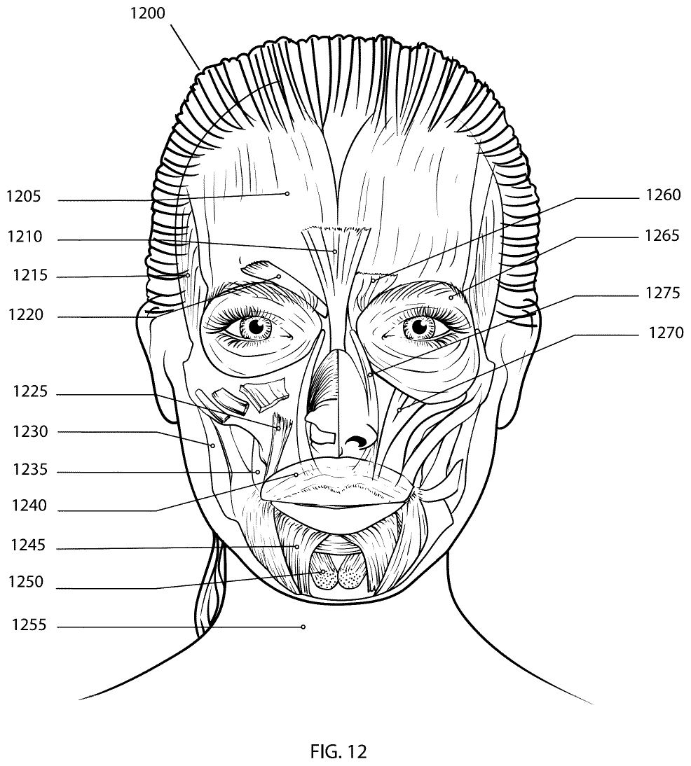

An accurate understanding of facial muscles is essential in fields such as plastic surgery, dermatology, and neuromuscular dentistry. The exemplary face 1200, as shown in FIG. 12, provides an illustration that may promote the understanding of and elucidate the key muscles involved in facial expressions and movements.

The frontalis muscle 1205 is located in the forehead region. This muscle is responsible for raising the eyebrows and wrinkling the forehead and is commonly targeted in cosmetic procedures like the application of various neurotoxins (e.g., Botox) for forehead wrinkles. The procerus muscle 1210 is located between the eyebrows and functions to pull the skin between the eyebrows downward, creating horizontal wrinkles. Involved in frowning, this muscle is a common site for cosmetic treatments. The temporalis muscle 1215 is located on the side of the skull. This muscle elevates and retracts the mandible, critical for chewing, and can be key in masticatory function and temporomandibular joint disorders. The corrugator supercilii muscle 1220 is located beneath the frontalis and orbicularis oculi. This muscle functions to draw the eyebrow downward and medially, producing vertical wrinkles. Contributing to frown lines, this muscle is often addressed in anti-aging treatments. The levator anguli oris 1225 is located near the mouth. It functions to elevate the angle of the mouth, aiding in smiling. Influencing expressions of happiness, this muscle is considered in facial reanimation surgery. The masseter muscle 1230 is located in the cheek area. Functioning to elevate the mandible, it is vital for chewing. This muscle is prominent in jawline contouring and TMJ treatments. The buccinator muscle 1235 is located in the cheek. It functions to hold food between the teeth during chewing and assists in blowing air. Influencing facial contours, this muscle is involved in oral functions. The orbicularis oris muscle 1240 is located around the mouth and lips. It functions to control movements of the mouth and lips and is central in speech, eating, and expressions like kissing. The depressor labii inferioris 1245 is located in the lower lip area and functions to lower the bottom lip. This muscle is involved in frowning and is considered in cosmetic corrections. The mentalis muscle 1250 is located at the tip of the chin. It functions to elevate the lower lip and wrinkles the chin. This muscle influences chin aesthetics and is addressed in facial rejuvenation. The platysma muscle 1255 covers the neck. This muscle contributes to expressions of tension and fright. It is commonly targeted in neck lift procedures and reflects aging signs. The depressor supercilii 1260 is located below the corrugator muscle and aids in pulling the eyebrow downward. This muscle deepens frown expressions and is considered in brow lift surgeries. The orbicularis oculi muscle 1265 encircles the eye. Its function is essential for blinking and closing the eyelids. The muscle is commonly targeted in eyelid surgeries and cosmetic treatments. The levator labii superioris (alaeque nasi) 1270 is located in the upper lip and functions to elevate the upper lip. This muscle is involved in expressions like sneering and is important in facial symmetry. The levator labii superioris (alaeque nasi) 1275 muscle is situated in the upper facial region. This muscle is responsible for clevating the upper lip and the ala of the nose. Its function and location are crucial considerations m cosmetic procedures such as rhinoplasty and lip augmentation. These facial muscles are crucial for medical professionals in diagnosing and treating various facial conditions, as well as in cosmetic enhancements and reconstructions.

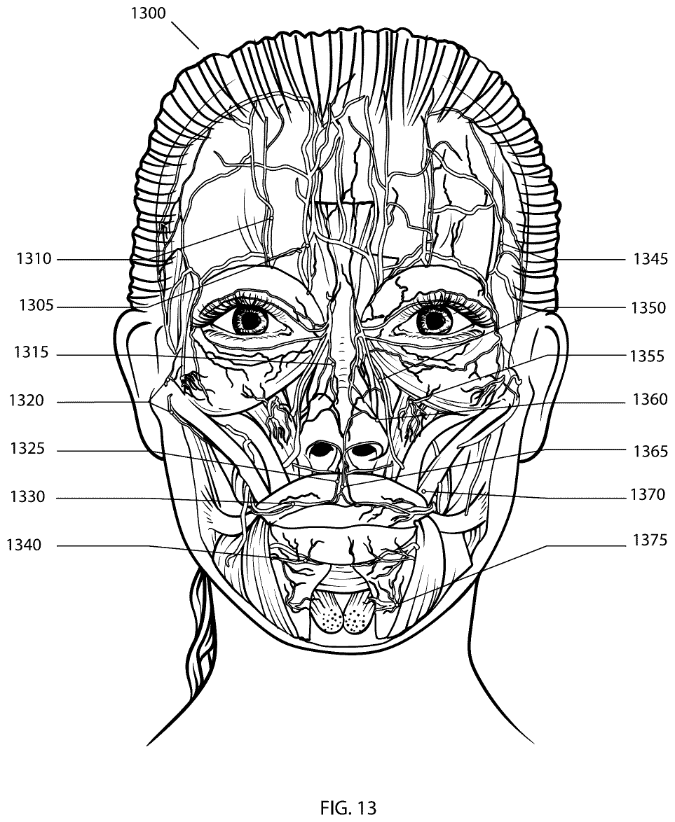

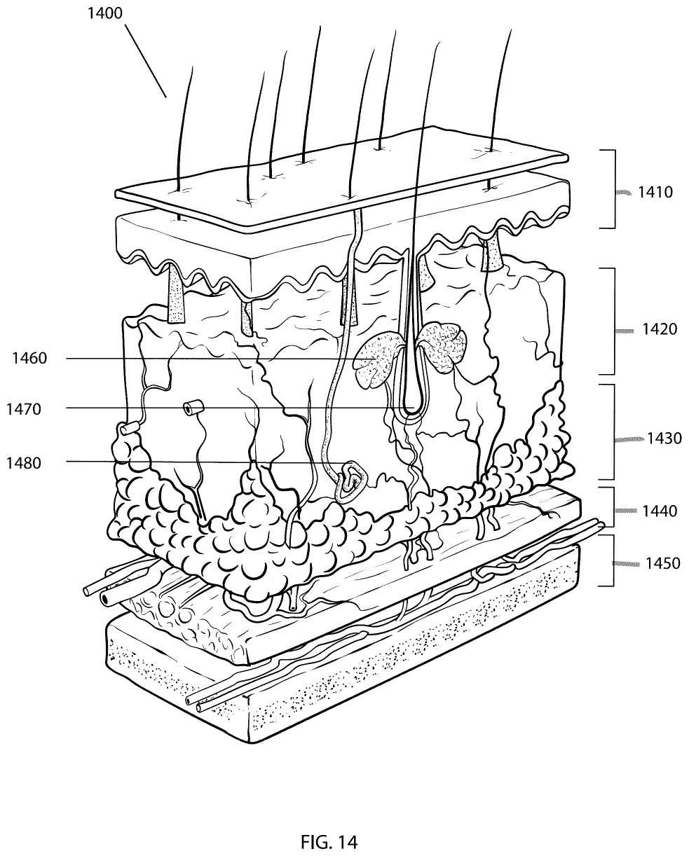

An understanding of the vascular system, as shown in the exemplary face 1300 illustrated m FIG. 13, in the face can be crucial for medical and aesthetic professionals in various fields, including plastic surgery, dermatology, facial procedures and maxillofacial surgery. The following description elucidates several key vascular structures involved in facial blood circulation. It shall be understood by those skilled in the art that the description herein should not be read, nor is intended to be exhaustive or limiting. Further. in the current exemplary FIG. 13, while it is understood that arteries and veins are separate features of a vasculature system, the arteries and veins are identified in FIG. 13 using a single reference numeral. All references made shall be understood as applicable within the generally accepted meaning as may be held by those skilled in the art. The supratrochlear artery and vein 1305 are located at the upper edge of the orbit. These structures function to supply and drain blood from the forehead and sealp region. They are important in forehead procedures and in assessing forehead circulation. The supraorbital artery and vein 1310 are located above the orbit and function to provide and drain blood from the forehead and upper eyelid. Crucial in eyelid and forehead surgeries, the risk of injury to these structures can lead to bematoma or bleeding. The dorsal nasal artery and vein 1315 run along the dorsum (bridge) of the nose and function to supply and drain blood from the upper part of the nose. Important in rhinoplasty and nasal reconstruction; injury can lead to significant bleeding or compromise nasal skin viability.

The transverse facial artery and vein 1320 are located across the face. These structures function to supply and drain the middle region of the face, including the cheek. Essential for cheek surgeries, their injury can lead to significant bleeding. The septal branch artery and vein 1325 are situated in the nasal septum. They provide and drain blood from the nasal septum and can be crucial in surgeries involving the nasal septum; injury can lead to septal hematoma or compromise septal cartilage. The superior labial branch (of the facial artery and vein) 1330 is located in the upper lip area. They function to supply blood to the upper lip and assist in drainage. These features are relevant in lip augmentation and reconstructive procedures. The inferior labial artery and vein 1340 are located around the lower lip. They function to supply and drain the lower lip and are crucial in lower lip surgeries; bleeding risk in trauma or procedures.

The superficial temporal artery and vein 1345 are located at the side of the head above the ear. They function to supply blood to the frontal and temporal regions and are significant in temporal region procedures, being palpable in temporal arteritis. The angular artery and vein 1350 is located near the angle of the nose, close to the eyes. They function to supply and drain the lateral nasal wall and adjacent cheek area and are key in periorbital and nasal surgeries; injury can cause hematoma or affect tear trough area. The infraorbital artery and vein 1355 are located beneath the orbit. They function to supply and drain blood from the lower eyelid and upper cheek area. Important in lower eyelid and midface procedures, the risk of hematoma or bleeding can be significant. The lateral nasal artery and vein 1360 is located along the sides of the nose and serve the lateral walls of the nose. Important in lateral nasal procedures and rhinoplasty, they can present a significant bleeding risk. The columellar artery and vein 1365 are found in the columella, the tissue that separates the nostrils. They supply and drain blood from the columella and nasal tip and are significant in detailed nasal tip surgeries; injury can affect nasal tip skin viability. The facial artery and vein 1370 are major vessels of the face that function to supply and drain the majority of the facial area, including lips, nose, and cheeks. They are key in numerous facial procedures and injury can cause significant complications. The mental artery and vein 1375 can be understood to emerge at the mental foramen. They function to supply blood to the chin and lower lip and are important in chin surgeries; bleeding or hematoma risk. The submental artery and vein (not shown) are located beneath the chin. They function to supply and drain the area under the chin and lower jawline. These are significant in neck and submental surgeries and injury can lead to bleeding complications.

Understanding these facial vascular structures is crucial for cosmetic and surgical planning, injury prevention, and effective treatment of facial conditions. Knowledge of these vessels ensures proper management of blood supply and drainage in facial procedures.

An accurate understanding of the skin and its layers is essential in dermatology, cosmetic surgery, and various medical fields. Elucidating the key components of dermal tissues and associated structures, as seen in structure 1400 illustrated in FIG. 14, can be a significant advantage provided by the exemplary embodiments, both described and contemplated, of the current invention.

The epidermis 1410 is the outermost layer of the skin and provides a waterproof barrier and creates skin tone. This layer further serves to protect against external elements. As the first line of defense against environmental damage, this layer is involved in conditions like dermatitis and psoriasis. The dermis 1420 is located beneath the epidermis layer. This layer contains tough connective tissue, hair follicles, and sweat glands. It is responsible for skin strength and elasticity and is key in wound healing, and showing aging signs. This layer may be a common target in cosmetic procedures like laser therapy and dermal fillers. The hypodermis 1430 (subcutaneous layer) is located as a deeper layer under the dermis. This layer is composed of fat and connective tissue and can provide insulation and cushioning. This layer is important in temperature regulation and shock absorption and can be targeted in procedures like liposuction. The muscle layer 1440 is located underlying the dermal layers. The facial muscles are interconnected with the skin and are responsible for facial expressions. The muscle layer is essential in expressions and aging and are commonly targeted in rejuvenation procedures and treatments. The layer of tissue identified as bone 1450 provides the facial skeletal structure. The bone provides the framework for dermal tissue layers and promote the shape given to a facial structure. Fundamental in facial structure, bone is considered in reconstructive surgery and orthodontics. The sebaceous gland 1460 is located within the dermis and functions to secrete sebum, an oily substance for skin lubrication and protection. Involved in acne and other skin conditions, the sebaceous gland is commonly a target in dermatological treatments. The hair follicle(s) 1470 are located within the dermis and are responsible for hair growth, connected to sebaceous glands. Central in hair growth and health, the hair follicle(s) are typically focused on in treatments for hair loss and scalp conditions. The sweat gland(s) 1480 are located throughout the skin, primarily in the dermis. They function to regulate body temperature through sweat excretion and are involved in excretory and immune functions. Important in thermoregulation, sweat gland(s) disorders can lead to conditions like hyperhidrosis or anhidrosis.

Understanding these dermal layers and associated structures is crucial for diagnosing and treating skin conditions, as well as in cosmetic enhancements and reconstructive surgeries. Their detailed knowledge ensures effective management of skin health and aesthetics.

The process of producing a 3DS of the current invention can comprise various steps to be performed in numerous combinations. It shall be understood that the term producing broadly refers to and may be synonymous with various terms including, but not necessarily limited to, creating, generating, manufacturing, constructing and such other commonly used indications for the production of an exemplary 3DS for the current invention. For exemplary method embodiments, a method of producing a 3DS can comprise a first step of designing a 3DS. The design can promote various configurations that may simulate any one or combination of numerous different human anatomy structures including, without limitation, any of the HFDTLs disclosed in the instant application, and any demographic characteristic that is correlated or associated thereto. The design can be generated in physical (e.g., blueprint) and/or digital (e.g., computer implemented (digital blueprint)) form. In this phase, a comprehensive digital design of the 3DS may be created. The creation of this design can employ and use various techniques and technologies, such as advanced computer-aided design (CAD) software.

It is contemplated that prior to this exemplary design step, the current invention may be further understood to comprise one or more additional steps to achieve the distinctive 3DS embodiments of the current invention. The current invention can comprise a step of determining the one or more human anatomical structures to be simulated by an exemplary 3DS embodiment. Further, the current invention can comprise a step of determining one or more demographic characteristics to be represented by or ascertainable from an exemplary 3DS produced as an embodiment for the current invention. Therefore, it is understood that the steps of producing an exemplary 3DS of the current invention can comprise the simulation of correlated demographic characteristics with human anatomical structures.

Still further, exemplary embodiments may comprise receiving input from aesthetic and cosmetic professionals, medical professionals and anatomical experts to ensure accuracy in the simulated representation of a human anatomical structure and any HALSS, Features, Defects, Target Sites, and/or Landmarks (HFDTLs). Various layers such as skin, muscle, vascular structures, and skeletal components can be intricately modeled. The physical or digital blueprint that may be generated may serve as the foundation for the physical construction or digital (virtual) representation of the 3DS, detailing every HFDTLs from the outermost to the innermost layers.

The exemplary method(s) embodiments for producing a 3DS can comprise a step of selecting the appropriate materials to simulate the desired and different anatomical structures. These materials may be chosen based on their ability to replicate the texture, density, and color of human tissues, including skin, muscle, and bone. For instance, different grades of silicone may be used to mimic skin and muscle, while rigid polymers may be chosen for skeletal components. Preparation of these materials may further involve one or more processing steps to render them into forms suitable for the subsequent manufacturing stages, such as filament for 3D printing.

The exemplary method embodiments for the current invention can comprise a construction and/or assembly process whereby the actual manufacturing of a 3DS can be promoted and accomplished. It is contemplated that the construction and/or assembly process can employ one or more of various techniques, technologies, processes and the like as are known by those skilled in the art. For example, a layered construction and assembly process may be employed. Using technologies, devices and techniques like 3D printers and printing, injection molding, and others, in an exemplary step of a construction process each layer of a 3DS simulation can be constructed.

It is contemplated that the exemplary methods for creating exemplary 3DS embodiments may comprise employing a 3D printer to generate an exemplary 3DS that can promote a real-world, anatomically accurate representation of one or more or any combination of human anatomical parts or features including, without limitation, a face, head, throat, shoulders, thoracic region, legs, feet and other areas and any combination thereof as has also been and will be further identified herein. The exemplary 3DS can be made accessible to one or more professionals for various purposes including, without limitation, training purposes. This access can be enabled in various environments and through various means including, without limitation, in a clinical setting and through a determined Protocol.

It shall be understood that the exemplary process can comprise the creation of any one or more of the HFDTLs, such as a Defect and Landmark, as a separate aspect and/or integrated within any one or more of the relevant layers, as may be detailed in the design or generated during this construction step. It is contemplated that any one or combination of the layers, including any of the one or more HFDTLs that may be represented by or within one or more constructed layers, may be constructed separately (individually), or may be constructed integrally with any one or combination of other layers.

Still further, the construction of any layer or layers can comprise their assembly in accordance and correlated with one or more determined demographic characteristics. As disclosed herein, the correlated demographic characteristics can comprise a representation of age, gender, ethnicity, skin color and such other characteristics as may be contemplated. Once individual layers and components are fabricated, it is contemplated that they are assembled to form the complete anatomical structure, ensuring that all layers align correctly and the overall structure is a high-fidelity simulation of the anatomical structure.

The exemplary embodiments for the current invention can comprise a 3DS having integrated or removably connected simulated HFDTLs. It is therefore contemplated that exemplary methods for producing a 3DS can comprise the production of simulated representations of any one or more HFDTLs. By way of non-limiting example, a step in the production of an exemplary 3DS embodiment can comprise the production and inclusion of predefined Defects (such as cysts, lesions, or fat pads). These Defects can be separately (individually) formed and included in a 3DS or integrally formed into a 3DS. Further, the production process can involve placing or positioning these Defects at specific locations, as per the design configuration or as determined throughout the production process, ensuring they realistically represent aesthetic and/or medical conditions. The defects can be connected to and/or embedded within the layers during the construction process or added subsequently through precise assembly techniques. This step is vital for the 3DS's intended use in aesthetic and/or medical training and research, as it provides a realistic platform for practitioners to learn and practice.

It is further contemplated that the production process for an exemplary 3DS of the current invention can comprise a quality control and testing step. This step can involve rigorous quality control and testing of a constructed 3DS. This step can promote the simulation meeting all specified requirements, including anatomical and demographic accuracy, material integrity, and functional effectiveness. One or more tests may be conducted to assess the durability of the materials, the accuracy of the anatomical features, fidelity of demographic characteristics and the responsiveness of the 3DS to aesthetic and/or medical procedures. Feedback from this phase may loop back to earlier stages for refinements, promoting the final product is of the highest standard for educational and professional use.

It is contemplated for various embodiments of a demographically determined 3DS in accordance with the current invention that it can be fabricated utilizing various technologies and techniques including, without limitation, a 3D printing device, from a negative mold and others as are known and may be contemplated for use. It can be understood that the 3DS is fabricated to provide a simulation of one or more of the various HFDTLs that may be integrally and/or removably interconnected to one or more HALSS, Features, Defects, Target Sites, Landmarks and/or one another individually or in any combination including, without limitation, one or more of any one or combination of the following: (i) skin layer, (ii) muscle layer, (iii) artery structures, (iv) nerve structures, (v) superficial musculoaponeurotic system structure(s), (vi) gland structures, (vii) skull structure, (viii) cartilage structures and any other structures as may be contemplated and known by those skilled in the art.

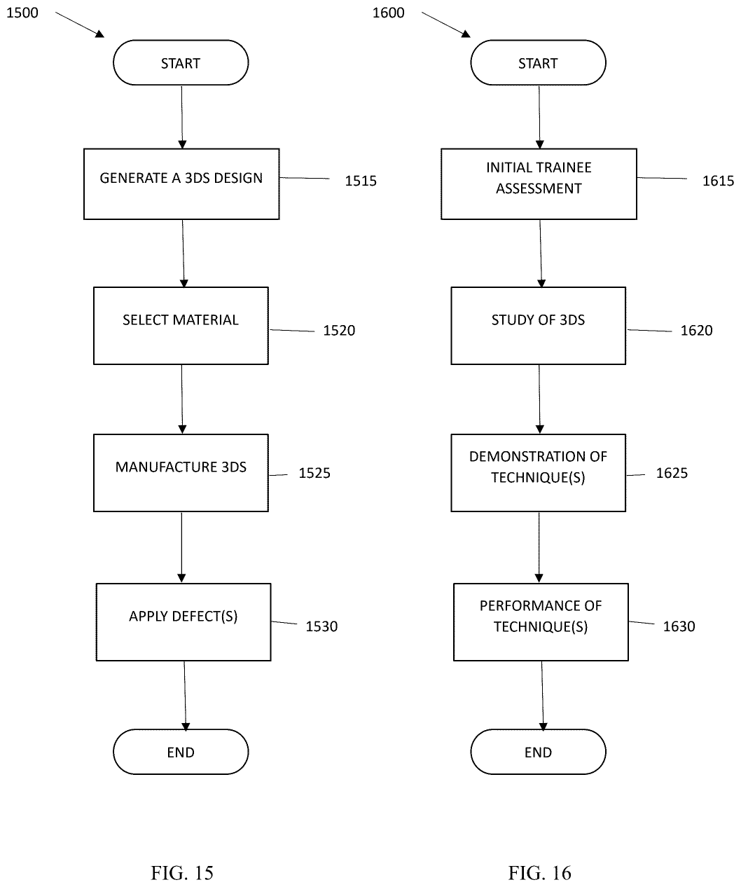

FIG. 15 is an exemplary method 1500 for producing a three-dimensional training device (referred to herein as a “3DS”), wherein the 3DS can simulate one or more human anatomical features. In a first step 1515, a detailed and precise 3DS design or a configuration for a 3DS is generated. This design configuration may be accomplished using a sophisticated computer-aided design (CAD) software specializing in anatomical modeling. This software may enable the detailed and precise creation of digital models of human anatomical structures, including every layer and feature. The contemplated user interface is intuitive, enabling seamless manipulation of structures and incorporation of anatomical data sourced from medical databases. This approach promotes anatomic fidelity in the digital model and may reflect real human variations. This approach may further include simulation features that enable the testing of the physical properties of the model under various conditions.

A contemplated alternative may involve the use of open-source 3D modeling software. While potentially less specialized than the software option described herein above, these tools can still offer sufficient capabilities for detailed modeling. The advantage of this approach can lie in its cost-effectiveness and the broad community support available for troubleshooting and advice.

Another contemplated alternative for this step may be to employ specialized medical imaging software that can convert MRI or CT scans directly into 3D models. This approach can provide highly accurate anatomical details directly from the scans. While there may be some limitations in terms of customizability and additional processing needed to make the models suitable for 3DS manufacturing, it can be a viable alternative.

In a second step 1520, one or more of a variety of advanced biocompatible materials can be selected for their properties closely resembling human tissue. These materials include high-grade silicones for skin and muscle layers and durable polymers for bone structures. Each material is prepared using proprietary techniques to enhance its realism, including color matching and texture enhancement. The materials are also tested for durability and safety, ensuring their suitability for aesthetic, cosmetic and medical training purposes. This approach guarantees a high degree of realism in the final 3DS.

As an alternative means, more readily available materials such as standard silicone and basic polymers may be used. These materials may be less expensive and more accessible, making this option cost-effective. While they may not offer the same level of realism as the materials described above, they can still provide a satisfactory level of detail for modeling, training and educational purposes.

An additional alternative involves using eco-friendly, sustainable materials. While this approach prioritizes environmental considerations, it may present challenges in achieving the same level of detail and realism as other options. The materials chosen would need to be carefully tested and processed to ensure they meet the necessary educational and functional requirements of the 3DS.

In a step 1525 a state-of-the-art 3D printer employing 3D printing technology may be used to generate or manufacture the 3DS. This technology can promote and allow for precise layer-by-layer construction of the 3DS. This precision printing technology can promote the accurate production of a digital model from step 1515 or through the use of various design configurations. Advanced printers capable of handling multiple materials and colors can be used to replicate various anatomical features and textures. This approach promotes high precision and consistency in the final product. Post-processing techniques, such as heat treatment or UV curing, can be applied to enhance the durability and realism of the 3DS.

The exemplary methods that are disclosed herein may pertain to the production of three-dimensional simulations (3DS) utilizing various types of 3D printer devices, with the aim of providing a hands-on, real-world experience for the user of the 3DS model. The utilization of a 3D printer device offers a versatile and efficient means of manufacturing 3DS models, allowing for precise replication of anatomical structures and other intricate details.

Various types of 3D printers may be employed, each offering unique benefits and capabilities. One type of 3D printer device suitable for producing 3DS models is the Fused Deposition Modeling (FDM) printer. FDM printers operate by extruding thermoplastic materials layer by layer to create the desired object. These printers are known for their affordability, case of use, and ability to produce robust and durable models. Additionally, Stereolithography (SLA) printers may be utilized, which utilize a vat of liquid resin cured by ultraviolet light to build the model layer by layer. SLA printers are renowned for their high precision and ability to produce intricate details, making them ideal for applications requiring fine resolution.

Alternatively, Selective Laser Sintering (SLS) printers may be employed, which use a laser to sinter powdered material, such as nylon or metal, into the desired shape. SLS printers offer the advantage of being able to produce complex geometries and functional parts with high strength and durability. Additionally, Digital Light Processing (DLP) printers may be utilized, which use a digital light projector to polymerize liquid resin into solid layers. DLP printers are known for their speed and ability to produce smooth surface finishes.

The use of a 3D printer device may involve standalone operation or integration into a computer-enabled system. In standalone operation, the 3D printer device operates independently, with the user directly controlling the printing process. Alternatively, the 3D printer device may be integrated into a computer-enabled system, where the printing process is controlled and monitored via computer software. This integration allows for greater automation, precision, and remote access to the printing process, enhancing efficiency and convenience.

The exemplary methods described herein leverage the capabilities of 3D printer devices to produce 3DS models, offering recipients a hands-on, real-world experience. The utilization of various types of 3D printers, whether standalone or as part of a computer-enabled system, provides flexibility and efficiency in manufacturing high-quality 3DS models tailored to specific applications.

A contemplated alternative can employ a combination of 3D printing and manual assembly. In this method, major components can be 3D printed, while finer details can be added or assembled manually by skilled technicians. This approach can be more time-consuming but may further promote a higher degree of customization and manual refinement of the 3DS.

Another alternative may involve the use of traditional casting and molding techniques. While this method may not offer the same level of precision as 3D printing, it can be effective for larger-scale models or when replicating simpler anatomical structures. This method requires skilled craftsmanship and careful quality control to ensure that each part of the 3DS meets the required specifications. It shall be understood that the description provided herein related to all aspects of the process including, without limitation, the design, materials, and construction, provided for any one or combination of the HFDTLs or any other aspects or components of the current invention such as, the forming assembly or structural framework, may apply, in a similar or distinct manner, to any other HFDTLs and/or aspects or components.

The use of advanced injection molding techniques to apply, connect and/or integrate, one or more defects into the 3DS may be employed in step 1530. This step of the method can promote the precise placement and realistic representation of various aesthetic, cosmetic and medical conditions such as cysts, lesions, or fat pads. The Defects can be designed in a manner similar to that described for step 1515 and then accurately replicated in the physical model. The materials used for these Defects can be carefully selected to simulate the texture and appearance of the actual conditions. This step assists in the 3DS providing a high degree of accuracy and consistency in representing Defects.

An alternative means involves manually inserting the Defects post-construction. In this method, after the primary structure of the 3DS is assembled, one or more Defects can be manually embedded or attached to the 3DS structure. This approach allows for greater flexibility in customizing the placement and type of Defects.

Another alternative is to create Defects using separate modular inserts that can be added or removed from the 3DS as needed. This method involves preparing individual defect modules, each designed to represent a specific medical condition. These modules may then be inserted into designated areas (i.e., Target Sites) of the 3DS, allowing for a flexible and customizable approach to defect simulation. While this method offers the advantage of interchangeability and adaptability, it may lack the seamless integration of defects seen in the best mode. It is particularly useful in training and educational settings where a variety of defect scenarios need to be demonstrated and practiced upon.

It is contemplated that the exemplary process 1500 can comprise a comprehensive suite of quality control measures to be implemented. This quality control step may include and employ both automated and manual inspection techniques and technologies to ensure that each exemplary 3DS meets determined standards of accuracy and quality. Advanced imaging and scanning techniques can be employed to compare a finished 3DS against an original design configuration (i.e., digital model.) Functional tests may be conducted to assess the durability and response of the 3DS to various MAC treatments, procedures and handling. Feedback from these tests may be used to refine the manufacturing process, ensuring continuous improvement of the product.

An alternative means for quality control involves a more manual inspection process. In this approach, manual examination of a 3DS may focus on the accuracy of anatomical features and the integration of Defects. While this method may be more time-consuming, it can allow for a more detailed scrutiny of each model. Functionality tests, such as stress testing and tactile assessments, may also be performed to ensure the model's suitability for educational and training purposes.

Another alternative for quality control and testing may include the implementation of a peer-review system, where professionals can be invited to evaluate the 3DS. This method may provide valuable insights from the end-users' perspective, ensuring that the models meet the practical requirements of a desired training and simulation. Feedback from these reviews is used to identify areas for improvement and guide future enhancements.

3D printing can be understood as a process in which a 3D printer device can be used to produce a three dimensional object based upon and from captured data, wherein this captured data may also be understood and referred to as image data or a digital model. The digital model may, typically, be generated from using MRI or CT scans of a desired object to capture imaging data and then convert such data to a format that a 3D printer device can read. The 3D printer turns this digital model into a tangible, solid, three-dimensional object, usually by the 3D printer laying down many successive, thin layers of a material. Simply put, 3D printing uses imaging data to design and manufacture material into three-dimensional objects layer by layer.

Employing 3D printing techniques and technologies in the medical and aesthetic fields may present a heretofore unrealized cost-effective solution for making one of a kind items including, without limitation, the 3DS of the current invention. With its minimal set up cost(s), first same as last cost to manufacture (print) basis, and the high degree of customization that may be allowed, the use of 3D printing may enable significant savings of both time and money and present a revolutionary approach in providing the unique embodiments of the 3DS, including the demographically determined 3DS embodiments, for the current invention.

Generally, an exemplary method or process of 3D printing can be understood in the following order: (1) plan or select the 3D object to be printed, (2) acquire digital data through scanning or digital design in standard tessellation language (STL), (3) the SDL file is processed by the ‘Slicer’ software that converts the model into layers and produces a G-code, and (4) using the G-code instructions, various commercially available, numerically controlled printers lay down specific volumes of material in successive 2D horizontal layers to build the 3D object. Using this process with multiple different types of models could be printed from a younger person in their teens or twenties to an aging person in their eighties or older along with printing both male and female and any other one or combination of various demographic characteristics.

The exemplary method(s) of 3D printing that may comprise the current invention may include a first step or Design Phase. The method starts with the creation of a digital blueprint of a desired structure (e.g., tissue, organ, body part, and the like) using specialized software. Typically, the digital blueprint is based on imaging data that is captured from using MRI or CT scans of a desired object, structure or other item as may be determined. This blueprint guides the entire printing process, dictating the structure, composition, and intricacies of the final product. In a second step or Material Selection step, it's time to pick the right ingredients for the bioprinting recipe. The materials employed, commonly known as bioinks, can vary depending on the structure being printed. They often consist of living cells suspended in a hydrogel-like substance, providing the scaffolding for layering and growth of the printed structure. The selection of bioinks may be based on various factors like compatibility with the characteristics of the selected design (e.g., body part), mechanical properties for the various aspects of the design, and ability to support overall growth and differentiation. Based on the imaging data (digital blueprint), in the third step or Printing Process of the method a 3D bioprinter device manufactures or prints a three-dimensional object using the selected bioinks that are precisely deposited layer by layer according to the digital blueprint. The 3D printer, typically via its printer head, lays down layers (cells and biomaterials) in a predetermined pattern.

It is contemplated that the exemplary process(es) of method(s) of 3D printing that may be employed for the current invention can comprise various additional techniques and technologies. For example, an exemplary 3D printing method(s) may comprise crosslinking and solidification techniques and technologies. To ensure stability and integrity, a newly (freshly) manufactured or printed structure may undergo a process called crosslinking. This step may involve solidifying the bioinks to hold the printed layers together firmly. Various techniques, such as exposure to light, temperature changes, or chemical reactions, may be employed to trigger crosslinking and transform the aqueous (liquid) bioinks into a solid, three-dimensional structure. It is understood that the physical and chemical properties of the various bioinks that may employed with and for the current invention can vary as contemplated by those skilled in the art. These differing characteristics may or may not impact on any crosslinking and solidification process employed.

It is further contemplated that an exemplary 3D printing method(s) may comprise cell culture and maturation techniques and technologies. With the basic framework of any exemplary embodiment in place, the process may include a nurturing of the printed tissue to maturity. The nurturing may comprise, without limitation, transferring the bioprinted construct to an incubator-like environment, where it may be bathed in a nurturing broth of growth factors, nutrients, and oxygen. This simulated biological environment may encourage cell proliferation, differentiation, and tissue maturation, which may gradually transform the printed structure into a desired final form which may or may not include one or more demographic factors and/or functional living tissue.

It is further contemplated that an exemplary 3D printing method(s) may comprise one or more quality control and testing steps. Just like quality control inspectors scrutinizing every inch of a new car, the bioprinted structure (tissue) may be tested for structural integrity, functionality, demographic alignment and compatibility. Advanced imaging techniques, biomechanical testing, and biological assays may be employed to assess the tissue's properties and ensure it meets the desired standards. A final contemplated step for an exemplary 3D printing method(s) of the current invention may comprise the use or implantation step. Once the bioprinted object has been manufactured, and any contemplated steps have been taken, the object may be used for any desired purpose. For example, the object may be used for research purposes, training purposes, integration into various other constructs, devices and/or objects. Whether it's providing a training device, replacing one or more of the interchangeable and removably connectable HTDFLs, creating custom structures, or advancing aesthetic and scientific knowledge, the possibilities are as vast as the imagination itself.

In an exemplary embodiment for the current invention, a method of providing training to a service provider for a MACS includes determining a location for promoting and establishing access to one or more exemplary 3DS embodiments of the current invention in a first step. The location for the presentation of an exemplary 3DS embodiment may and can be identified and referred to herein as a training location. A training location can be any location in which a 3DS is established for the purpose of promoting and enabling access to an exemplary 3DS, which may further promote opportunities for at least some form of education and training. Any training location may be capable of establishing or having established therein one or multiple 3DS. In a second step, delivery of an aesthetic (MACS) treatment to a location upon or within the exemplary 3DS can be performed in the training location.

In another exemplary method embodiment provided by the current invention, in a first step an exemplary 3DS is provided or obtained that simulates a human anatomical construct comprising one or more HFDTLs (i.e., HALSS, Features, Defects, Target Sites and/or Landmarks.) It shall be understood that any of the one or more HFDTLs can be referred to herein as a “training assembly”, “training feature” or “training site”. The 3DS provides a simulation for one or more anatomical regions. The 3DS including the one or more HEDTLs, each of which may be located at similar or distinct positions upon the surface and/or within one or more layers (including below an outer surface layer) of the 3DS. In a second step, the location of the training assembly within the 3DS is determined. A Trainee is allowed to interact with the 3DS in a manner that enables them to identify the location of the training assembly feature within the 3DS. The interaction enabled by the exemplary 3DS can be via direct physical interaction and/or through remote interaction, such as through the use of virtual simulation technologies or other computer implemented techniques, methodologies, technologies and the like as may be contemplated by those skilled in these fields. The Trainee interaction with the 3DS can be based on pre-determined training Protocols or treatments that direct the trainee in the performance of specific training activities or tasks. It is contemplated that various interactions by the Trainee with the 3DS are enabled and may be based on various methodologies, treatments, Protocols, processes and the like or the interaction may not be based on pre-determined activities or tasks and the trainee may be allowed to freely interact with the 3DS. In a third step an aesthetic treatment is delivered to the training assembly. The Trainee's interaction with the 3DS enables the accomplishment of one or more training activities or tasks, such as delivery of an aesthetic treatment. The accomplishment of the one or more training activities or tasks may provide a partial or complete performance of the one or more training Protocols. The performance of the one or more training Protocols may signify the accomplishment of various achievements, such as a step in the training Protocol or completion of a training Protocol that further signifies the Trainee's certification for the training Protocol.

In another exemplary method embodiment provided by the current invention, a first step includes fabricating a demographically determined 3DS that simulates a human anatomical construct including one or more HFDTs. The 3DS can be fabricated through the use of a 3D printing device in accordance with an exemplary embodiment of the current invention. The 3DS provides a simulation for one or more human anatomical regions or constructs. Any one or more HEDTLs may be located at similar or distinct positions upon the surface and/or within one or more layers (including below an outer surface layer) of the 3DS. It is contemplated that the method may include locating the fabricated 3DS at a predetermined training location. The training location can be selected by a user and can be any physical or virtual location that may be contemplated for use by the current invention. In a second step, an aesthetic treatment (MACS) to be performed upon the 3DS is determined. The MACS can comprise one or more various treatments and/or options. For instance, the MACS can be neurotoxins, dermal fillers, laser ablation treatments, coolsculpting, and/or such other cosmetic procedure as may be contemplated for performance by the current invention. In a third step the location of the HFDTLs within the 3DS is determined. The HFDTLs may be located at similar or distinct positions upon the surface and/or within (including below an outer layer or surface) the 3DS. In this step of the method a Trainee interacts with the 3DS, directly or virtually, to determine the location of the HFDTLs.

A computer of a complete computing device, may be communicatively/operationally connected with one or more HFDTLs or other features of the 3DS and, via this operational connection, a user or Trainee may have the capability to interact with the one or more HFDTLs of the 3DS in various ways. The interaction enabled for the user with the 3DS may allow the operator to change various characteristics of one or more HFDTLs and/or other features of the 3DS including, without limitation, volumetric, dimensional and such other characteristics as may be contemplated. By way of non-limiting example, where a HFDTLs is established as a representation of a fat pad, the computer operator may be enabled to adjust the volumetric dimensions of the fat pad within the 3DS.

In another step of the current method embodiment, an aesthetic treatment is delivered to the training assembly feature. The Trainee's interaction with the 3DS promotes and/or enables the accomplishment of one or more training activities or tasks, such as delivery of an aesthetic treatment. The accomplishment of the one or more training activities or tasks may provide a partial or complete performance of the one or more training Protocols. The performance of the one or more training Protocols may signify the accomplishment of various achievements, such as a step in the training Protocol or completion of a training Protocol that further signifies the trainee's certification for the training Protocol.

It is contemplated for all the exemplary embodiments of the current invention that the interaction between a computer operator, whether a Trainee or another user or computer operator, and a 3DS can be enabled in real-time. Therefore, it is contemplated that real-time adjustments, via a computing device, can be made to the 3DS including, without limitation, any of the training features or other features of the 3DS. It is contemplated that adjustments to any of the exemplary 3DS's of and for the current invention can be made at any time and in real-time including, without limitation, making adjustments during the performance of an exemplary training method provided through the use of a 3DS in accordance with embodiments for the current invention.

FIG. 16 is a block diagram illustration of an exemplary method 1600 for providing training employing a three-dimensional training device (referred to herein as a “3DS”), wherein the 3DS can simulate one or more human anatomical features that can be related to the training. In a step 1615 of the method 1600, a trainee may first undergo an initial assessment to determine their current level of knowledge and skill in cosmetic treatments. This assessment may involve a standardized test that includes both theoretical and practical components. Once completed, trainers introduce the trainees to the 3DS, explaining its features and relevance to Botox injections. In this exemplary embodiment, the 3DS is an advanced model that replicates human facial anatomy in detail, including muscle structure and skin texture. Trainees are encouraged to explore the 3DS to familiarize themselves with its tactile and visual aspects.

It is contemplated that this initial assessment may be a theoretical briefing on Botox injections without a preliminary skill assessment. The briefing may cover basic concepts and standard procedures in cosmetic treatments. After this, trainees can be introduced to a basic version of the 3DS which may have fewer features than an advanced model. This option suits trainees with some prior experience who might not require a comprehensive assessment.

Another alternative involves conducting an initial assessment through an interactive online platform before any hands-on training. Trainees would then be introduced to a digital version of the 3DS in a virtual environment. This method allows for remote learning and can be especially useful in situations where physical access to the advanced 3DS or training facilities is limited.

Method 1600 comprises a step 1620 that entails an in-depth study of a 3DS model. In the current exemplary embodiment, this includes an in-depth study of a facial anatomy using the 3DS model being employed for the identified training. Trainees can be guided through a comprehensive exploration of the facial structure, focusing on areas commonly targeted in Botox treatments. This guidance may comprise a comprehensive and detailed examination of muscles, nerves, and vascular structures. The 3DS offers a highly realistic representation, providing trainees with a tactile understanding of different facial layers and promote a comprehensive understanding of facial anatomy. This step is crucial for understanding the precise locations for Botox injections.

An alternative may involve the use of a 3DS model accompanied by detailed anatomical charts. It is contemplated that the understanding provided to trainees by the 3DS model used can be supplemented by charts and diagrams to provide a comprehensive understanding of facial anatomy. This may be of benefit for trainees who are more visually oriented.

Another alternative for promoting the comprehensive understanding to be gained by the trainee may be the use of virtual reality (VR) technology. Trainees can explore facial anatomy using VR headsets, interacting with a virtual 3DS embodiment of the current invention. This method provides an immersive experience, although it may provide a different tactile feedback in comparison with other physical 3DS models.

Demonstration of injection techniques to be employed for the training comprise step 1625. For example, expert trainers may demonstrate various injection techniques, that may be employed in the performance of neurotoxin (e.g., Botox) injections, on the advanced 3DS to trainees. This demonstration includes selecting appropriate injection sites, handling the syringe, and executing the injection. Trainees can observe the techniques up close, gaining insights into the nuances of the procedure. The realistic texture of the 3DS promotes the ability of trainers to show the proper depth and angle for injections. This step is crucial for trainees to understand the practical aspects of the treatment process.

An alternative method may involve video demonstrations of various injection (e.g., neurotoxin) techniques. Trainees may be enabled to watch recorded performance of procedures. It is further contemplated that these performances can be followed by discussions and Q&A sessions. This method provides visual learning that may be employed individually or in any combination with the hands-on aspect of training on a 3DS.

The practicing of injection techniques directly on the 3DS is performed in step 1630. Under the guidance of trainers, trainees use real-world syringes to simulate injections at the correct sites and depths. This hands-on practice is crucial for developing muscle memory and confidence in performing the procedure. The 3DS provides realistic feedback, mimicking the resistance and texture of human skin. This step reinforces the skills learned in the demonstration phase.

An alternative method allows trainees to practice on various different 3DS embodiments or medical mannequins. While these models may not offer the full range of features of the advanced 3DS, they still provide a platform for developing basic injection skills. This option is cost-effective and can be used in situations where resources are limited. Another alternative involves the use of computer simulations for practice. Trainees can be enabled to use software to simulate the injection process, which provides visual feedback but lacks the tactile experience of practicing on a physical model. This method can be combined with theoretical learning for a more comprehensive training experience.

It is contemplated as a part of the exemplary training process 1600 that trainees may undergo a thorough evaluation to assess their proficiency in performing injection(s) techniques using the 3DS. The evaluation may be conducted by experienced trainers and includes both the accuracy of injection sites and technique proficiency. Trainees are required to demonstrate their skills on the advanced 3DS, replicating a series of typical treatment scenarios. Feedback is provided immediately, with emphasis on both strengths and areas needing improvement. This comprehensive evaluation ensures that trainees are well-prepared to perform numerous, various treatments in real-world settings.

An alternative method of evaluation involves a combination of practical assessment on various different 3DS models or mannequins and a written test. The practical assessment may focus on basic injection techniques, while the written test covers theoretical knowledge about Botox treatments. This approach is suitable for programs with limited access to 3DS models but still ensures a balanced evaluation of practical and theoretical understanding.

Another alternative for evaluation is a peer-review system, where trainees perform injections on a 3DS model and receive feedback from their peers. This method fosters a collaborative learning environment and allows trainees to view different techniques and approaches. While this method provides diverse insights, it might lack the detailed expertise of professional trainers. However, it can be particularly useful in reinforcing learning and building confidence among trainees.

For the purposes of this specification and appended claims, unless otherwise indicated, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Also, as used in the specification and including the appended claims, all numbers expressing quantities of ingredients, percentages or proportions of materials, reaction conditions, and other numerical values used in the specification and claims, are to be understood as being modified in all instances by the term “about.” Similarly, when values are expressed as approximations, by use of the antecedent “about,” it will be understood that the particular value forms another embodiment that is +/−10% of the recited value. Accordingly, unless indicated to the contrary, the numerical parameters set forth in the following specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of this application are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a range of “1 to 100” includes any and all subranges between (and including) the minimum value of 1 and the maximum value of 100, that is, any and all subranges having a minimum value of equal to or greater than 1 and a maximum value of equal to or less than 100, for example, 5 to 95, 25 to 75, 40 to 60 and the like.

As may be used herein, the term “biodegradable” refers to, for example, a material that can be at least partially broken down or degraded by a bodily fluid and discarded as waste from the body and/or a material that can be broken down or degraded by a living organism. Thus, “non-biodegradable” can refer to a material that cannot be broken down or degraded by a bodily fluid and/or cannot be broken down or degraded by a living organism. As used herein the term “resorbable” refers to, for example, a material that can be at least partially broken down or degraded by a bodily fluid and assimilated within the body. Thus, a “non-resorbable” material as used herein can refer to, for example, a material that cannot be broken down or degraded by bodily fluid and assimilated within the body.

In some embodiments, the biocompatible biodegradable and/or bioresorbable material or materials may include, without limitation, polymeric and/or non-polymeric materials, such as, for example, one or more polyurethane, polyester, polytetrafluoroethylene (PTFE), polyethylacrylate/polymethylmethacrylate, polylactide, polylactide-co-glycolide, polyamides, polydioxanone, polyvinyl chloride, polymeric or silicone rubber, collagen, thermoplastics, poly (alpha-hydroxy acids), poly (lactide-co-glycolide) (PLGA), polylactide (PLA), poly (L-lactide), polyglycolide (PG), polyethylene glycol (PEG) conjugates of poly (alpha-hydroxy acids), polyorthoesters (POE), polyaspirins, polyphosphazenes, collagen, hydrolyzed collagen, gelatin, hydrolyzed gelatin, fractions of hydrolyzed gelatin, elastin, starch, pre-gelatinized starch, hyaluronic acid, chitosan, alginate, albumin, fibrin, vitamin E analogs, such as alpha tocopheryl acetate, d-alpha tocopheryl succinate, D,L-lactide, or L-lactide,-caprolactone, dextrans, vinylpyrrolidone, polyvinyl alcohol (PVA), PVA-g-PLGA, PEGT-PBT copolymer (polyactive), methacrylates, poly (N-isopropylacrylamide), PEO-PPO-PEO (pluronics), PEO-PPO-PAA copolymers, PLGA-PEO-PLGA, PEG-PLG, PLA-PLGA, poloxamer 407, PEG-PLGA-PEG triblock copolymers, POE, SAIB (sucrose acetate isobutyrate), polydioxanone, methylmethacrylate (MMA), MMA and N-vinylpyyrolidone, polyamide, oxycellulose, copolymer of glycolic acid and trimethylene carbonate, polyesteramides, tyrosine polyarylates, polyetheretherketone, polymethylmethacrylate, silicone, hyaluronic acid, chitosan, or combinations thereof.

This specification details various methods and embodiments for the production of three-dimensional simulations (3DS) and the utilization of these models in providing training and education. It is imperative to note that the descriptions and examples presented herein are intended to be illustrative and exemplary in nature, rather than limiting. The outlined methods and embodiments, encompassing both the generation or manufacturing of the 3DS and its application in hands-on, real-world training and/or educational environments, serve to convey a comprehensive understanding of the invention, as well as various alternative embodiments. These descriptions provide non-limiting examples of how the 3DS can be created, used and employed, offering a range of possibilities that align with the inventive concept.

Each step in the methods, along with the various options delineated for each, presents an approximation of the procedures, designed to elucidate the concept with clarity and detail. The alternatives given for each stage of the 3DS production, education and training methodology are not exhaustive but are intended to showcase the versatility and adaptability of the invention. The alternatives and approximations provided herein demonstrate the breadth of the invention's application and are designed to encompass various scenarios and requirements that may arise in the practical use of the 3DS, particularly in medical and educational settings.

Moreover, the specification includes examples and descriptions that illustrate the practicality and effectiveness of using a 3DS in training scenarios, emphasizing the benefits of a hands-on approach. These examples, while detailed, are not to be construed as limiting the scope of the invention but rather to provide a clear and comprehensive understanding of its practical applications. The invention's capacity to adapt to various training needs and its compatibility with different manufacturing methods underscore its innovative nature.

The descriptions and examples within this specification are provided for the purpose of clarity and understanding. They outline an example of the invention's operation and offer a spectrum of alternatives, serving as a guide for its potential applications and variations. The scope of the invention should therefore be determined not solely by the embodiments illustrated but by the comprehensive scope as shall be understood by those skilled in the arts, the appended claims and their legal equivalent.

What is claimed is:

1. A demographically determined three-dimensional training device, comprising:
at least one demographically determined simulated human tissue layer presenting a human anatomical feature having at least one demographic bias indicator; and
at least one defect disposed upon the simulated human tissue layer,
wherein the at least one defect is selected from a group consisting of a cyst, wound, lesion, scar, fat pad and lymphoma, or a combination thereof.

2. The training device of claim 1, wherein the simulated human tissue layer comprises at least one epidermis-simulating layer which is the outermost layer of the 3DS, a dermis-simulating layer adjacent to the epidermis-simulating layer comprising an upper dermis-simulating layer and a lower dermis-simulating layer and a subcutaneous-simulating layer disposed inwardly from the dermis-simulating layer.

3. The training device of claim 1 further comprising at least one target site disposed upon the simulated human tissue layer.

4. The training device of claim 3, wherein the at least one target site comprises the at least one defect disposed therein.

5. The training device of claim 1, wherein the at least one demographic bias indicator provides the training device with an aesthetic associated with at least one demographic factor selected from the group consisting of age, gender, race, ethnicity, weight, height and skin tone.

6. The training device of claim 1, wherein the defect is a cutaneous defect-simulating structure.

7. The training device of claim 1, wherein the defect protrudes above an outer-most surface of the simulated human tissue layer.

8. A demographically determined three-dimensional training device, comprising:
a structural framework corresponding to a human face;
at least one demographically determined simulated skin layer disposed on at least a portion of the structural framework and having at least one demographic bias indicator;
at least one target site disposed on the simulated skin layer providing at least one site for performing a training procedure; and
at least one defect disposed upon the simulated skin layer and within the at least one target site,
wherein the at least one defect is selected from a group consisting of a cyst, wound, lesion, scar, fat pad and lymphoma, or a combination thereof.

9. The training device of claim 8, wherein the simulated skin layer comprises at least one epidermis-simulating layer which is the outermost layer of the 3DS, a dermis-simulating layer adjacent to the epidermis-simulating layer comprising an upper dermis-simulating layer and a lower dermis-simulating layer and a subcutaneous-simulating layer disposed inwardly from the dermis-simulating layer.

10. The training device of claim 8 wherein the at least one demographic bias indicator provides the training device with an aesthetic associated with at least one demographic factor selected from the group consisting of age, gender, race, ethnicity, weight, height and skin tone.

11. The training device of claim 8, wherein the defect is a cutaneous defect-simulating structure.

12. The training device of claim 8, wherein the defect protrudes above an outer-most surface of the simulated skin tissue layer.

13. A method for providing training for at least one cosmetic treatment, the method comprising:
providing a plurality of demographically determined three-dimensional training devices, wherein each of the demographically three-dimensional training device includes
a structural framework corresponding to at least one human anatomical part,
at least one demographically determined simulated human tissue layer disposed on at least a portion of the structural framework and having at least one demographic bias indicator, and
at least one defect disposed upon the simulated human tissue layer,
wherein the at least one defect is selected from the group consisting of a cyst, wound, lesion, scar, fat pad and lymphoma and combinations thereof; and
selecting at least one demographically determined three-dimensional training device from the plurality of demographically determined three-dimensional training devices based on at least one desired demographic bias indicator and at least one desired defect associated with the at least one cosmetic treatment.

14. The method of claim 13 further includes delivery of an active ingredient(s), wherein the active ingredient is delivered by mechanisms selected from at least one intercellular, transcellular, or transappendageal.

15. The method of claim 13, wherein the simulated human tissue layer comprises at least one epidermis-simulating layer which is the outermost layer of the 3DS, a dermis-simulating layer adjacent to the epidermis-simulating layer comprising an upper dermis-simulating layer and a lower dermis-simulating layer and a subcutaneous-simulating layer disposed inwardly from the dermis-simulating layer.

16. The method of claim 13, wherein each of the demographically three-dimensional training device comprises at least one target site disposed upon the simulated human tissue layer.

17. The method of claim 16, wherein the at least one target site comprises the at least one defect disposed therein.

18. The method of claim 13, wherein the at least one demographic bias indicator provides the training device with an aesthetic associated with at least one demographic factor selected from the group consisting of age, gender, race, ethnicity, weight, height and skin tone.

19. The training device of claim 13, wherein the defect is a cutaneous defect-simulating structure.

20. The method of claim 13, wherein the defect protrudes above an outer-most surface of the skin-simulated layer.
